(19) United States
(12) Patent Application Publication
(10) Pub. No.: US 2018/0299338 A1
(43) Pub. Date: Oct. 18, 2018

(54) STRAIN DETECTING ELEMENT, PRESSURE SENSOR AND MICROPHONE

(71) Applicant: KABUSHIKI KAISHA TOSHIBA, Minato-ku (JP)

(72) Inventors: Yoshihiko FUJI, Kawasaki (JP); Hideaki Fukuzawa, Kawasaki (JP); Yoshihiro Higashi, Komatsu (JP); Shiori Kaji, Kawasaki (JP)

(73) Assignee: KABUSHIKI KAISHA TOSHIBA, Minato-ku (JP)

(21) Appl. No.: 16/016,125

(22) Filed: Jun. 22, 2018

Related U.S. Application Data
(63) Continuation of application No. 14/662,857, filed on Mar. 19, 2015.

(30) Foreign Application Priority Data
Mar. 19, 2014 (JP) 2014-057260

(51) Int. Cl. G01L 9/16; G01L 1/12

(52) U.S. Cl. CPC G01L 9/16; G01L 1/122

(57) ABSTRACT

According to one embodiment, the pressure sensor includes a supporting portion, a film portion, and a strain detecting element. The film portion is supported by the supporting portion. The strain detecting element is disposed on a part of the film portion. The strain detecting element includes a first magnetic layer, a second magnetic layer, and an intermediate layer. A magnetization direction of the first magnetic layer is variable according to a deformation of the film portion. The first magnetic layer has a first facing surface. The second magnetic layer has a second facing surface. The second facing surface faces the first facing surface. The intermediate layer is disposed between the first magnetic layer and the second magnetic layer. An area of the first facing surface is larger than an area of the second facing surface.

### CROSS-REFERENCE TO RELATED APPLICATIONS

This application is based upon and claims the benefit of Japanese Patent Application No. 2014-57260, filed on Mar. 19, 2014, the entire contents of which are incorporated herein by reference.

### FIELD

Embodiments described herein relate generally to a strain detecting element, a pressure sensor and a microphone.

### BACKGROUND

A pressure sensor using a Micro Electro Mechanical Systems (MEMS) technique includes, for example, a piezoresistive type and a capacitance type. Meanwhile, a pressure sensor using a spinning technique has been proposed. The pressure sensor using the spinning technique senses a change in resistance according to a strain. The pressure sensor using the spinning technique is desired be high sensitive.

A strain detecting element and a pressure sensor according to an embodiment provides a high-sensitive strain detecting element, a pressure sensor and a microphone.

### BRIEF DESCRIPTION OF THE DRAWINGS

FIG. 1 is a schematic cross-sectional view for describing an operation of a pressure sensor according to a first embodiment.

FIG. 2 is a schematic perspective view illustrating a configuration of a strain detecting element according to the first embodiment.

FIG. 3A to FIG. 3D are schematic views for describing an operation of the strain detecting element.

FIG. 4 is a schematic perspective view for describing the operation of the strain detecting element.

FIG. 5 is a schematic plan view for describing the operation of the strain detecting element.

FIG. 6A to FIG. 6E are schematic perspective views illustrating exemplary configurations of the strain detecting element.

FIG. 7A to FIG. 7D are schematic perspective views illustrating exemplary configurations of the strain detecting element.

FIG. 8A and FIG. 8B are schematic perspective views illustrating exemplary configurations of the strain detecting element.

FIG. 9A to FIG. 9G are schematic plan views illustrating configurations of the strain detecting element.

FIG. 10 is a schematic perspective view illustrating ah exemplary configuration of the strain detecting element.

FIG. 11 is a schematic perspective view illustrating an exemplary configuration of the strain detecting element.

FIG. 12 is a schematic perspective view illustrating an exemplary configuration of the strain detecting element.

FIG. 13 is a schematic perspective view illustrating another exemplary configuration of the strain detecting element.

FIG. 14 is a schematic perspective view illustrating another exemplary configuration of the strain detecting element.

FIG. 15 is a schematic perspective view illustrating another exemplary configuration of the strain detecting element.

FIG. 16 is a schematic perspective view illustrating another exemplary configuration of the strain detecting element.

FIG. 17 is a schematic perspective view illustrating another exemplary configuration of the strain detecting element.

FIG. 18A to FIG. 18I are schematic cross-sectional views illustrating a method for manufacturing the strain detecting element.

FIG. 19J to FIG. 19L are schematic cross-sectional views illustrating a method for manufacturing the strain detecting element.

FIG. 20A to FIG. 20F are schematic cross-sectional views illustrating another method for manufacturing the strain detecting element.

FIG. 21G to FIG. 21I are schematic cross-sectional views illustrating another method for manufacturing the strain detecting element.

FIG. 22A to FIG. 22F are schematic cross-sectional views illustrating another method for manufacturing the strain detecting element.

FIG. 23G to FIG. 23I are schematic cross-sectional views illustrating another method for manufacturing the strain detecting element.

FIG. 24A to FIG. 24G are schematic cross-sectional views illustrating another method for manufacturing the strain detecting element.

FIG. 25 is a schematic perspective view illustrating a configuration of a strain detecting element according to a second embodiment.

FIG. 26A to FIG. 26E are schematic perspective views illustrating an exemplary configuration of the strain detecting element.

FIG. 27A and FIG. 27B are schematic perspective views illustrating an exemplary configuration of the strain detecting element.

FIG. 28 is a schematic perspective view illustrating the configuration of the strain detecting element.

FIG. 29A to FIG. 29I are schematic plan views illustrating an exemplary configuration of the strain detecting element.

FIG. 30 is a schematic perspective view illustrating an exemplary configuration of the strain detecting element.

FIG. 31 is a schematic perspective view illustrating another exemplary configuration of the strain detecting element.

FIG. 32 is a schematic perspective view illustrating another exemplary configuration of the strain detecting element.

FIG. 33 is a schematic perspective view illustrating another exemplary configuration of the strain detecting element.

FIG. 34 is a schematic perspective view illustrating another exemplary configuration of the strain detecting element.

FIG. 35 is a schematic perspective view illustrating another exemplary configuration of the strain detecting element.

FIG. 36 is a schematic perspective view illustrating another exemplary configuration of the strain detecting element.

FIG. 37 is a schematic perspective view illustrating another exemplary configuration of the strain detecting element.

FIG. 38 is a schematic perspective view illustrating another exemplary configuration of the strain detecting element.

FIG. 39 is a schematic perspective view illustrating another exemplary configuration of the strain detecting element.

FIG. 40 is a schematic perspective view illustrating another exemplary configuration of the strain detecting element.

FIG. 41 is a schematic perspective view illustrating another exemplary configuration of the strain detecting element.

FIG. 42 is a schematic perspective view illustrating another exemplary configuration of the strain detecting element.

FIG. 43 is a schematic perspective view illustrating another exemplary configuration of the strain detecting element.

FIG. 44 is a schematic perspective view illustrating another exemplary configuration of the strain detecting element.

FIG. 45 is a schematic perspective view illustrating another exemplary configuration of the strain detecting element.

FIG. 46 is a schematic perspective view illustrating another exemplary configuration of the strain detecting element.

FIG. 47 is a schematic perspective view illustrating another exemplary configuration of the strain detecting element.

FIG. 48 is a schematic perspective view illustrating another exemplary configuration of the strain detecting element.

FIG. 49 is a schematic perspective view illustrating another exemplary configuration of the strain detecting element.

FIG. 50 is a schematic perspective view illustrating another exemplary configuration of the strain detecting element.

FIG. 51 is a schematic perspective view illustrating another exemplary configuration of the strain detecting element.

FIG. 52 is a schematic perspective view illustrating another exemplary configuration of the strain detecting element.

FIG. 53 is a schematic perspective view illustrating another exemplary configuration of the strain detecting element.

FIG. 54A to FIG. 54I are schematic cross-sectional views illustrating a method for manufacturing the strain detecting element.

FIG. 55J to FIG. 55L are schematic cross-sectional views illustrating a method for manufacturing the strain detecting element.

FIG. 56A to FIG. 56H are schematic cross-sectional views illustrating another method for manufacturing the strain detecting element.

FIG. 57A to FIG. 57G are schematic cross-sectional views illustrating another method for manufacturing the strain detecting element.

FIG. 58A to FIG. 58G are schematic cross-sectional views illustrating another method for manufacturing the strain detecting element.

FIG. 59A to FIG. 59G are schematic cross-sectional views illustrating another method for manufacturing the strain detecting element.

FIG. 60 is a schematic perspective view illustrating a configuration of a pressure sensor according to a third embodiment.

FIG. 61 are schematic cross-sectional views illustrating a configuration of the pressure sensor.

FIG. 62A to 62F are schematic plan views illustrating a configuration of the pressure sensor.

FIG. 63 is a schematic perspective view for describing a configuration of the pressure sensor.

FIG. 64 is a graph for describing the configuration of the pressure sensor.

FIG. 65 is a contour drawing for describing the configuration of the pressure sensor.

FIG. 66A to FIG. 66E are schematic plan views illustrating a configuration of the pressure sensor.

FIG. 67A to FIG. 67D are schematic circuit diagrams illustrating a configuration of the pressure sensor.

FIG. 68A to FIG. 68E are schematic perspective views illustrating a method for manufacturing the pressure sensor.

FIG. 69 is a schematic perspective view illustrating an exemplary configuration of the pressure sensor.

FIG. 70 is a function block diagram illustrating an exemplary configuration of the pressure sensor.

FIG. 71 is a function block diagram illustrating an exemplary configuration of a part of the pressure sensor.

FIG. 72A and 72B illustrate a method for manufacturing the pressure sensor.

FIG. 73A and FIG. 73B illustrate a method for manufacturing the pressure sensor.

FIG. 74A and FIG. 74B illustrate a method for manufacturing the pressure sensor.

FIG. 75A and FIG. 75B illustrate a method for manufacturing the pressure sensor.

FIG. 76A and FIG. 76B illustrate a method for manufacturing the pressure sensor.

FIG. 77A and FIG. 77B illustrate a method for manufacturing the pressure sensor.

FIG. 78A and FIG. 78B illustrate a method for manufacturing the pressure sensor.

FIG. 79A and FIG. 79B illustrate a method for manufacturing the pressure sensor.

FIG. 80A and FIG. 80B illustrate a method for manufacturing the pressure sensor.

FIG. 81A and FIG. 81B illustrate a method for manufacturing the pressure sensor.

FIG. 82A and FIG. 82B illustrate a method for manufacturing the pressure sensor.

FIG. 83A and FIG. 83B illustrate a method for manufacturing the pressure sensor.

FIG. 84 is a schematic cross-sectional view illustrating a configuration of a microphone according to a fourth embodiment.

FIG. 85 is a schematic view illustrating a configuration of a blood pressure sensor according to a fifth embodiment.

FIG. 86 is a schematic cross-sectional view viewed from the line H1-H2 of the blood pressure sensor.

FIG. 87 is a schematic circuit diagram illustrating a configuration of a touch panel according to a sixth embodiment.

### DETAILED DESCRIPTION

A pressure sensor according to an embodiment includes a supporting portion, a film portion, and a strain detecting element. The film portion is supported by the supporting portion. The strain detecting element is disposed on a part of the film portion. The strain detecting element includes a first magnetic layer, a second magnetic layer, and an intermediate layer. A magnetization direction of the first magnetic layer is variable according to a deformation of the film portion. The first magnetic layer has a first facing surface. The second magnetic layer has a second facing surface. The second facing surface faces the first facing surface. The intermediate layer is disposed between the first magnetic layer and the second magnetic layer. An area of the first facing surface is larger than an area of the second facing surface.

A strain detecting element according to another embodiment is disposed on a deformable film portion. The strain detecting element includes a first magnetic layer, a plurality of second magnetic layers, and an intermediate layer. The first magnetic layer changes a magnetization direction according to a deformation of the film portion. The first magnetic layer has a first facing surface. The plurality of second magnetic layers each have a second facing surface. The second facing surfaces face the first facing surface. The intermediate layer is disposed between the first magnetic layer and the second magnetic layers.

Various Embodiments will be described hereinafter with reference to the accompanying drawings. The drawings are schematic or conceptual. The relationship between the thickness and the width of each portion, and the size ratio between the portions, for instance, are not necessarily identical to those in reality. Furthermore, the same portion may be illustrated with different dimensions or ratios depending on the figures. In the present description and the respective drawings, components similar to those described previously with reference to earlier figures are labeled with like reference numerals, and the detailed description thereof is omitted appropriately. In the present description, a state of “disposed on” includes a state where another component is inserted between components in addition to a state where a component is disposed directly in contact with another component.

### 1. FIRST EMBODIMENT

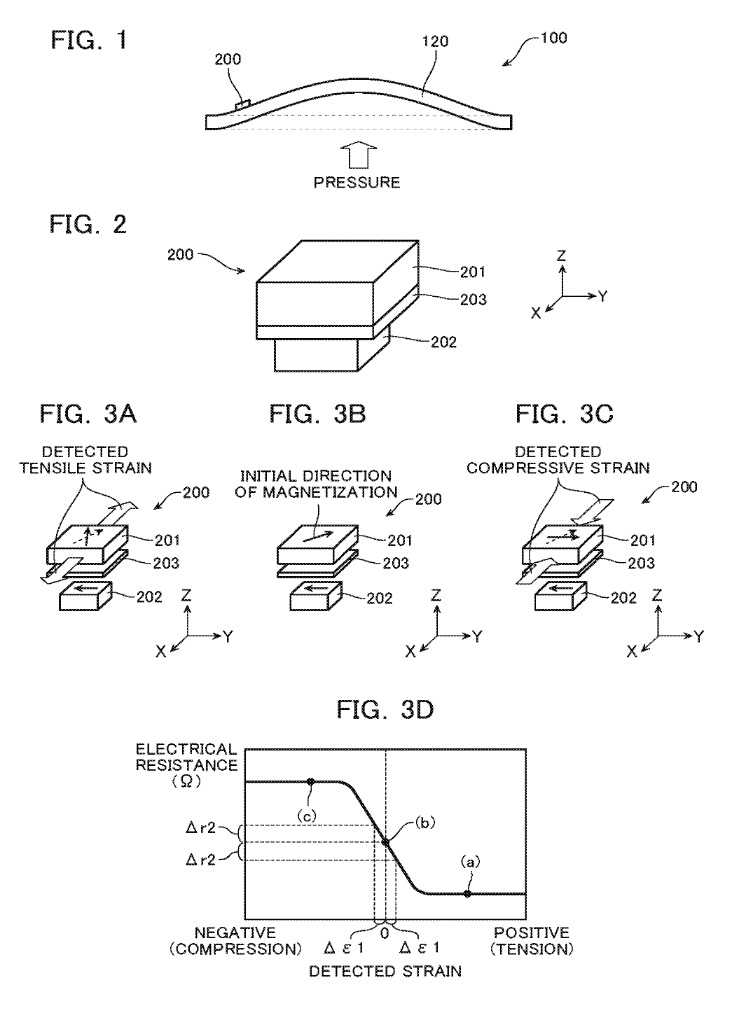

First, with reference to FIG. 1, the following describes an operation of a pressure sensor according to a first embodiment. FIG. 1 is a schematic cross-sectional view for describing an operation of the pressure sensor according to the first embodiment.

As illustrated in FIG. 1, a pressure sensor 100 includes a film portion 120 and a strain detecting element 200. The strain detecting element 200 is disposed on the film portion 120. The film portion 120 bends by pressure from the outside. The strain detecting element 200 strains according to a bend of the film portion 120. According to this strain, an electrical resistance value is changed. Therefore, by detecting the change in the electrical resistance value of the strain detecting element, pressure from the outside is detected. A pressure sensor 100A may detect a sound wave or an ultrasonic sound wave. In this case, the pressure sensor 100A functions as a microphone.

The following describes a configuration of the strain detecting element 200 with reference to FIG. 2. FIG. 2 is a schematic perspective view illustrating a configuration of the strain detecting element according to the first embodiment. Hereinafter, a direction from a first magnetic layer 201 and a second magnetic layer 202 being laminated is referred to as a Z direction. A predetermined direction perpendicular to this Z direction is referred to as an X direction. A direction perpendicular to the Z direction and the X direction is referred to as a Y direction.

As illustrated in FIG. 2, the strain detecting element 200 according to the embodiment includes the first magnetic layer 201, the second magnetic layer 202, and an intermediate layer 203. The intermediate layer 203 is disposed between the first magnetic layer 201 and the second magnetic layer 202. If the strain detecting element 200 strains, relative directions of magnetization of the magnetic layers 201 and 202 change. In association with it, an electrical resistance value between the magnetic layers 201 and 202 changes. Therefore, detecting the change in this electrical resistance value allows detecting a strain generated in the strain detecting element 200.

In the embodiment, a ferromagnetic material is used for the first magnetic layer 201. The first magnetic layer 201, for example, functions as a magnetization free layer. A ferromagnetic material is used for the second magnetic layer 202. The second magnetic layer 202, for example, functions as a reference layer. The second magnetic layer 202 may be a magnetization fixed layer or may be a magnetization free layer.

As illustrated in FIG. 2, the first magnetic layer 201 is formed larger than the second magnetic layer 202. That is, the bottom surface of the first magnetic layer 201 facing the second magnetic layer 202 is formed wider than the top surface of the second magnetic layer 202 facing the first magnetic layer 201. In other words, dimensions of the X-Y plane of the first magnetic layer 201 are formed larger than dimensions of the X-Y plane of the second magnetic layer 202.

As illustrated in FIG. 2 the bottom surface of the first magnetic layer 201 partially faces the second magnetic layer 202. In contrast to this, the entire top surface of the second magnetic layer 202 faces the first magnetic layer 201. In other words, the second magnetic layer 202 is disposed inside of the first magnetic layer 201 in the X-Y plane.

As illustrated in FIG. 2, the dimensions of the X-Y plane of the intermediate layer 203 approximately match the dimensions of the X-Y plane of the first magnetic layer 201. Therefore, the bottom surface of the intermediate layer 203 facing the second magnetic layer 202 is formed wider than the top surface of the second magnetic layer 202 facing the intermediate layer 203.

In the strain detecting element 200 illustrated in FIG. 2, the dimensions of the first magnetic layer 201 and the second magnetic layer 202 can be separately controlled by different etching processes. Accordingly, a difference in the dimensions of the first magnetic layer 201 and the second magnetic layer 202 can be freely set.

Next, with reference to FIG. 3A to FIG. 3D, the following describes an operation of the strain detecting element 200 according to the embodiment. FIGS. 3A, B, and C are schematic perspective views illustrating states where a tensile strain occurs in the strain detecting element 200, a strain does not occur in the strain detecting element 200, and a compressive strain occurs in the strain detecting element 200, respectively. The following assumes that the magnetization direction of the second magnetic layer 202 of the strain detecting element 200 is a −Y direction while a direction of a strain generated in the strain detecting element 200 is the X direction. The second magnetic layer 202 is assumed to function as the magnetization fixed layer.

As illustrated in FIG. 3B, when the strain detecting element 200 according to the embodiment does not strain, a relative angle formed by the magnetization direction of the first magnetic layer 201 and the magnetization direction of the second magnetic layer 202 can be larger than 0° and smaller than 180°. In the example illustrated in FIG. 3B, the magnetization direction of the first magnetic layer 201 with respect to the magnetization direction of the second magnetic layer 202 is 135°, and the magnetization direction of the first magnetic layer 201 with respect to the direction of the strain is 45° (135°). However, here, the angle of 135° is merely an example and another angle can be set. Hereinafter, as illustrated in FIG. 3B, the magnetization direction of the first magnetic layer 201 in the case where the strain does not occur is referred to as an “initial magnetization direction.” The initial magnetization direction of the first magnetic layer 201 is set by a hard bias, a shape magnetic anisotropy of the first magnetic layer 201, or a similar condition.

Here, as illustrated in FIG. 3A and FIG. 3C, if the strain detecting element 200 strains in the X direction, an “inverse magnetostrictive effect” occurs in the first magnetic layer 201. Thus, the directions of magnetization of the first magnetic layer 201 and the second magnetic layer 202 relatively change.

The “inverse magnetostrictive effect” is a phenomenon where the magnetization direction of ferromagnetic body is changed by strain. For example, when a ferromagnetic material used for the magnetization free layer has a positive magnetostriction constant, the magnetization direction of the magnetization free layer approaches parallel to the direction of a tensile strain and approaches vertically to the direction of a compressive strain. On the other hand, when the ferromagnetic material used for the magnetization free layer has a negative magnetostriction constant, the magnetization direction approaches vertically to the direction of the tensile strain and approaches parallel to the direction of the compressive strain.

In the examples illustrated in FIG. 3A and FIG. 3C, the ferromagnetic material having a positive magnetostriction constant is used for the first magnetic layer 201 of the strain detecting element 200. Accordingly, as illustrated in FIG. 3A, the magnetization direction of the first magnetic layer 201 approaches parallel to the direction of the tensile strain and approaches vertically to the direction of the compressive strain. The magnetostriction constant of the first magnetic layer 201 may be a negative.

FIG. 3D is a schematic graph showing the relationship between the electrical resistance of the strain detecting element 200 and a magnitude of the strain generated in the strain detecting element 200. In FIG. 3D, a strain in the tensile direction is assumed as a strain in the positive value while a strain in a compressive direction is assumed as a strain in the negative value.

As illustrated in FIG. 3A and FIG. 3C, when the directions of magnetization of the first magnetic layer 201 and the second magnetic layer 202 relatively change, as illustrated in FIG. 3D, a “magnetoresistance effect (MR effect)” changes the electrical resistance value between the first magnetic layer 201 and the second magnetic layer 202.

The MR effect is a phenomenon that changes the electrical resistance between these magnetic layers by the relative change of the magnetization direction between the magnetic layers. The MR effect includes, for example, a giant magnetoresistance (GMR) effect or a tunneling magnetoresistance (TMR) effect.

When the first magnetic layer 201, the second magnetic layer 202, and the intermediate layer 203 have the positive magnetoresistance effect and if the relative angle formed by the first magnetic layer 201 and the second magnetic layer 202 is small, the electrical resistance reduces. On the other hand, when the first magnetic layer 201, the second magnetic layer 202, and the intermediate layer 203 have the negative magnetoresistance effect and if the relative angle is small, the electrical resistance increases.

The strain detecting element 200, for example, has the positive magnetoresistance effect. Accordingly, as illustrated in FIG. 3A, if the tensile strain occurs in the strain detecting element 200 and the angle formed by the magnetization direction of the first magnetic layer 201 and the magnetization direction of the second magnetic layer 202 approaches from 135° to 90°, as illustrated in FIG. 3D, the electrical resistance between the first magnetic layer 201 and the second magnetic layer 202 reduces. Meanwhile, as illustrated in FIG. 3C, if the compressive strain occurs in the strain detecting element 200 and the angle formed by the magnetization direction of the first magnetic layer 201 and the magnetization direction of the second magnetic layer 202 approaches from 135° to 180°, as illustrated in FIG. 3D, the electrical resistance between the first magnetic layer 201 and the second magnetic layer 202 increases. The strain detecting element 200 may have the negative magnetoresistance effect.

Here, as illustrated in FIG. 3D, for example, a minute strain is referred to as Δε1, and a resistance change in the strain detecting element 200 when applying the minute strain Δε1 to the strain detecting element 200 is referred to as Δr2. Further, an amount of change in the electrical resistance value per unit strain is referred to as a gauge factor (GF). To manufacture the high-sensitive strain detecting element 200, increasing the gauge factor is desirable.

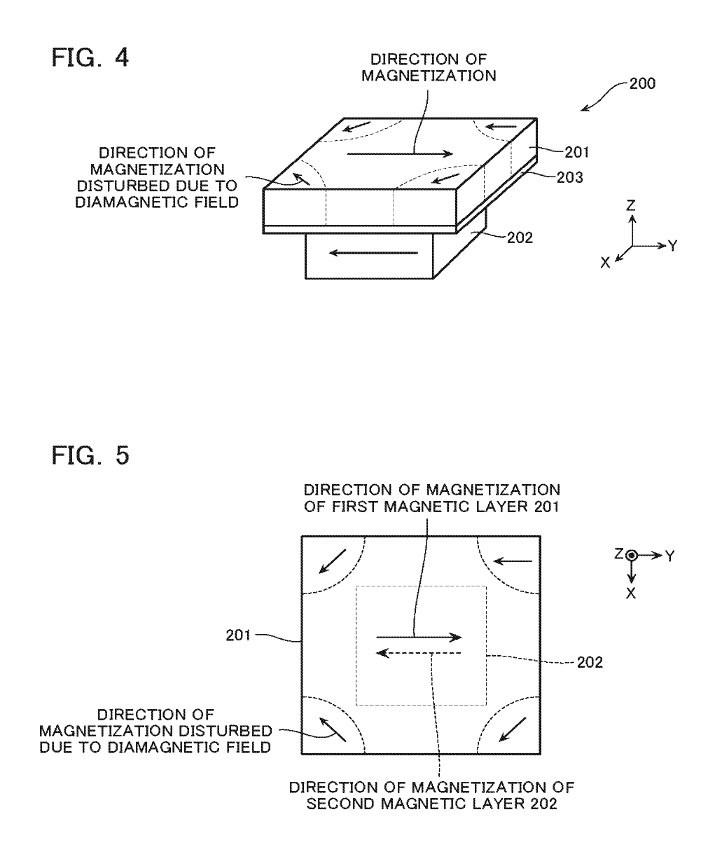

The following describes the operation of the strain detecting element 200 in detail with reference to FIG. 4 and FIG. 5. FIG. 4 is a schematic perspective view for describing the operation of the strain detecting element 200. FIG. 5 is a schematic plan view for describing the operation of the strain detecting element 200.

FIG. 4 and FIG. 5 schematically illustrate a magnetization state of when the strain detecting element 200 is in the state illustrated in FIG. 3C. That is, in the state illustrated in FIG. 4 and FIG. 5, the second magnetic layer 202 is magnetized in the −Y direction. The most part of the first magnetic layer 201 is magnetized in the Y direction; however, the directions of magnetization at the edge portions (four corners) are disturbed.

This disturbance of magnetization direction is caused by a diamagnetic field. That is, if the dimensions of the strain detecting element 200 are small, an influence of a magnetic pole to the edge portion of the first magnetic layer 201 generates the diamagnetic field in the inside of the first magnetic layer 201 (magnetization free layer). This may disturb the magnetization direction at the edge portion. On the other hand, the second magnetic layer 202, as described later, the magnetization direction can be fixed to one direction with a pinning layer or a similar layer. Accordingly, the fixing with the pinning layer can be set stronger than the diamagnetic field, which is generated in the inside of the second magnetic layer 202. Therefore, even if the second magnetic layer 202 is configured to be a smaller area than the first magnetic layer 201, the magnetization is not disturbed.

Here, as described with reference to FIG. 3D, the electrical resistance value between the first magnetic layer 201 and the second magnetic layer 202 changes according to the magnetization direction of the first magnetic layer 201. Therefore, if the part where the magnetization direction is disturbed faces the second magnetic layer 202, the change in the magnetization direction cannot be preferably detected from the resistance value. This may reduce the gauge factor.

However, as illustrated in FIG. 4 and FIG. 5, in the strain detecting element 200 according to the embodiment, the top surface of the second magnetic layer 202 faces only the part near the center portion where the magnetization direction is not disturbed in the bottom surface of the first magnetic layer 201. In the bottom surface of the first magnetic layer 201, the top surface does not face the edge portions where the magnetization direction is likely to be disturbed. Therefore, the strain detecting element 200 according to the embodiment preferably changes the resistance value according to the magnetization direction at the bottom surface of the first magnetic layer 201 where the magnetization direction is not disturbed. Accordingly, even if the strain detecting element 200 is downsized, the gauge factor is not damaged. Thus, the strain detecting element 200 operates at good sensitivity. This allows providing the high-resolution and high-sensitive strain detecting element.

In FIG. 4 and FIG. 5, the regions where the magnetization direction is disturbed in the bottom surface of the first magnetic layer 201 do not face the top surface of the second magnetic layer 202 at all. However, for example, the region where the magnetization direction is disturbed may partially face the top surface of the second magnetic layer 202. Even in this case, an influence that the disturbance of the magnetization direction at the edge portion of the first magnetic layer 201 gives to the resistance value of the strain detecting element 200 is reduced.

For example, the dimensions of the second magnetic layer 202 in the X direction or the Y direction are preferable to be 0.9 times or less compared with the dimensions of the first magnetic layer 201 in the X direction or the Y direction, arid more preferable to be 0.8 times or less. The area of the X-Y plane of the second magnetic layer 202 is preferable to be 0.81 times or less compared with the area of the X-Y plane of the first magnetic layer 201, and more preferable to be 0.64 times or less.

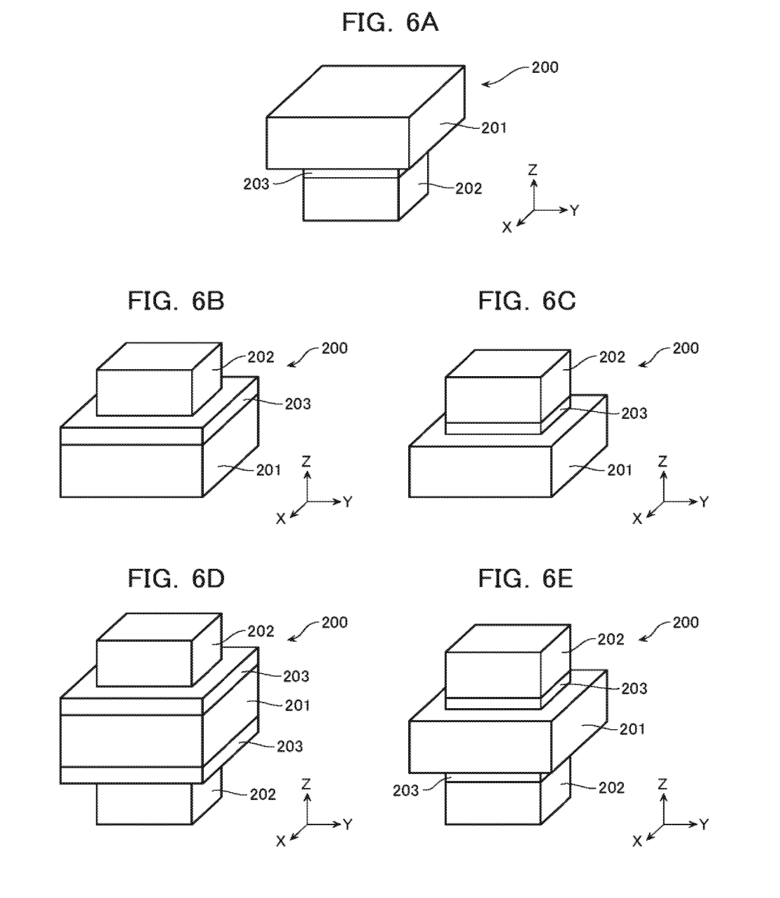

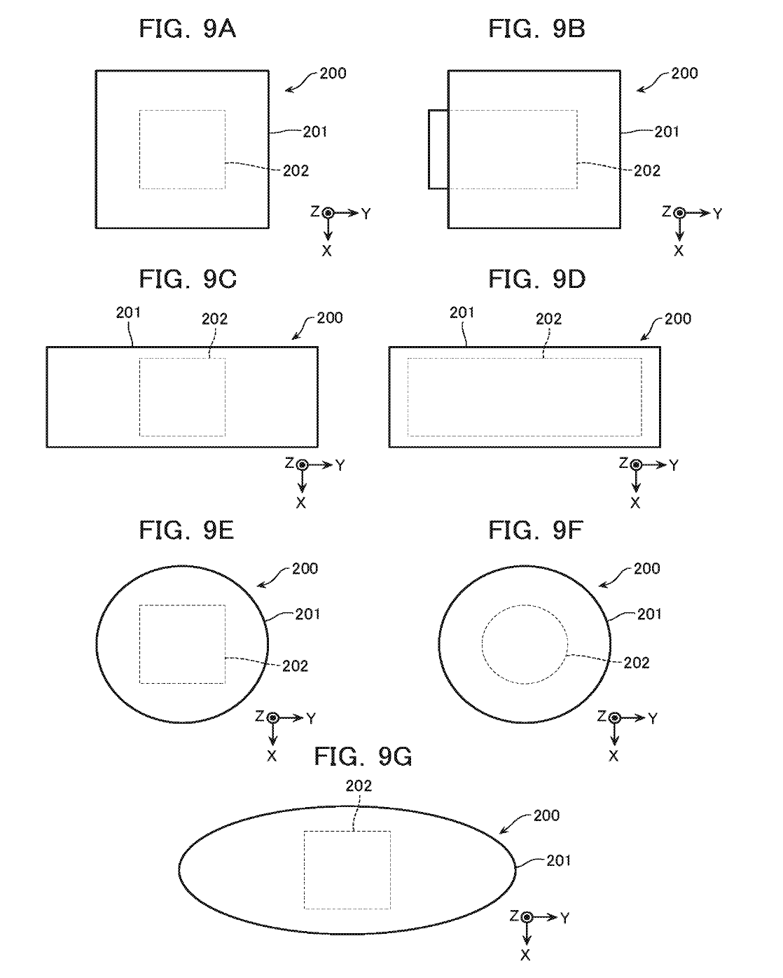

The following describes other exemplary configurations of the strain detecting element 200 with reference to FIG. 6A to FIG. 9G. FIG. 6A to FIG. 8B are schematic perspective views illustrating other exemplary configurations of the strain detecting element 200. FIG. 9A to FIG. 9G are schematic plan views illustrating other exemplary configurations of the strain detecting element 200. The strain detecting elements 200 according to the respective exemplary configurations described later and the strain detecting element 200 illustrated in FIG. 2 can be used in combination with one another.

In the example illustrated in FIG. 2, the dimensions of the X-Y plane of the intermediate layer 203 approximately matches the dimensions of the X-Y plane of the first magnetic layer 201. However, as illustrated in FIG. 6A, the dimensions of the X-Y plane of the intermediate layer 203 may approximately match the dimensions of the X-Y plane of the second magnetic layer 202. In this case, the bottom surface of the first magnetic layer 201 facing the intermediate layer 203 is formed wider than the top surface of the intermediate layer 203 facing the first magnetic layer 201.

In the examples illustrated in FIG. 2 and FIG. 6A, the strain detecting element 200 is configured by laminating the second magnetic layer 202, the intermediate layer 203, and the first magnetic layer 201 in this order. However, as illustrated in FIG. 6B and FIG. 6C, the strain detecting element 200 may be configured by laminating the first magnetic layer 201, the intermediate layer 203, and the second magnetic layer 202 in this order.

In the examples illustrated in FIG. 2, FIG. 6A, FIG. 6B, and FIG. 6C, the strain detecting element 200 is configured by laminating the first magnetic layer 201 and the second magnetic layer 202 via the intermediate layer 203 disposed at any one of an upper or a lower side of the first magnetic layer 201. However, as illustrated in FIG. 6D and FIG. 6E, the strain detecting element 200 may be configured by laminating the first magnetic layer 201 and the second magnetic layer 202 via the intermediate layer 203 disposed at both the upper side and lower side of the first magnetic layer 201.

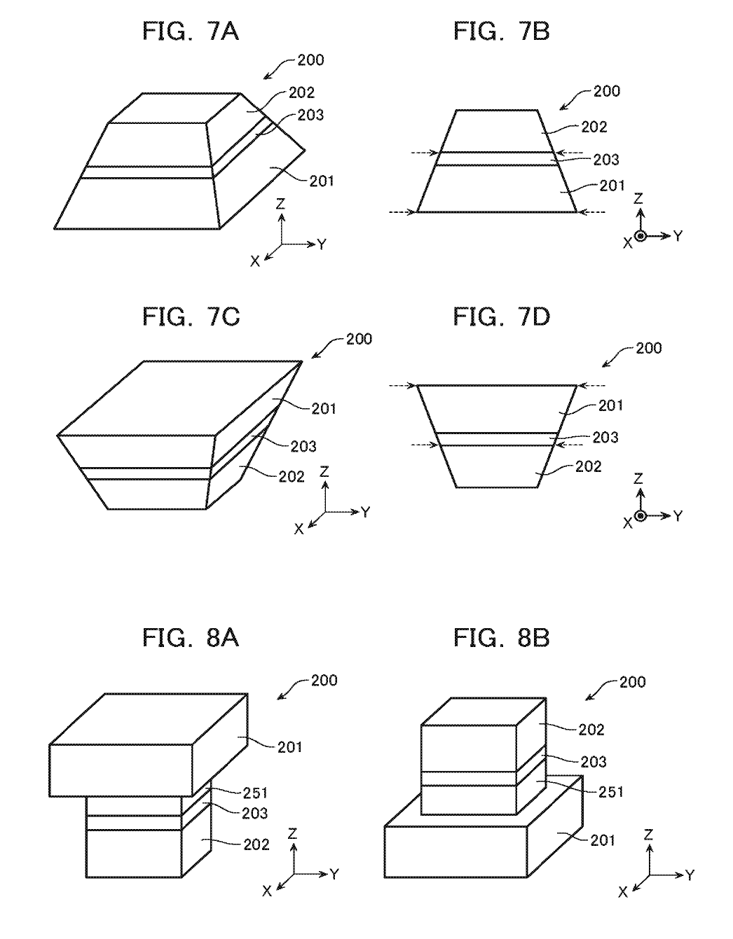

In the examples illustrated in FIG. 2 and FIG. 6A to FIG. 6E, the side surfaces of the first magnetic layer 201, the second magnetic layer 202, and the intermediate layer 203 are formed approximately perpendicular to the Z direction. However, for example, as illustrated in FIG. 7A to FIG. 7D, the side surfaces of the first magnetic layer 201, the second magnetic layer 202, and the intermediate layer 203 can also be formed as a consecutive inclined surface. In this case, as illustrated in FIG. 7A and FIG. 7B, the strain detecting-element 200 can also be formed into a tapered shape. As illustrated in FIG. 7C and FIG. 7D, the strain detecting element 200 can also be formed into an inverting tapered shape. The tapered shape can be fabricated by appropriately selecting a condition for an etching process during a process of the element. With the strain detecting element 200 illustrated in FIG. 7A or FIG. 7C, for example, as indicated in FIG. 7B or FIG. 7D, by measuring dimensions of the largest parts of the first magnetic layer 201 and the second magnetic layer 202, the dimensions of the first magnetic layer 201 and the second magnetic layer 202 may be checked. Alternatively, for example, a difference between average planer dimensions of the first magnetic layer 201 and average planer dimensions of the second magnetic layer 202 may be compared.

As illustrated in FIG. 8A and FIG. 8B, a third magnetic layer 251 may be interposed between the first magnetic layer 201 and the intermediate layer 203. In the examples illustrated in FIG. 8A and FIG. 8B, the dimensions of the X-Y plane of the second magnetic layer 202, the intermediate layer 203, and the third magnetic layer 251 approximately match. These dimensions are smaller than the dimensions of the X-Y plane of the first magnetic layer 201. A ferromagnetic material is used for the third magnetic layer 251. The third magnetic layer 251 functions as the magnetization free layer together with the first magnetic layer 201. That is, the third magnetic layer 251 is magnetically coupled to the first magnetic layer 201. The magnetization direction of the third magnetic layer 251 matches the magnetization direction of the part near the center portion of the first magnetic layer 201. The use of the structure as illustrated in FIG. 8A and FIG. 8B, as described later, allows manufacturing a laminated structure near the intermediate layer, which significantly contributes to the MR effect among the laminated structure of the magnetization fixed layer/the intermediate layer/the magnetization free layer, consistently in vacuum. This is preferable in manufacturing in an aspect of obtaining a high MR ratio. Here, the third magnetic layer 251 has the element dimensions smaller than the first magnetic layer 201 similar to the second magnetic layer 202. However, the third magnetic layer 251 is coupled to be magnetically coupled to the central region of the first magnetic layer 201 whose dimensions are relatively large and therefore the disturbance of magnetization is small. Accordingly, the disturbance of magnetization of the third magnetic layer 251 can also be reduced. This allows obtaining the effect of the embodiment.

As illustrated in FIG. 9A, a centroid of the first magnetic layer 201 and a centroid of the second magnetic layer 202 may overlap in the X-Y plane. As illustrated in FIG. 9A, the second magnetic layer 202 may fall within the inside of the first magnetic layer 201 in the X-Y plane. This aspect is, as described above, preferable in an aspect that the region where the magnetization is disturbed, which is the edge portion of the first magnetic layer 201, included in the region where the first magnetic layer 201 and the second magnetic layer 202 overlap is reduced. Therefore, this is preferable in an aspect of obtaining a high gauge factor.

However, as illustrated in FIG. 9B, the centroid of the first magnetic layer 201 and the centroid of the second magnetic layer 202 may be shifted in the X-Y plane. As illustrated in FIG. 9B, the second magnetic layer 202 may protrude from the first magnetic layer 201 in the X-Y plane. This aspect as well, as described above, can obtain the effect of reducing the region where the magnetization is disturbed, which is the edge portion of the first magnetic layer 201, included in the region where the first magnetic layer 201 and the second magnetic layer 202 overlap.

As illustrated in FIG. 9A and FIG. 9B, the shape of the X-Y plane of the first magnetic layer 201 may be an approximately square shape. Alternatively, as illustrated in FIG. 9C and FIG. 9D, the first magnetic layer 201 may be an approximately rectangular shape having a difference between the dimensions in the X direction and the dimensions in the Y direction so as to provide the shape magnetic anisotropy. Similarly, as illustrated in FIG. 9A and FIG. 9C, the shape of the X-Y plane of the second magnetic layer 202 may be an approximately square shape. Alternatively, as illustrated i n FIG. 9B and FIG. 9D, the second magnetic layer 202 may be an approximately rectangular shape having a difference between the dimensions in the X direction and the dimensions in the Y direction so as to provide the shape magnetic anisotropy.

In the case where at least one of the first magnetic layer 201 and the second magnetic layer 202 is formed into the approximately rectangular shape in the X-Y plane, the long axis direction becomes a direction for easy magnetization. Therefore, for example, without the use of the hard bias, the initial magnetization direction of the first magnetic layer 201 can be set. This allows reducing a manufacturing cost of the strain detecting element 200.

As illustrated in FIG. 9E and FIG. 9F, the shape of the X-Y plane of the first magnetic layer 201 may be an approximately circular shape. Alternatively, as illustrated in FIG. 9G, the X-Y plane may be an oval shape (elliptical shape) so as to provide the shape magnetic anisotropy. Alternatively, as illustrated in FIG. 9F, the shape of the X-Y plane of the second magnetic layer 202 may be the approximately circular shape. Further, as illustrated in FIG. 9E, FIG. 9F, and FIG. 9G, these first magnetic layer 201 and second magnetic layer 202 can be used in combination appropriately. The planar shape of the first magnetic layer 201 and the second magnetic layer 202 may be formed in any shape.

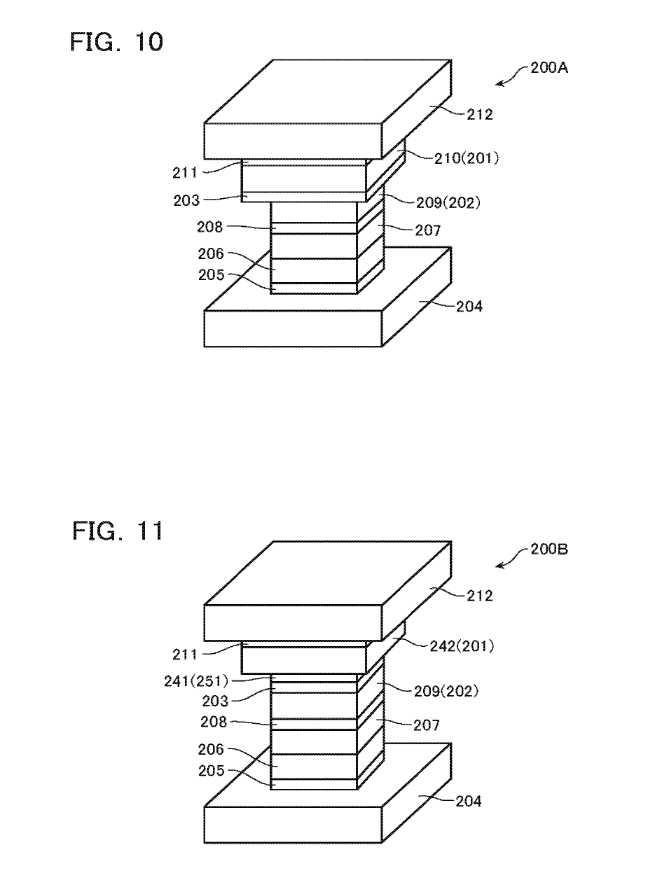

The following describes exemplary configurations of the strain detecting element 200 according to the embodiment with reference to FIG. 10 to FIG. 17. Hereinafter, the description of a “material A/material B” indicates a state where a layer of the material B is disposed over a layer of the material A.

FIG. 10 is a schematic perspective view illustrating an exemplary configuration 200A of the strain detecting element 200. As illustrated in FIG. 10, the strain detecting element 200A is configured by laminating a lower electrode 204, an under layer 205, a pinning layer 206, a second magnetization fixed layer 207, a magnetic coupling layer 208, a first magnetization fixed layer 209 (second magnetic layer 202), the intermediate layer 203, a magnetization free layer 210 (first magnetic layer 201), a cap layer 211, and an upper electrode 212 in this order. The first magnetization fixed layer 209 corresponds to the second magnetic layer 202. The magnetization free layer 210 corresponds to the first magnetic layer 201. The planar shapes of the first magnetization fixed layer 209 (second magnetic layer 202), the intermediate layer 203, and the magnetization free layer 210 (first magnetic layer 201) of the strain detecting element 200A illustrated in FIG. 10 are similar to the structures illustrated in FIG. 2. The strain detecting element 200A illustrated in FIG. 10 may also use the planar shapes of the first magnetization fixed layer 209 (second magnetic layer 202), the intermediate layer 203, and the magnetization free layer 210 (first magnetic layer 201) illustrated in FIG. 6A and FIG. 7C.

As the under layer 205, for example, Ta/Ru are used. The thickness of this Ta layer (length in the Z-axis direction) is, for example, 3 nanometers (nm). The thickness of this Ru layer is, for example, 2 nm. For the pinning layer 206, for example, an IrMn layer at the thickness of 7 nm is used. For the second magnetization fixed layer 207, for example, a Co₇₅Fe₂₅ layer at the thickness of 2.5 nm is used. For the magnetic coupling layer 208, for example, an Ru layer at the thickness of 0.9 nm is used. For the first magnetization fixed layer 209, for example, a Co₄₀Fe₄₀B₂₀ layer at the thickness of 3 nm is used. For the intermediate layer 203, for example, an MgO layer at the thickness of 1.6 nm is used. For the magnetization free layer 210, for example, the Co₄₀Fe₄₀B₂₀ layer at the thickness of 4 nm is used. For the cap layer 211, for example, Ta/Ru are used. The thickness of this Ta layer is, for example, 1 nm. The thickness of this Ru layer is, for example, 5 nm.

For the lower electrode 204 and the upper electrode 212, for example, at least any of aluminum (Al), aluminum copper alloy (Al—Cu), copper (Cu), silver (Ag), and gold (Au) is used. As a first electrode and a second electrode, the use of such material of comparatively small electrical resistance allows efficiently passing a current to the strain detecting element 200A. For the lower electrode 204 and the upper electrode 212, a non-magnetic material can be used.

The lower electrode 204 and the upper electrode 212 may include, for example, under layers (not illustrated) for the lower electrode 204 and the upper electrode 212, cap layers (not illustrated) for the lower electrode 204 and the upper electrode 212, and at least any of layers made of Al, Al—Cu, Cu, Ag, and Au disposed between the under layers and the cap layers. For example, for the lower electrode 204 and the upper electrode 212, tantalum (Ta)/copper (Cu)/tantalum (Ta), or a similar material is used. The use of Ta as the under layers of the lower electrode 204 and the upper electrode 212, for example, improves adhesiveness between a substrate and the lower electrode 204 and adhesiveness between the cap layer 211 and the upper electrode 212. As the under layers for the lower electrode 204 and the upper electrode 212, titanium (Ti), titanium nitride (TiN), or a similar material may be used.

The use of Ta as the cap layers of the lower-electrode 204 and the upper electrode 212 can prevent oxidation of the copper (Cu) or a similar material, which is disposed under the cap layer. As the cap layers for the lower electrode 204 and the upper electrode 212, titanium (Ti), titanium nitride (TiN), or a similar material may be used.

For the under layer 205, a laminated structure including, for example, a buffer layer (not illustrated) and a seed layer (not illustrated) can be used. This buffer layer, for example, reduces roughness of the surface of the lower electrode 204, the film portion 120, or a similar portion and improves crystalline of layers laminated on this buffer layer. As the buffer layer, for example, at least any one of materials selected from the group consisting of tantalum (Ta), titanium (Ti), vanadium (V), tungsten (W), zirconium (Zr), hafnium (Hf), and chrome (Cr) is used. As the buffer layer, an alloy containing at least one material selected from these materials may be used.

In the under layer 205, the thickness of the buffer layer is preferable to be 1 nm or more to 10 nm or less. The thickness of the buffer layer is more preferable to be 1 nm or more to 5 nm or less. If the thickness of the buffer layer is too thin, a buffer effect is lost. If the thickness of the buffer layer is too thick, the thickness of the strain detecting element 200 becomes excessively thick. When forming the seed layer on the buffer layer, the seed layer can have the buffer effect. In this case, the buffer layer may be omitted. For the buffer layer, for example, the Ta layer at the thickness of 3 nm is used.

The seed layer in the under layer 205 controls a crystalline orientation of a layer laminated on this seed layer. This seed layer controls a crystal grain size of the layer laminated on this seed layer. As this seed layer, a metal of a face-centered cubic structure (fcc structure), a hexagonal close-packed structure (hcp structure), or a body-centered cubic structure (bcc structure) or a similar material is used.

As the seed layer in the under layer 205, ruthenium (Ru) of the hcp structure, NiFe of the fcc structure, or Cu of the fcc structure is used. This, for example, allows the crystalline orientation of a spin-valve film on the seed layer to fcc (111) orientation. For the seed layer, for example, the Cu layer at the thickness of 2 nm or the Ru layer at the thickness of 2 nm is used. To enhance the crystalline orientation property of the layer formed on the seed layer, the thickness of the seed layer is preferable to be 1 nm or more to 5 nm or less. The thickness of the seed layer is more preferable to be 1 nm or more to 3 nm or less. This sufficiently provides a function as the seed layer, which improves the crystalline orientation.

On the other hand, for example, in the case where crystal grains of the layer formed on the seed layer needs not to be orientated (for example, in the case where the magnetization free layer made of amorphous is formed), the seed layer may be omitted. As the seed layer, for example, the Cu layer at the thickness of 2 nm is used.

The pinning layer 206 fixes the magnetization of the second magnetization fixed layer 207 using, for example, an unidirectional anisotropy applied to the second magnetization fixed layer 207 (ferromagnetic layer), which is formed on the pinning layer 206. For the pinning layer 206, for example, an antiferromagnetic layer is used. For the pinning layer 206, for example, at least any of materials selected from the group consisting of Ir—Mn, Pt—Mn, Pd—Pt—Mn, Ru—Mn, Rh—Mn, Ru—Rh—Mn, Fe—Mn, Ni—Mn, Cr—Mn—Pt, and Ni—O is used. For the pinning layer 206, an alloy further containing an additive element to Ir—Mn, Pt—Mn, Pd—Pt—Mn, Ru—Mn, Rh—Mn, Ru—Rh—Mn, Fe—Mn, Ni—Mn, Cr—Mn—Pt, and Ni—O may be used. To give the unidirectional anisotropy having sufficient strength, the thickness of the pinning layer 206 is appropriately set.

To fix the magnetization of the ferromagnetic layer in contact with the pinning layer 206, an annealing process is performed during applying a magnetic field. The magnetization of the ferromagnetic layer in contact with the pinning layer 206 is fixed in the direction of the magnetic field, which is applied during the annealing process. An annealing temperature, for example, is set to a magnetization fixation temperature or more of the antiferromagnetic material used for the pinning layer 206. In the case where the antiferromagnetic layer including Mn is used, Mn is diffused in the layer other than the pinning layer 206. This may reduce a MR ratio. Accordingly, setting the annealing temperature equal to or less than the temperature where the Mn diffusion occurs is desirable. For example, 200 degrees (° C.) or more to 500 degrees (° C.) or less can be set. Preferably, 250 degrees (° C.) or more to 400 degrees (° C.) or less can be set.

In the case where PtMn or PdPtMn is used as the pinning layer 206, the thickness of the pinning layer 206 is preferable to be 8 nm or more to 20 nm or less. The thickness of the pinning layer 206 is more preferable to be 10 nm or more to 15 nm or less. In the case where IrMn is used as the pinning layer 206, the unidirectional anisotropy can be provided at the thickness thinner than the case where PtMn is used as the pinning layer 206. In this case, the thickness of the pinning layer 206 is preferable to be 4 nm or more to 18 nm or less. The thickness of the pinning layer 206 is more preferable to be 5 nm or more to 15 nm or less. For the pinning layer 206, for example, an Ir₂₂Mn₇₈ layer at the thickness of 7 nm is used.

As the pinning layer 206, a hard magnetic layer may be used. As the hard magnetic layer, for example, a hard magnetic material where a magnetic anisotropy and a coercivity are comparatively high, for example, Co—Pt, Fe—Pt, Co—Pd, and Fe—Pd is used. An alloy further containing an additive element to Co—Pt, Fe—Pt, Co—Pd, and Fe—Pd may be used. For example, CoPt (proportion of Co is 50 at. % or more to 85 at. % or less), (CoₓPt₁₀₀₋ₓ)_{100-y}Cr_{y} (x is 50 at. % or more to 85 at. % or less, and y is 0 at. % or more to 40 at. % or less), or FePt (proportion of Pt is 40 at. % or more to 60 at . % or less) may be used.

For the second magnetization fixed layer 207, for example, a CoₓFe₁₀₀₋ₓ alloy (x is 0 at. % or more to 100 at. % or less), an NiₓFe₁₀₀₋ₓ alloy (x is 0 at. % or more to 100 at. % or less), or a material containing the non-magnetic element to these materials is used. As the second magnetization fixed layer 207, for example, at least any of materials selected from the group consisting of Co, Fe, and Ni is used. As the second magnetization fixed layer 207, an alloy containing at least one material selected from these materials may be used. As the second magnetization fixed layer 207, (COₓFe₁₀₀₋ₓ)_{100-y}B_{y} alloy (x is 0 at. % or more to 100 at. % or less, and y is 0 at. % or more to 30 at. % or less) can also be used. As the second magnetization fixed layer 207, the use of amorphous alloy of (CoₓFe₁₀₀₋ₓ)_{100-y}B_{y} allows reducing a variation of characteristics of the strain detecting element 200A even if a size of the strain detecting element is small.

The thickness of the second magnetization fixed layer 207 is, for example, preferable to be 1.5 nm or more to 5 nm or less. Accordingly, for example, the strength of the unidirectional anisotropy field caused by the pinning layer 206 can be further strengthened. For example, via the magnetic coupling layer formed on the second magnetization fixed layer 207, the strength of antiferromagnetic coupling field between the second magnetization fixed layer 207 and the first magnetization fixed layer 209 can be further strengthened. For example, a magnetic film thickness of the second magnetization fixed layer 207 (product of saturation magnetization Bs and thickness t (Bs·t)) is preferable to be a substantially equal to the magnetic film thickness of the first magnetization fixed layer 209.

The saturation magnetization of Co₄₀Fe₄₀B₂₀ formed to the thin film is around 1.9 T (tesla). For example, as the first magnetization fixed layer 209, the use of the Co₄₀Fe₄₀B₂₀ layer at the thickness of 3 nm forms the first magnetization fixed layer 209 at the magnetic film thickness of 1.9 T×3 nm, which is 5.7 Tnm. On the other hand, the saturation magnetization of Co₇₅Fe₂₅ is around 2.1 T. The thickness of the second magnetization fixed layer 207 where the magnetic film thickness equal to the above-described magnetic film thickness is obtained is 5.7 Tnm/2.1 T, which is 2.7 nm. In this case, the use of the Co₇₅Fe₂₅ layer at the thickness of around 2.7 nm for the second magnetization fixed layer 207 is preferable. As the second magnetization fixed layer 207, for example, the Co₇₅Fe₂₅ layer at the thickness of 2.5 nm is used.

In the strain detecting element 200A, a synthetic pin structure formed by the second magnetization fixed layer 207, the magnetic coupling layer 208, and the first magnetization fixed layer 209 is used. Instead, a single pin structure formed of a single-layer magnetization fixed layer may be used. In the case where the single pin structure is used, as the magnetization fixed layer, for example, the Co₄₀Fe₄₀B₂₀ layer at the thickness of 3 nm is used. As the ferromagnetic layer used for the magnetization fixed layer in the single pin structure, the material same as the material of the above-described second magnetization fixed layer 207 may be used.

The magnetic coupling layer 208 generates an antiferromagnetic coupling between the second magnetization fixed layer 207 and the first magnetization fixed layer 209. The magnetic coupling layer 208 forms the synthetic pin structure. As the magnetic coupling layer 208, for example, Ru is used. The thickness of the magnetic coupling layer 208 is, for example, preferable to be 0.8 nm or more to 1 nm or less. As long as the material generates sufficient antiferromagnetic coupling between the second magnetization fixed layer 207 and the first magnetization fixed layer 209, a material other than Ru may be used as the magnetic coupling layer 208. The thickness of the magnetic coupling layer 208 can be set to 0.8 nm or more to 1 nm or less corresponding to a second peak (2nd peak) of Ruderman-Kittel-Kasuya-Yosida (RKKY) coupling. Furthermore, the thickness of the magnetic coupling layer 208 may be set to the thickness of 0.3 nm or more to 0.6 nm or less corresponding to a first peak (1st peak) of the RKKY coupling. As the magnetic coupling layer 208, for example, Ru at the thickness of 0.9 nm is used. This allows further stably obtaining the highly reliable coupling.

The magnetic layer used for the first magnetization fixed layer 209 directly contributes to the MR effect. As the first magnetization fixed layer 209, for example, Co—Fe—B alloy is used. Specifically, as the first magnetization fixed layer 209, (CoₓFe₁₀₀₋ₓ)_{100-y}B_{y} alloy (x is 0 at. % or more to 100 at. % or less while y is 0 at. % or more to 30 at. % or less) can also be used. As the first magnetization fixed layer 209, in the case where amorphous alloy of (CoₓFe₁₀₀₋ₓ)_{100-y}B_{y} is used, for example, even if the size of the strain detecting element 200 is small, a variation between the elements caused by the crystal grains can be reduced.

The layer formed on the first magnetization fixed layer 209 (for example, a tunnel insulating layer (not illustrated)) can be flattened. Flattening the tunnel insulating layer allows reducing a defect density of the tunnel insulating layer. This allows obtaining a larger MR ratio at a lower areal resistance. For example, in the case where MgO is used as the material of the tunnel insulating layer, using the amorphous alloy of (CoₓFe₁₀₀₋ₓ)_{100-y}B_{y} as the first magnetization fixed layer 209 allows strengthening the orientation of the MgO layer (100), which is formed on the tunnel insulating layer. Further increasing the orientation of the MgO layer (100) allows obtaining a larger MR ratio. (CoₓFe₁₀₀₋ₓ)_{100-y}B_{y} alloy is crystallized using the surface of the MgO layer (100) as a template during annealing. This allows obtaining a good crystal conformation between MgO and (CoₓFe₁₀₀₋ₓ)_{100-y}B_{y} alloy. Obtaining good crystal conformation allows obtaining a further larger MR ratio. As the first magnetization fixed layer 209, in addition to the Co—Fe—B alloy, for example, the Fe—Co alloy may be used.

The thicker first magnetization fixed layer 209 allows obtaining a larger MR ratio. To obtain a larger fixed magnetic field, forming the thin first magnetization fixed layer 209 is preferable. The MR ratio and the fixed magnetic field have the relationship of trade-off regarding the thickness of the first magnetization fixed layer 209. To use a Co—Fe—B alloy as the first magnetization fixed layer 209, the thickness of the first magnetization fixed layer 209 is preferable to be 1.5 nm or more to 5 nm or less. The thickness of the first magnetization fixed layer 209 is more preferable to be 2.0 nm or more to 4 nm or less.

For the first magnetization fixed layer 209, in addition to the above-described materials, a Co₉₀Fe₁₀ alloy in the fcc structure, Co in the hcp structure, or an Co alloy in the hcp structure is used. As the first magnetization fixed layer 209, for example, at least one material selected from the group consisting of Co, Fe, and Ni is used. As the first magnetization fixed layer, an alloy containing at least one material selected from these materials is used. As the first magnetization fixed layer 209, using the FeCo alloy material in the bcc structure, the Co alloy containing cobalt composition of 50% or more, or a material of Ni composition of 50% or more (Ni alloy) allows obtaining, for example, a larger MR ratio.

As the first magnetization fixed layer 209, for example, a Heusler magnetic alloy layer such as Co₂MnGe, Co₂FeGe, Co₂MnSi, Co₂FeSi, Co₂MnAl, Co₂FeAl, Co₂MnGa_{0.5}Ge_{0.5}, and Co₂FeGa_{0.5}Ge_{0.5} can also be used. For example, as the first magnetization fixed layer 209, for example, the Co₄₀Fe₄₀B₂₀ layer at the thickness of 3 nm is used.

The intermediate layer 203, for example, separates the magnetic coupling between the first magnetic layer 201 and the second magnetic layer 202. For the intermediate layer 203, for example, metal, an insulator, or a semiconductor is used. As this metal, for example, Cu, Au, Ag, or a similar material is used. To use metal as the intermediate layer 203, the thickness of the intermediate layer is, for example, around 1 nm or more to 7 nm or less. As this insulator or semiconductor, for example, magnesium oxide (such as MgO), aluminum oxide (such as Al₂O₃), titanium oxide (such as TiO), zinc oxide (such as ZnO), or Gallium oxide (Ga—O) is used. To use the insulator or the semiconductor as the intermediate layer 203, the thickness of the intermediate layer 203 is, for example, around 0.6 or more to 2.5 nm or less. As the intermediate layer 203, for example, a Current-Confined-Path (CCP) spacer layer may be used. To use the CCP spacer layer as the spacer layer, for example, a structure where a copper (Cu) metal path is formed in an insulating layer made of aluminum oxide (Al₂O₃) is used. For example, as the intermediate layer, the MgO layer at the thickness of 1.6 nm is used.

For the magnetization free layer 210, a ferromagnetic material is used. The ferromagnetic material containing, for example, Fe, Co, or Ni can be used for the magnetization free layer 210. As the material of the magnetization free layer 210, for example, an FeCo alloy, an NiFe alloy or the like is used. Furthermore, for the magnetization free layer 210, an Co—Fe—B alloy, an Fe—Co—Si—B alloy; a material having a large λs (magnetostriction constant) such as an Fe—Ga alloy, an Fe—Co—Ga alloy, a Tb-M-Fe alloy, Tb-M1-Fe-M2 alloy, Fe-M3-M4-B alloy, Ni, Fe—Al; ferrite; or a similar material is used. In the above-described Tb-M-Fe alloy, M is at least one material selected from, the group consisting of Sm, Eu, Gd, Dy, Ho, and Er. In the above-described Tb-M1-Fe-M2 alloy, M1 is at least one material selected from the group consisting of Sm, Eu, Gd, Dy, Ho, and Er. M2 is at least one material selected from the group consisting of Ti, Cr, Mn, Co, Cu, Nb, Mo, W, and Ta. In the above-described Fe-M3-M4-B alloy, M3 is at least one selected from the group consisting of Ti, Cr, Mn, Co, Cu, Nb, Mo, W, and Ta. M4 is at least one material selected from the group consisting of Ce, Pr, Nd, Sm, Tb, Dy, and Er. The above-described ferrite includes Fe₃O₄, (FeCo)₃O₄, or a similar material. The thickness of the magnetization free layer 210 is, for example, 2 nm or more.

For the magnetization free layer 210, a magnetic material containing boron may be used. For the magnetization free layer 210, for example, an alloy containing at least one element selected from the group consisting of Fe, Co, and Ni and boron (B) may be used. For example, the Co—Fe—B alloy and the Fe—B alloy can be used. For example, the Co₄₀Fe₄₀B₂₀ alloy can be used. When using an alloy containing at least one element selected from the group consisting of Fe, Co, and Ni and the boron (B) for the magnetization free layer 210, as an element to promote high magnetostriction, Ga, Al, Si, W, or a similar material may be added. For example, the Fe—Ga—B alloy, the Fe—Co—Ga—B alloy, or, the Fe—Co—Si—B alloy may be used. The use of such magnetic material containing boron decreases the coercivity (Hc) of the magnetization free layer 210. This facilitates a change in the magnetization direction caused by the strain. This allows obtaining high strain sensitivity.

A boron concentration in the magnetization free layer 210 (for example, a composition ratio of boron) is preferable to be 5 at. % (atomic percent) or more. This allows easily obtaining an amorphous structure. The boron concentration in the magnetization free layer is preferable to be 35 at. % or less. If the boron concentration is too high, for example, the magnetostriction constant is reduced. The boron concentration in the magnetization free layer is, for example, preferable to be 5 at. % or more to 35 at. % or less. The boron concentration is more preferable to be 10 at. % or more to 30 at. % or less.

To use Fe₁—_{y}B_{y} (0<y≤0.3) or (FeₐX₁₋ₐ)_{1-y}B_{y} (X═Co or Ni, 0.8 ≤ a <1, 0 < y ≤ 0.3) for a part of the magnetic layer of the magnetization free layer 210, the large magnetostriction constant λ and low coercivity can be easily obtained at the same time. Accordingly, this is especially preferable from the viewpoint of obtaining the high gauge factor. For example, as the magnetization free layer 210, Fe₈₀B₂₀ (4 nm) can be used. As the magnetization free layer, Co₄₀Fe₄₀B₂₀ (0.5 nm)/Fe₈₀B₂₀ (4 nm) can be used.

The magnetization free layer 210 may have a multilayer structure. When using the tunnel insulating layer made of MgO as the intermediate layer 203, disposing a layer made of the Co—Fe—B alloy at the part of the magnetization free layer 210 in contact with the intermediate layer 203 is preferable. This allows obtaining a high magnetoresistance effect. In this case, a layer of the Co—Fe—B alloy is disposed on the intermediate layer 203. On the layer of the Co—Fe—B alloy, another magnetic material having large magnetostriction constant is disposed. When the magnetization free layer 210 has the multilayer structure, for the magnetization free layer 210, for example, Co—Fe—B (2 nm)/Fe—Co—Si—B (4 nm) is used.

The cap layer 211 protects the layers disposed below the cap layer 211. For the cap layer 211, for example, a plurality of metal layers is used. For the cap layer 211, for example, a two-layer structure constituted of the Ta layer and the Ru layer (Ta/Ru) is used. The thickness of this Ta layer is, for example, 1 nm. The thickness of this Ru layer is, for example, 5 nm. As the cap layer 211, instead, of the Ta layer and the Ru layer, another metal layer may be disposed. The cap layer 211 can be configured as required. For example, as the cap layer 211, the non-magnetic material can be used. As long as the layer disposed, below the cap layer 211 can be protected, as the cap layer 211, another material may be used.

When using a magnetic material containing boron for the magnetization free layer 210, to prevent diffusion of the boron, a diffusion preventing layer (not illustrated) made of an oxide material or a nitride material may be disposed between the magnetization free layer 210 and the cap layer 211. The use of the diffusion preventing layer made of the oxide layer or the nitride layer reduces the diffusion of the boron contained in the magnetization free layer 210, thus allowing maintaining the amorphous structure of the magnetization free layer 210. As the oxide material and the nitride material used for the diffusion preventing layer, specifically, the oxide material and the nitride material containing art element such as Mg, Al, Si, Ti, V, Cr, Mn, Fe, Co, Ni, Cu, Zn, Zr, Nb, Mo, Ru, Rh, Pd, Ag, Hf, Ta, W, Sn, Cd, and Ga can be used. Here, the diffusion preventing layer is a layer not contributing to the magnetoresistance effect. Therefore, the lower the areal resistance, the more the diffusion preventing layer is preferable. For example, the areal resistance of the diffusion preventing layer is preferable to be set lower than the areal resistance of the intermediate layer contributing to the magnetoresistance effect. From the viewpoint of decreasing the areal resistance of the diffusion preventing layer, the use of an oxide or nitride of low barrier height, Mg, Ti, V, Zn, Sn, Cd, or Ga is preferable. As the function to minimize the diffusion of boron, an oxide featuring stronger chemical bonding is preferable. For example, MgO with a thickness of 1.5 nm can be used. The oxynitride can be regarded as any of the oxide or the nitride.

When using the oxide material or the nitride material for the diffusion preventing layer, the film thickness of the diffusion preventing layer is preferable to be 0.5 nm or more from the viewpoint of fully providing the diffusion preventing function of the boron, and from the viewpoint of reducing the areal resistance, 5 nm or less is preferable. That is, the film thickness of the diffusion preventing layer is preferable to be 0.5 nm or more to 5 nm or less and further preferable to be 1 nm or more to 3 nm or less.

As the diffusion preventing layer, at least any of materials selected from the group consisting of magnesium (Mg) silicon (Si), and aluminum (Al) can be used. As the diffusion preventing layer, a material containing these light elements can be used. These light elements are coupled to the boron to generate a chemical compound. For example, at least any of an Mg—B chemical, compound, an Al—B chemical compound, and an Si—B chemical compound is formed at a part including the interface between the diffusion preventing layer and the magnetization free layer 210. These chemical compounds minimize the diffusion of the boron.

Another metal layer or a similar layer may be inserted between the diffusion preventing layer and the magnetization free layer 210. Note that if a distance between the diffusion preventing layer and the magnetization free layer 210 is too far, the boron diffuses between the diffusion preventing layer and the magnetization free layer 210; therefore, the boron concentration in the magnetization free layer 210 is reduced. Accordingly, the distance between the diffusion preventing layer and the magnetization free layer 210 is preferable to be 10 nm or less and more preferable to be 3 nm or less.

FIG. 11 is a schematic perspective view illustrating another exemplary configuration 200B of the strain detecting element 200. The strain detecting element 200B is, different from the strain detecting element 200A, formed by including the third magnetic layer 251 between the intermediate layer 203 and the first magnetic layer 201. That is, as illustrated in FIG. 11, the strain detecting element 200B is configured by laminating the lower electrode 204, the under layer 205, the pinning layer 206, the second magnetization fixed layer 207, the magnetic coupling layer 208, the first magnetization fixed layer 209 (second magnetic layer 202), the intermediate layer 203, a second magnetization free layer 241 (third magnetic layer 251), a first magnetization free layer 242 (first magnetic layer 201), the cap layer 211, and the upper electrode 212 in this order. The first magnetization fixed layer 209 corresponds to the second magnetic layer 202. The second magnetization free layer 241 corresponds to the third magnetic layer 251. The first magnetization free layer 242 corresponds to the first magnetic layer 201. The planar shapes of the first magnetization fixed layer 209 (second magnetic layer 202), the intermediate layer 203, the second magnetization free layer 241 (third magnetic layer 251), and the first magnetization free layer 242 (first magnetic layer 201) of the strain detecting element 200B illustrated in FIG. 11 are similar to the structures illustrated in FIG. 8A.

As the under layer 205, for example, Ta/Ru are used. The thickness of this Ta layer (length in the Z-axis direction) is, for example, 3 nanometers (nm). The thickness of this Ru layer is, for example, 2 nm. For the pinning layer 206, for example, the IrMn layer at the thickness of 7 nm is used. For the second magnetization fixed layer 207, for example, a Co₇₅Fe₂₅ layer at the thickness of 2.5 nm is used. For the magnetic coupling layer 208, for example, the Ru layer at the thickness of 0.9 nm is used. For the first magnetization fixed layer 209, for example, a Co₄₀Fe₄₀B₂₀ layer at the thickness of 3 nm is used. For the intermediate layer 203, for example, an MgO layer at the thickness of 1.6 nm is used. For the second, magnetization free layer 241, for example, a Co₄₀Fe₄₀B₂₀ layer at the thickness of 1.5 nm is used. For the first magnetization free layer 242, for example, a Co₄₀Fe₄₀B₂₀ layer at the thickness of 4 nm is used. For the cap layer 211, for example, Ta/Ru are used. The thickness of this Ta layer is, for example, 1 nm. The thickness of this Ru layer is, for example, 5 nm.

In the strain detecting element 200B illustrated in FIG. 11, the planer dimensions of the second magnetization free layer 241 is similar to the planer dimensions of the first magnetization fixed layer 209. Here, the second magnetization free layer 241 magnetically couples to the first magnetization free layer 242, thus allowing functioning as the magnetization free layer. Here, the second magnetization free layer 241 has the element dimensions smaller than the first magnetization free layer 242 similar to the first magnetization fixed layer 209. However, the second magnetization free layer 241 is connected and magnetically coupled to the central region of the first magnetization free layer 242 whose dimensions are relatively large and therefore the disturbance of magnetization is small. Accordingly, the disturbance of magnetization of the second magnetization free layer 241 can also be reduced. This allows obtaining the effect of the embodiment. The use of the strain detecting element 200B illustrated in FIG. 11, as described later, allows manufacturing a laminated structure near the intermediate layer 203, which significantly contributes to the MR effect among the laminated structure of the magnetization fixed layer/the intermediate layer/the magnetization free layer, at a time in vacuum. This is preferable in an aspect of obtaining a high MR ratio.

Here, as the material used for the second magnetization free layer 241, the material similar to the material used for the above-described magnetization free layer 210 (FIG. 10) can be used. If the film thickness of the second magnetization free layer 241 is too thick, an effect of reducing the disturbance of magnetization due to the magnetic coupling with the first magnetization free layer 242 is degraded. Accordingly, the film thickness is preferable to be 4 nm or less and more preferable to be 2 nm or less. As the material used for the first magnetization free layer 242, the material similar to the material used for the above-described magnetization free layer 210 (FIG. 10) can be used. As materials for other respective layers, the materials similar to the materials of the strain detecting element 200A can be used.

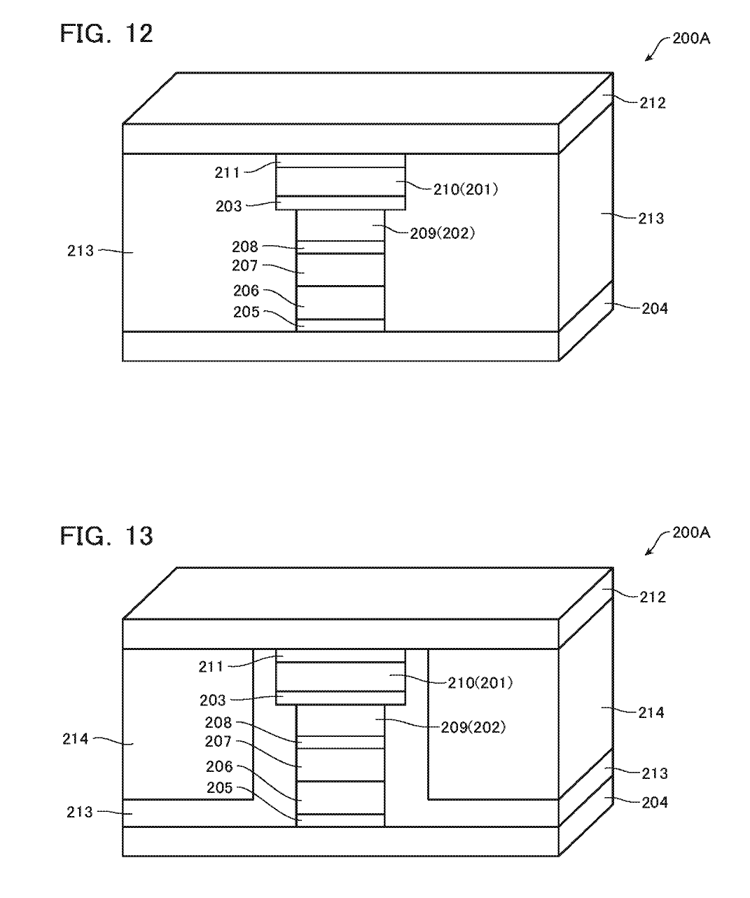

FIG. 12 is a schematic perspective view illustrating an exemplary configuration of the strain detecting element 200A. As exemplified in FIG. 12, the strain detecting element 200A may include an insulating layer (insulating part) 213. The insulating layer 213 is filled between the lower electrode 204 and the upper electrode 212.

For the insulating layer 213, for example, an aluminum oxide (such as Al₂O₃) or a silicon oxide (such as SiO₂) can be used. The insulating layer 213 can reduce a leak current of the strain detecting element 200A.

FIG. 13 is a schematic perspective view illustrating another exemplary configuration of the strain detecting element 200A. As exemplified in FIG. 13, the strain detecting element 200A may include two hard bias layers (hard bias parts) 214, the lower electrode 204, and the insulating layer 213. The hard bias layers 214 are disposed between the lower electrode 204 and the upper electrode 212 so as to be separate from one another. The insulating layer 213 is filled between the upper electrode 212 and the hard bias layer 214.

The hard bias layer 214 sets the magnetization direction of the magnetization free layer 210 (first magnetic layer 201) a desired direction by magnetization of the hard bias layer 214. With the hard bias layer 214, in a state where external pressure is not applied to the film portion, the magnetization direction of the magnetization free layer 210 (first magnetic layer 201) can be set to the desired direction.

As the hard bias layer 214, for example, a hard magnetic material e a magnetic anisotropy and a coercivity are compartively high, for example, Co—Pt, Fe—Pt, Co—Pd, and Fe—Pd is used. An alloy further containing an additive element to Co—Pt, Fe—Pt, Co—Pd, and Fe—Pd may be used. For example, CoPt (proportion of Co is 50 at. % or more to 85 at. % or less), (CoₓPt₁₀₀₋ₓ)_{100-y}Cr_{y} (x is 50 at. % or more to 85 at. % or less, and y is 0 at. % or more to 40 at. % or less), or FePt (proportion of Pt is 40 at. % or more to 60 at. % or less) may be used. When using such materials, by applying an external magnetic field larger than the coercivity of the hard bias layer 214, the magnetization direction of the hard bias layer 214 can be set (fixed) to the direction of applying the external magnetic field. The thickness of the hard bias layer 214 (for example, length along the direction from the lower electrode 204 to the upper electrode 212) is, for example, 5 nm or more to 50 nm or less.

When arranging the insulating layer 213 between the lower electrode 204 and the upper electrode 212, as the material of the insulating layer 213, SiOₓ and AlOₓ can be used. Furthermore, between the insulating layer 213 and the hard bias layer 214, an under layer (not illustrated) may be disposed. When using Co—Pt, Fe—Pt, Co—Pd, Fe—Pd, or a similar material, which is a hard magnetic material having comparatively high magnetic anisotropy and coercivity, for the hard bias layer 214, as the material of the under layer for the hard bias layer 214, Cr, Fe—Co, or a similar material can be used. The above-described hard bias layer 214 is also applicable to any strain detecting elements described later.

The hard bias layer 214 may have a structure of being laminated on a pinning layer for hard bias layer (not illustrated). In this case, by exchange coupling between the hard bias layer 214 and the pinning layer for hard bias layer, the magnetization direction of the hard bias layer 214 can be set (fixed). In this case, for the hard bias layer 214, a material at least any of Fe, Co, and Ni or a ferromagnetic material formed of an alloy containing at least one kind of these materials can be used. In this case, for the hard bias layer 214, for example, CoₓFe₁₀₀₋ₓ alloy (x is 0 at. % or more to 100 at. % or less), NixFe₁₀₀₋ₓ alloy (x is 0 at. % or more to 100 at. % or less), or a material where the non-magnetic element is added to these materials can be used. As the hard bias layer 214, the material similar to the above-described first magnetization fixed layer 209 can be used. For the pinning layer for hard bias layer, the material made of the material similar to the material of the pinning layer 206 in the above-described strain detecting element 200A can be used. In the case where the pinning layer for hard bias layer is disposed, the under layer similar to the material used for the under layer 205 may be disposed below the pinning layer for hard bias layer. The pinning layer for hard bias layer may be disposed at the lower portion of the hard bias layer or may be disposed at the upper portion of the hard bias layer. The magnetization direction of the hard bias layer 214 in this case can be determined by annealing in a magnetic field similar to the pinning layer 206.

The above-described hard bias layer 214 and insulating layer 213 are applicable to all the strain detecting elements 200A described in the embodiments. Assume the case where the laminated structure constituted of the hard bias layer 214 and the pinning layer for hard bias layer, which is as described above, is used. In this case, even if a large external magnetic field is instantaneously applied to the hard bias layer 214, the magnetization direction of the hard bias layer 214 can be easily maintained.

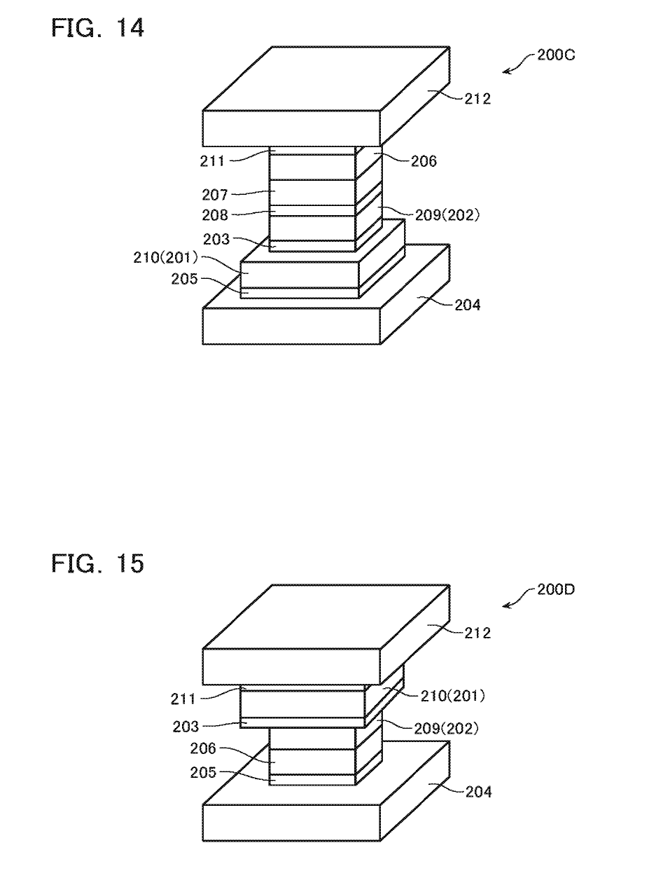

FIG. 14 is a schematic perspective view illustrating another exemplary configuration 200C of the strain detecting element 200. The strain detecting element 200C is, different from the strain detecting element 200A, has a top spin-valve type structure. That is, as illustrated in FIG. 14, the strain detecting element 200C is configured by laminating the lower electrode 204, the under layer 205, the magnetization free layer 210 (first magnetic layer 201), the intermediate layer 203, the first magnetization fixed layer 209 (second magnetic layer 202), the magnetic coupling layer 208, the second magnetization fixed layer 207, the pinning layer 206, the cap layer 211, and the upper electrode 212 in this order. The first magnetization fixed layer 209 corresponds to the second magnetic layer 202. The magnetization free layer 210 corresponds to the first magnetic layer 201. The planar shapes of the first magnetization fixed layer 209 (second magnetic layer 202), the intermediate layer 203, and the magnetization free layer 210 (first magnetic layer 201) of the strain detecting element 200C illustrated in FIG. 14 are similar to the structures illustrated in FIG. 6C. The strain detecting element 200C illustrated in FIG. 14 may also use the planar shapes of the first magnetization fixed layer 209 (second magnetic layer 202), the intermediate layer 203, and the magnetization free layer 210 (first magnetic layer 201) illustrated in FIG. 6B and FIG. 7A. The structure as illustrated in FIG. 8B where the third magnetic layer 251 is added may be used.

For the under layer 205, for example, Ta/Cu are used. The thickness of this Ta layer (length in the Z-axis direction) is, for example, 3 nm. The thickness of this Cu layer is, for example, 5 nm. For the magnetization free layer 210, for example, a Co₄₀Fe₄₀B₂₀ layer at the thickness of 4 nm is used. For the intermediate layer 203, for example, the MgO layer at the thickness of 1.6 nm is used. For the first magnetization fixed layer 209, for example, Co₄₀Fe₄₀B₂₀/Fe₅₀Co₅₀ are used. The thickness of this Co₄₀Fe₄₀B₂₀ layer is, for example, 2 nm. The thickness of this Fe₅₀Co₅₀ layer is, for example, 1 nm. For the magnetic coupling layer 208, for example, the Ru layer at the thickness of 0.9 nm is used. For the second magnetization fixed layer 207, for example, a Co₇₅Fe₂₅ layer at the thickness of 2.5 nm is used. For the pinning layer 206, for example, the IrMn layer at the thickness of 7 nm is used. For the cap layer 211, for example, Ta/Ru are used. The thickness of this Ta layer is, for example, 1 nm. The thickness of this Ru layer is, for example, 5 nm.

In the above-described strain detecting element 200A in the bottom spin-valve type, the first magnetization fixed layer 209 (second magnetic layer 202) is formed lower than the magnetization free layer 210 (first magnetic layer 201) (-Z-axis direction). In contrast to this, in the strain detecting element 200C in the top spin-valve type, the first magnetization fixed layer 209 (second magnetic layer 202) is formed above the magnetization free layer 210 (first magnetic layer 201) (+Z-axis direction). Therefore, the materials of the respective layers contained in the strain detecting element 200C can be used by vertically inverting the materials of the respective layers contained in the strain detecting element 200A. The above-described diffusion preventing layer can be disposed between the under layer 205 and the magnetization free layer 210 of the strain detecting element 200C.

FIG. 15 is a schematic perspective view illustrating another exemplary configuration 200D of the strain detecting element 200. The single pin structure using a single magnetization fixed layer is applied to the strain detecting element 200D. That is, as illustrated in FIG. 15, the strain detecting element 200D is configured by laminating the lower electrode 204, the under layer 205, the pinning layer 206, the first magnetization fixed layer 209 (second magnetic layer 202), the intermediate layer 203, the magnetization free layer 210 (first magnetic layer 201), and the cap layer 211 in this order. The first magnetization fixed layer 209 corresponds to the second magnetic layer 202. The magnetization free layer 210 corresponds to the first magnetic layer 201. The planar shapes of the first magnetization fixed layer 209 (second magnetic layer 202), the intermediate layer 203, and the magnetization free layer 210 (first magnetic layer 201) of the strain detecting element 200D illustrated in FIG. 15 are similar to the structures illustrated in FIG. 2. The strain detecting element 200D illustrated in FIG. 15 may also use the planar shapes of the first magnetization fixed layer 209 (second magnetic layer 202), the intermediate layer 203, and the magnetization free layer 210 (first magnetic layer 201) illustrated in FIG. 6A and FIG. 7C. The structure as illustrated in FIG. 8A where the third magnetic layer 251 is added may be used.

For the under layer 205, for example, Ta/Ru are used. The thickness of this Ta layer (length in the Z-axis direction) is, for example, 3 nm. The thickness of this Ru layer is, for example, 2 nm. For the pinning layer 206, for example, the IrMn layer at the thickness of 7 nm is used. For the first magnetization fixed layer 209, for example, the Co₄₀Fe₄₀B₂₀ layer at the thickness of 3 nm is used. For the intermediate layer 203, for example, the MgO layer at the thickness of 1.6 nm is used. For the magnetization free layer 210, for example, a Co₄₀Fe₄₀Ba₂₀ layer at the thickness of 4 nm is used. For the cap layer 211, for example, Ta/Ru are used. The thickness of this Ta layer is, for example, 1 nm. The thickness of this Ru layer is, for example, 5 nm.

For the materials of the respective layers of the strain detecting element 200D, the materials similar to the materials of the respective layers of the strain detecting element 200A can be used.

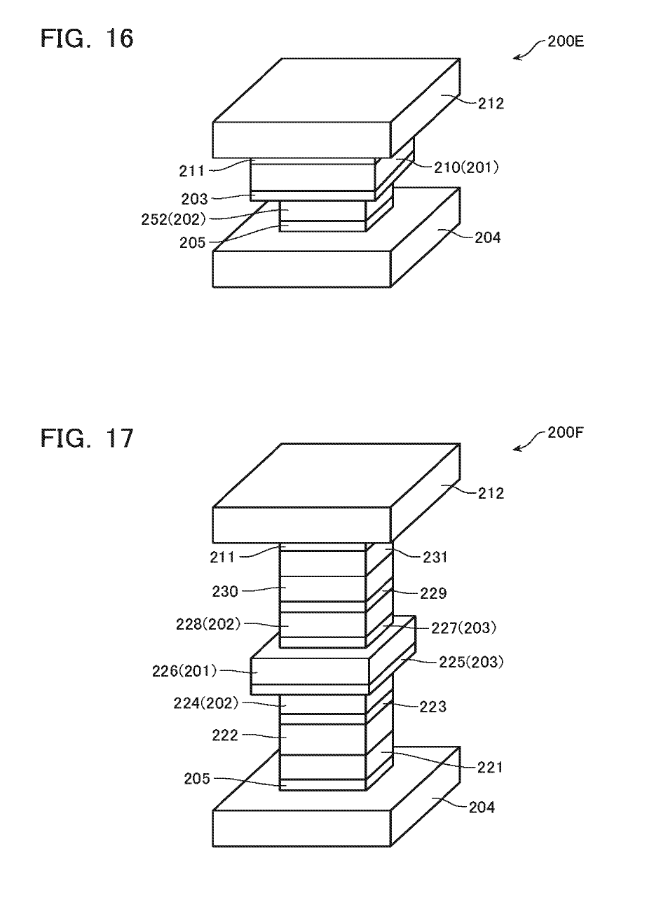

FIG. 16 is a schematic perspective view illustrating another exemplary configuration 200E of the strain detecting element 200. In the strain detecting element 200E, the second magnetic layer 202 is made function as a reference layer 252, not as the magnetization fixed layer. That is, as illustrated in FIG. 16, the strain detecting element 200E is configured by laminating the lower electrode 204, the under layer 205, the reference layer 252 (second magnetic layer 202), the intermediate layer 203, the magnetization free layer 210 (first magnetic layer 201), and the cap layer 211 in this order. The first magnetization fixed layer 209 corresponds to the second magnetic layer 202. The magnetization free layer 210 corresponds to the first magnetic layer 201. The planar shapes of the reference layer 252 (second magnetic layer 202), the intermediate layer 203, and the magnetization free layer 210 (first magnetic layer 201) of the strain detecting element 200E illustrated in FIG. 16 are similar to the structures illustrated in FIG. 2. The strain detecting element 200E illustrated in FIG. 16 may also use the planar shapes of the reference layer 252 (second magnetic layer 202), the intermediate layer 203, and the magnetization free layer 210 (first magnetic layer 201) illustrated in FIG. 6A and FIG. 7C. The structure as illustrated, in FIG. 8A where the third magnetic layer 251 is added may be used.

As the under layer 205, for example, Cr is used. The thickness of this Cr layer (length in the Z-axis direction) is, for example, 5 nm. For the reference layer 252, for example, a Co₈₀Pt₂₀ layer at the thickness of 10 nm is used. For the intermediate layer 203, for example, the MgO layer at the thickness of 1.6 nm is used. For the magnetization free layer 210, for example, a Co₄₀Fe₄₀B₂₀ layer at the thickness of 4 nm is used. For the cap layer 211, for example, Ta/Ru are used. The thickness of this Ta layer is, for example, 1 nm. The thickness of this Ru layer is, for example, 5 nm.

Here, a material used for the reference layer 252 can be selected such that an aspect of a change in the magnetization direction caused by the same strain may be different from the material used for the magnetization free layer 210. For example, for the reference layer 252, a material that is less likely to change the magnetization direction caused by the strain compared with the magnetization free layer 210 can be used.

As the reference layer 252, for example, the hard magnetic material where the magnetic anisotropy and the coercivity are comparatively high, for example, Co—Pt, Fe—Pt, Co—Pd, and Fe—Pd is used. An alloy further containing an additive element to Co—Pt, Fe—Pt, Co—Pd, and Fe—Pd may be used. By using the hard magnetic material having high magnetic anisotropy, a reference layer where the change in the magnetization direction caused by strain is less likely to occur compared with the magnetization free layer or hardly occurs can be obtained. For example, CoPt (proportion of Co is 50 at . % or more to 85 at. % or less), (CoₓPt₁₀₀₋ₓ)_{100-y}Cr_{y} (x is 50 at . % or more to 85 at. % or less, and y is 0 at . % or more to 40 at. % or less), or FePt (proportion of Pt is 40 at. % or more to 60 at. % or less) may be used. When using such materials, by applying the external magnetic field larger than the coercivity of the reference layer 252, the magnetization direction of the reference layer 252 cart be set (fixed) to the direction of applying the external magnetic field. The thickness of the reference layer 252 (for example, length along the direction from the lower electrode to the upper electrode) is, for example, 5 nm or more to 50 nm or less.

For example, for the reference layer, a material at least any of Fe, Co, and Ni or a ferromagnetic material formed of an alloy containing at least one kind of these materials can be used. In this case, for the reference layer, the ferromagnetic material having low magnetostriction constant can be used. By using the ferromagnetic material having low magnetostriction constant, even if the magnetic anisotropy of the material is not so high, the reference layer where the change in the magnetization direction caused by strain is less likely to occur compared with the magnetization free layer or hardly occurs can be obtained.

As materials for other respective layers of the strain detecting element 200E, the materials similar to the materials of the respective layers of the strain detecting element 200A can foe used.

FIG. 17 is a schematic perspective view illustrating another exemplary configuration 200F of the strain detecting element 200. As illustrated in FIG. 17, in the strain detecting element 200F, the second magnetic layers 202 are formed above and below the first magnetic layer 201 via the intermediate layers 203. That is, as illustrated in FIG. 17, the strain detecting element 200F is configured by laminating the lower electrode 204, the under layer 205, a lower pinning layer 221, a lower second magnetization fixed layer 222, a lower magnetic: coupling layer 223, a lower first magnetization fixed layer 224, a lower intermediate layer 225, a magnetization free layer 226, an upper intermediate layer 227, an upper first magnetization fixed layer 228, an upper magnetic coupling layer 229, an upper second magnetization fixed layer 230, an upper pinning layer 231, the cap layer 211, and the upper electrode 212 in this order. The lower first magnetization fixed layer 224 and the upper first magnetization fixed layer 228 correspond to the second magnetic layer 202. The magnetization free layer 226 corresponds to the first magnetic layer 201. The planar shapes of the lower first magnetization fixed layer 224 (second magnetic layer 202) the lower intermediate layer 225 (intermediate layer 203) the magnetization free layer 226 (first magnetic layer 201) the upper intermediate layer 227 (intermediate layer 203), and the upper first magnetization fixed layer 228 (second magnetic layer 202) of the strain detecting element 200F illustrated in FIG. 17 are a combination of the structures illustrated in FIG. 6D and FIG. 6E.

As the under layer 205, for example, Ta/Ru are used. The thickness of this Ta layer (length in the Z-axis direction) is, for example, 3 nanometers (nm). The thickness of this Ru layer is, for example, 2 nm. For the lower pinning layer 221, for example, the IrMn layer at the thickness of 7 nm is used. For the lower second magnetization fixed layer 222, for example, the Co₇₅Fe₂₅ layer at the thickness of 2.5 nm is used. For the lower magnetic coupling layer 223, for example, the Ru layer at the thickness of 0.9 nm is used. For the lower first magnetization fixed layer 224, for example, the Co₄₀Fe₄₀B₂₀ layer at the thickness of 3 nm is used. For the lower intermediate layer 225, for example, the MgO layer at the thickness of 1.6 nm is used. For the magnetization free layer 226, for example, a Co₄₀Fe₄₀B₂₀ layer at the thickness of 4 nm is used. For the upper intermediate layer 227, for example, the MgO layer at the thickness of 1.6 nm is used. For the upper first magnetization fixed layer 228, for example, Co₄₀Fe₄₀B₂₀/Fe₅₀Co₅₀ are used. The thickness of this Co₄₀Fe₄₀B₂₀ layer is, for example, 2 nm. The thickness of this Fe₅₀Co₅₀ layer is, for example, 1 nm. For the upper magnetic coupling layer 229, for example, the Ru layer at the thickness of 0.9 nm is used. For the upper second magnetization fixed layer 230, for example, the Co₇₅Fe₂₅ layer at the thickness of 2.5 nm is used. For the upper pinning layer 231, for example, the IrMn layer at the thickness of 7 nm is used. For the cap layer 211, for example, Ta/Ru are used. The thickness of this Ta layer is, for example, 1 nm. The thickness of this Ru layer is, for example, 5 nm.

For the materials of the respective layers of the strain detecting element 200F, the materials similar to the materials of the respective layers of the strain detecting element 200A can be used.

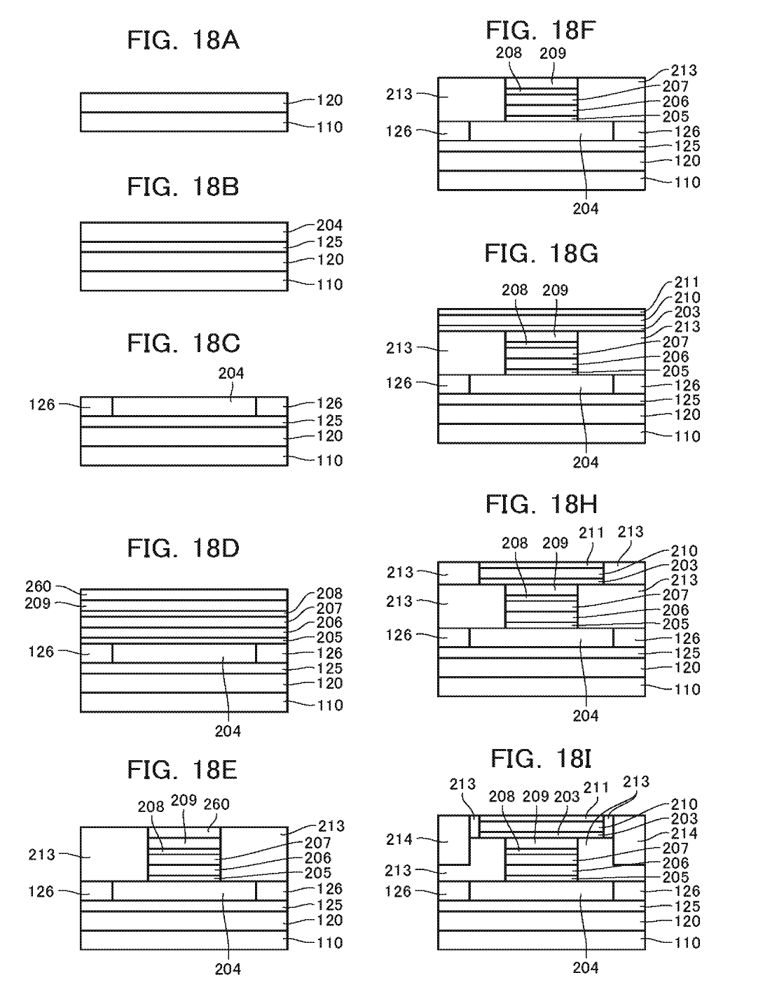

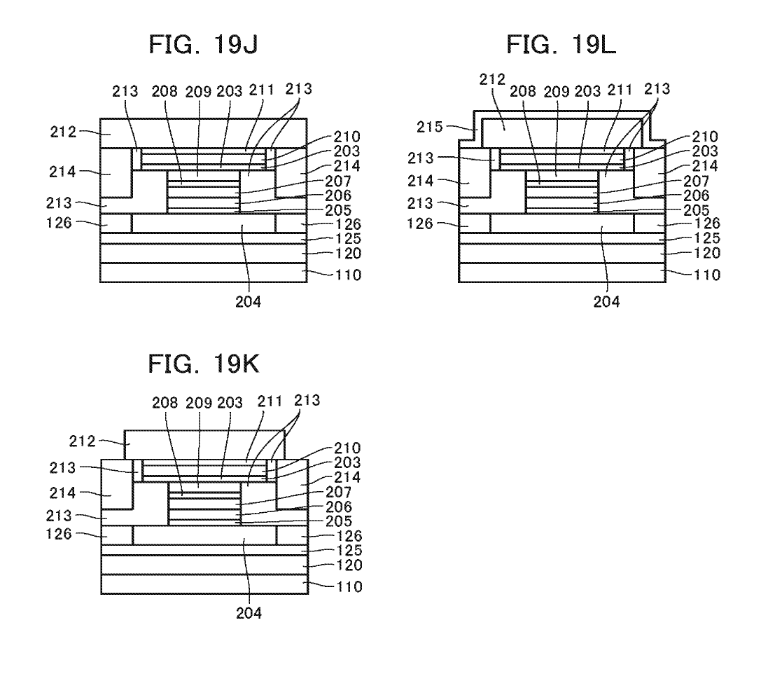

The following describes a method for manufacturing the strain detecting element 200 according to the embodiment with reference to FIG. 18A to FIG. 19K. FIG. 18A to FIG. 19K are schematic cross-sectional views illustrating a state for manufacturing, for example, the strain detecting element 200A illustrated in FIG. 10.

When manufacturing the strain detecting element 200, for example, as illustrated in FIG. 18A, the film portion 120, a wiring (not illustrated), or a similar member can be formed on a substrate 110. Next, as illustrated in FIG. 18B, an insulating layer 125 and the lower electrode 204 are formed on the film portion 120. For example, as the insulating layer 125, SiOₓ (80 nm) is formed. For example, as the lower electrode 204, Ta (5 nm)/Cu (200 nm)/Ta (35 nm) are formed. After this, a surface smoothing treatment such as a CMP process may be performed on an outermost surface of the lower electrode 204 to flatten a constitution formed on the lower electrode. Here, when configuring the outermost surface of the film portion 120 by a material having an insulating property, the formation of the insulating layer 125 is not always necessarily. When the substrate 110 itself is finally formed to be deformable, the film portion 120 is not necessarily to be disposed separately from the substrate 110.

Next, as illustrated in FIG. 18C, the planar shape of the lower electrode 204 is processed. This process patterns a resist by photolithography. Afterwards, using the resist pattern (not illustrated) as a mask, physical milling or chemical milling is performed. For example, Ar ion milling is performed. Furthermore, an insulating layer 126 is embedded at the periphery of the lower electrode 204. In this process, for example, a liftoff process is performed. For example, while leaving the resist pattern, which is formed by the photolithography, the insulating layer 126 is formed on the entire surface, and the resist pattern is removed. As the insulating layer 126, for example, SiOₓ, AlOₓ, SiNₓ, and AlNₓ can be used.

Next, as illustrated in FIG. 18D, the under layer 205, the pinning layer 206, the second magnetization fixed layer 207, the magnetic coupling layer 208, the first magnetization fixed layer 209, and an intermediate cap layer 260 are laminated on the lower electrode 204 in this order. For example, as the under layer 205, Ta (3 nm)/Ru (2 nm) are formed. As the pinning layer 206, IrMn (7 nm) is formed on the under layer 205. As the second magnetization fixed layer 207/the magnetic coupling layer 208/the first magnetization fixed layer 209, Co₇₅Fe₂₅ (2.5 nm)/Ru (0.9 nm)/Co₄₀Fe₄₀B₂₀ (8 nm) are formed on the pinning layer 206. Further, as the intermediate cap layer 260, MgO (3 nm) is formed. Here, the intermediate cap layer 260 and a part of the first magnetization fixed layer 209 are removed in a process described later.

Next, as illustrated in FIG. 18E, the under layer 205, the pinning layer 206, the second magnetization fixed layer 207, the magnetic coupling layer 208, the first magnetization fixed, layer 209 (second magnetic layer 202), and the intermediate cap layer 260 are removed leaving a part of them. This process patterns a resist by photolithography. Afterwards, using the resist pattern (not illustrated) as a mask, the physical milling or the chemical milling is performed. For example, the Ar ion milling is performed.

Next, the insulating layer 213 is embedded at the periphery of the laminated body including the first magnetization fixed layer 209. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

Next, as illustrated in FIG. 18F, the intermediate cap layer 260, which is the outermost surface of the laminated body, a part of the first magnetization fixed layer 209, and a part of the insulating layer 213 are removed. This removal process performs the physical milling or a similar process. For example, the Ar ion milling or a substrate bias process using Ar plasma is performed. The process illustrated in FIG. 18F is performed inside of an apparatus that forms the laminated body including the magnetization free layer 210 (first magnetic layer 201), which is formed later. Thus, in a state where the outermost surface of the first magnetization fixed layer 209 (second magnetic layer 202) is cleaned, the process can transition to a formation of the intermediate layer in a vacuum. For example, after completely removing the MgO (3 nm) of the intermediate cap layer 260 and removing 5 nm from the Co₄₀Fe₄₀B₂₀ (8 nm) of the first magnetization fixed layer 209, as the first magnetization fixed layer 209, Co₄₀Fe₄₀B₂₀ (3 nm) is formed.

Next, as illustrated in FIG. 18G, the intermediate layer 203, the magnetization free layer 210 (first magnetic layer 201), and the cap layer 211 are laminated on the first magnetization fixed layer 209 in this order. For example, as the intermediate layer 203, MgO (1.6 nm) is formed. As the magnetization free layer 210, Co₄₀Fe₄₀B₂₀ (4 nm) is formed on the intermediate layer 203. As the cap layer 211, Cu (3 nm)/Ta (2 nm)/Ru (10 nm) are formed on the magnetization free layer 210. Between the magnetization free layer 210 and the cap layer 211, as the diffusion preventing layer (not illustrated), MgO (1.5 nm) may be formed.

Next, as illustrated in FIG. 18H, the intermediate layer 203, the magnetization free layer 210 (first magnetic layer 201), and the cap layer 211 are removed leaving a part of them. This process patterns a resist by photolithography. Afterwards, using the resist pattern (not illustrated) as a mask, the physical milling or the chemical milling is performed. For example, the Ar ion milling is performed. Here, the planer dimensions of the laminated body including the magnetization free layer 210 (first magnetic layer 201) are processed larger than the planer dimensions of the laminated body including the first magnetization fixed layer 209 (second magnetic layer 202).

Next, the insulating layer 213 is embedded at the periphery of the laminated body including the magnetization free layer 210. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

Next, a magnetic field annealing, which fixes the magnetization direction of the first magnetization fixed layer 209 (second magnetic layer 202), is performed. For example, while applying the external magnetic field at 7 kOe, annealing is performed for one hour at 300° C. Here, as long as performed after the process of FIG. 18D, which forms the laminated body including the second magnetic layer 202, the magnetic field annealing may be performed at any timing.

Next, as illustrated in FIG. 18I, the hard bias layers 214 are embedded into the insulating layers 213. For example, holes where the hard bias layers 214 are embedded are formed at the insulating layers 213. This process patterns a resist by photolithography. Afterwards, using the resist pattern (not illustrated) as a mask, the physical milling or the chemical milling is performed. This process may form the hole up to the depth penetrating the peripheral insulating layer 213 or may be stopped in midstream. FIG. 18I exemplifies the case where the formation of the hole is stopped in midstream so as not to penetrate the insulating layer 213. If the hole is etched up to the depth of penetrating the insulating layer 213, at the embedding process of the hard bias layer 214 illustrated in FIG. 18I, an insulating layer (not illustrated) need to be formed below the hard bias layer 214.

Next, the hard bias layers 214 are embedded into the formed holes. In this process, for example, the liftoff process is performed. For example, while leaving the resist pattern, which is formed by the photolithography, the hard bias layer 214 is formed on the entire surface, and the resist pattern is removed. Here, for example, as an under layer for hard bias layer, Cr (5 nm) is formed. As the hard bias layer 214, for example, Co₈₀Pt₂₀ (20 nm) is formed on the under layer for hard bias layer. Further, a cap layer (not illustrated) may be formed on the hard bias layer 214. As this cap layer, the materials described above as the materials applicable to the cap layer of the strain detecting element 200A may be used. Alternatively, as this cap layer, an insulating layer made of a material such as SiOₓ, AlOₓ, SiNₓ, and AlNₓ may be used.

Next, the external magnetic field is applied at room temperature, thus setting the magnetization direction of the hard magnetic material contained in the hard bias layer 214. The magnetization direction of the hard, bias layer 214 may be set by the external, magnetic field at any timing as long as performed after the embedding of the hard bias layer 214.

The embedding process of the hard bias layer 214 illustrated in FIG. 18I may be performed simultaneously with the embedding process of the insulating layer 213 illustrated, in FIG. 18H. The embedding process of the hard bias layer 214 illustrated in FIG. 18H is not necessarily to be performed

Next, as illustrated in FIG. 19J, the upper electrode 212 is laminated on the cap layer 211. Next, as illustrated in FIG. 19K, the upper electrode 212 is removed leaving a part of the upper electrode 212. This process patterns a resist by photolithography. Afterwards, using the resist pattern (not illustrated) as a mask, the physical milling or the chemical milling is performed.

Next, as illustrated in FIG. 19L, a protecting layer 215 is formed. The protecting layer 215 covers the upper electrode 212 and the hard bias layer 214. For example, as the protecting layer 215, an insulating layer made of a material such as SiOₓ, AlOₓ, SiNₓ, and AlNₓ may be used. The protecting layer 215 is not necessarily to be disposed.

Although not illustrated in FIG. 18A to FIG. 19L, a contact hole to the lower electrode 204 or the upper electrode 212 may be formed.

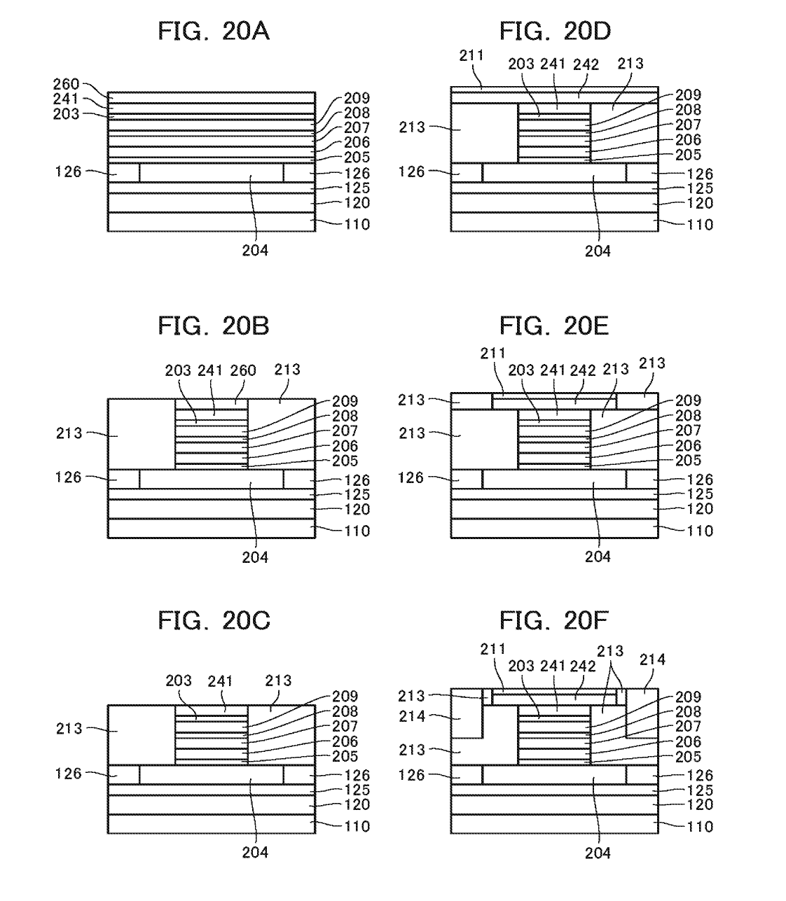

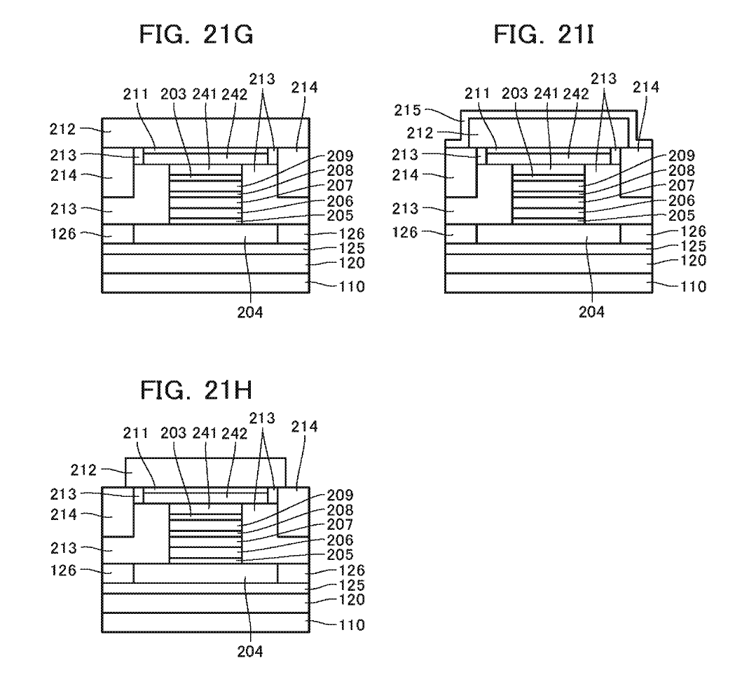

The following describes another method for manufacturing the strain detecting element 200 according to the embodiment with reference to FIG. 20A to FIG. 21H. FIG. 20A to FIG. 21H are schematic cross-sectional views illustrating a state for manufacturing, for example, the strain detecting element 200B illustrated in FIG. 11.

In this manufacturing method, the processes illustrated in FIG. 18A to FIG. 18C are performed similar to the method for manufacturing the strain detecting element 200A.

Next, as illustrated in FIG. 20A, the under layer 205, the pinning layer 206, the second magnetization fixed layer 207, the magnetic coupling layer 208, the first magnetization fixed layer 209, the intermediate layer 203, the second magnetization free layer 241 (third magnetic layer 251), and the intermediate cap layer 260 are laminated on the lower electrode 204 in this order. For example, as the under layer 205, Ta (3 nm)/Ru (2 nm) are formed. As the pinning layer 206, IrMn (7 nm) is formed on the under layer 205. As the second magnetization fixed layer 207/the magnetic coupling layer 208/the first magnetization fixed layer 209, Co₇₅Fe₂₅ (2.5 nm)/Ru (0.9 nm)/Co₄₀Fe₄₀B₂₀ (3 nm) are formed on the pinning layer 206. As the intermediate layer 203, MgO (1.6 nm) is formed on the first magnetization fixed layer 209. As the second magnetization free layer 241 (third magnetic layer 251), Co₄₀Fe₄₀B₂₀ (4 nm) is formed on the intermediate layer 203. Further, as the intermediate cap layer 260, MgO (3 nm) is formed on the second magnetization free layer 241. Here, the intermediate cap layer 260 and a part of the second magnetization free layer 241 are removed in a process described later.

Next, as illustrated in FIG. 20B, the under layer 205, the pinning layer 206, the second magnetization fixed layer 207, the magnetic coupling layer 208, the first magnetization fixed layer 209 (second magnetic layer 202), the intermediate layer 203, the second magnetization free layer 241 (third magnetic layer 251), and the intermediate cap layer 260 are removed leaving a part of them. This process patterns a resist by photolithography. Afterwards, using the resist pattern (not illustrated) as a mask, the physical milling or the chemical milling is performed. For example, the Ar ion milling is performed.

Next, the insulating layer 213 is embedded at the periphery of the laminated body including the first magnetization fixed layer 209. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

Next, as illustrated in FIG. 20C, the intermediate cap layer 260, which is the outermost surface of the laminated body, a part of the second magnetization free layer 241, and a part of the insulating layer 213 are removed. This removal process performs the physical milling or a similar process. For example, the Ar ion milling or the substrate bias process using Ar plasma is performed. The process illustrated in FIG. 20C is performed inside of the apparatus that forms the laminated body including the first magnetization free layer 242 (first magnetic layer 201), which is formed later. Thus, in a state where the outermost surface of the first magnetization fixed layer 209 (second magnetic layer 202) is purified, the process can transition to a formation of the intermediate layer in vacuum. For example, after completely removing the MgO (3 nm) of the intermediate cap layer 260 and removing 3 nm from the Co₄₀Fe₄₀B₂₀ (4 nm) of the second magnetization free layer 241, as the second magnetization free layer 241, Co₄₀Fe₄₀B₂₀ (1 nm) is formed.

Next, as illustrated in FIG. 20D, the first magnetization free layer 242 (first magnetic layer 201) and the cap layer 211 are laminated on the second magnetization free layer 241 in this order. For example, as the first magnetization free layer 242 (first magnetic layer 201), Co₄₀Fe₄₀B₂₀ (4 nm) is formed. As the cap layer 211, Cu (3 nm)/Ta (2 nm)/Ru (10 nm) are formed on the first magnetization free layer 242. Between the magnetization free layer 241 and the cap layer 211, as the diffusion preventing layer (not illustrated), MgO (1.5 nm) may be formed.

Next, as illustrated in FIG. 20E, the first magnetization free layer 242 (first magnetic layer 201) and the cap layer 211 are removed leaving a part of them. This process patterns a resist by photolithography. Afterwards, using the resist pattern (not illustrated) as a mask, the physical milling or the chemical milling is performed. For example, the Ar ion milling is performed. Here, the planer dimensions of the laminated body including first magnetization free layer 242 (first magnetic layer 201) are processed larger than the planer dimensions of the laminated body including the first magnetization fixed layer 209 (second magnetic layer 202).

Next, the insulating layer 213 is embedded at the periphery of the laminated body including the first magnetization free layer 242. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

Next, the magnetic field annealing, which fixes the magnetization direction of the first magnetization fixed layer 209 (second magnetic layer 202), is performed. For example, while applying the external magnetic field at 7 kOe, annealing is performed for one hour at 300° C. Here, as long as performed after the process of FIG. 20A, which forms the laminated body including the second magnetic layer 202, the magnetic field annealing may be performed at any timing.

Hereinafter, as illustrated in FIG. 20F and FIG. 21G to FIG. 21H, by the processes almost similar to the processes described with reference to FIG. 18I and FIG. 19J to FIG. 19K, the strain detecting element 200B illustrated in FIG. 11 can be manufactured. When using this manufacturing method, the process described with reference to FIG. 20A can form the laminated structure (the first magnetization fixed layer 209, the intermediate layer 203, and the second magnetization free layer 241) near the intermediate layer 203, which gives a significant influence to the MR effect, at a time in vacuum. Therefore, this is preferable from the aspect of obtaining the high MR ratio.

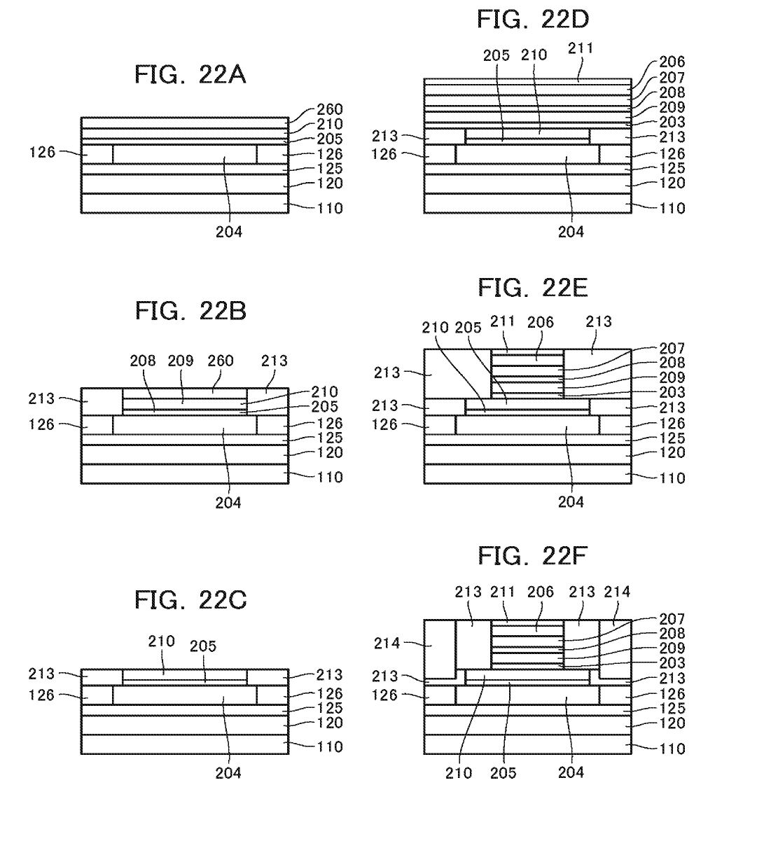

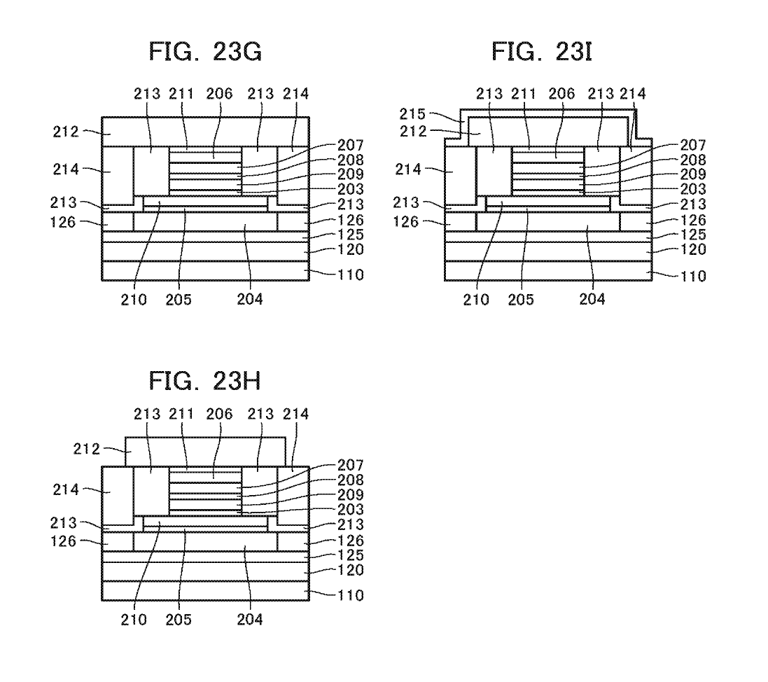

The following describes another method for manufacturing the strain detecting element 200 according to the embodiment with reference to FIG. 22A to FIG. 23H. FIG. 22A to FIG. 23H are schematic cross-sectional views illustrating a state for manufacturing, for example, the strain detecting element 200C illustrated in FIG. 14.

In this manufacturing method, the processes illustrated in FIG. 18A to FIG. 18C are performed similar to the method for manufacturing the strain detecting element 200A.

Next, as illustrated in FIG. 22A, the under layer 205, the magnetization free layer 210 (first magnetic layer 201), and the intermediate cap layer 260 are laminated on the lower electrode 204 in this order. For example, as the under layer 205, Ta (3 nm)/Cu (5 nm) are formed. As the magnetization free layer 210, Co₄₀Fe₄₀B₂₀ (8 nm) is formed on the under layer 205. Further, as the intermediate cap layer 260, MgO (3 nm) is formed on the magnetization free layer 210. Here, the intermediate cap layer 260 and a part of the magnetization free layer 210 are removed in a process described later. Between the magnetization free layer 210 and the under layer 205, as the diffusion preventing layer (not illustrated), MgO (1.5 nm) may be formed.

Next, as illustrated in FIG. 22B, the under layer 205, the magnetization free layer 210 (first magnetic layer 201), and the intermediate cap layer 260 are removed leaving a part of them. This process patterns a resist by photolithography. Afterwards, using the resist pattern (not illustrated) as a mask, the physical milling or the chemical milling is performed. For example, the Ar ion milling is performed.

Next, the insulating layer 213 is embedded at the periphery of the laminated body including the magnetization free layer 210. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

Next, as illustrated in FIG. 22C, the intermediate cap layer 260, which is the outermost surface of the laminated body, a part of the magnetization free layer 210, and a part of the insulating layer 213 are removed. This removal process performs the physical milling or a similar process. For example, the Ar ion milling or the substrate bias process using Ar plasma is performed. The process illustrated in FIG. 22C is performed inside of the apparatus that forms the laminated body including the intermediate layer 203 and the first magnetization fixed layer 209 (second magnetic layer 202), which are formed later. Thus, in a state where the outermost surface of the magnetization free layer 210 is purified, the process can transition to a formation of the intermediate layer in vacuum. For example, after completely removing the MgO (3 nm) of the intermediate cap layer 260 and removing 4 nm from the Co₄₀Fe₄₀B₂₀ (8 nm) of the magnetization free layer 210, as the magnetization free layer 210, Co₄₀Fe₄₀B₂₀ (4 nm) is formed.

Next, as illustrated in FIG. 22D, the intermediate layer 203, the first magnetization fixed layer 209 (second magnetic layer 202), the magnetic coupling layer 208, the second magnetization fixed layer 207, the pinning layer 206, and the cap layer 211 are laminated on the magnetization free layer 210 in this order. For example, as the intermediate layer 203, MgO (1.6 nm) is formed. As the first magnetization fixed layer 209 (second magnetic layer 202)/the magnetic coupling layer 208/the second magnetization fixed layer 207, Co₄₀Fe₄₀B₂₀ (2 nm)/Fe₅₀Co₅₀ (1 nm)/Ru (0.9 nm)/Co₇₅Fe₂₅ (2.5 nm) are formed. As the pinning layer 206, IrMn (7 nm) is formed on the second magnetization fixed layer 207. As the cap layer 211, Cu (3 nm)/Ta (2 nm)/Ru (10 nm) are formed on the pinning layer 206.

Next, as illustrated in FIG. 22E, the intermediate layer 203, the first magnetization fixed layer 209 (second magnetic layer 202), the magnetic coupling layer 208, the second magnetization fixed layer 207, the pinning layer 206, and the cap layer 211 are removed leaving a part of them. This process patterns a resist by photolithography. Afterwards, using the resist pattern (not illustrated) as a mask, the physical milling or the chemical milling is performed. For example, the Ar ion milling is performed. Here, the planer dimensions of the laminated body including the first magnetization fixed layer 209 (second magnetic layer 202) are processed smaller than the planer dimensions of the laminated body including the magnetization free layer 210 (first magnetic layer 201).

Next, the insulating layer 213 is embedded at the periphery of the laminated body including the first magnetization fixed layer 209. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

Next, the magnetic field annealing, which fixes the magnetization direction of the first magnetization fixed layer 209 (second magnetic layer 202), is performed. For example, while applying the external magnetic field at 7 kOe, annealing is performed for one hour at 300° C. Here, as long as performed after the process of FIG. 22D, which forms the laminated body including the second magnetic layer 202, the magnetic field annealing may be performed at any timing.

Hereinafter, as illustrated in FIG. 22F and FIG. 23G to FIG. 23H, by the processes almost similar to the processes described with reference to FIG. 18I and FIG. 19J to FIG. 19K, the strain detecting element 200C illustrated in FIG. 14 can be manufactured.

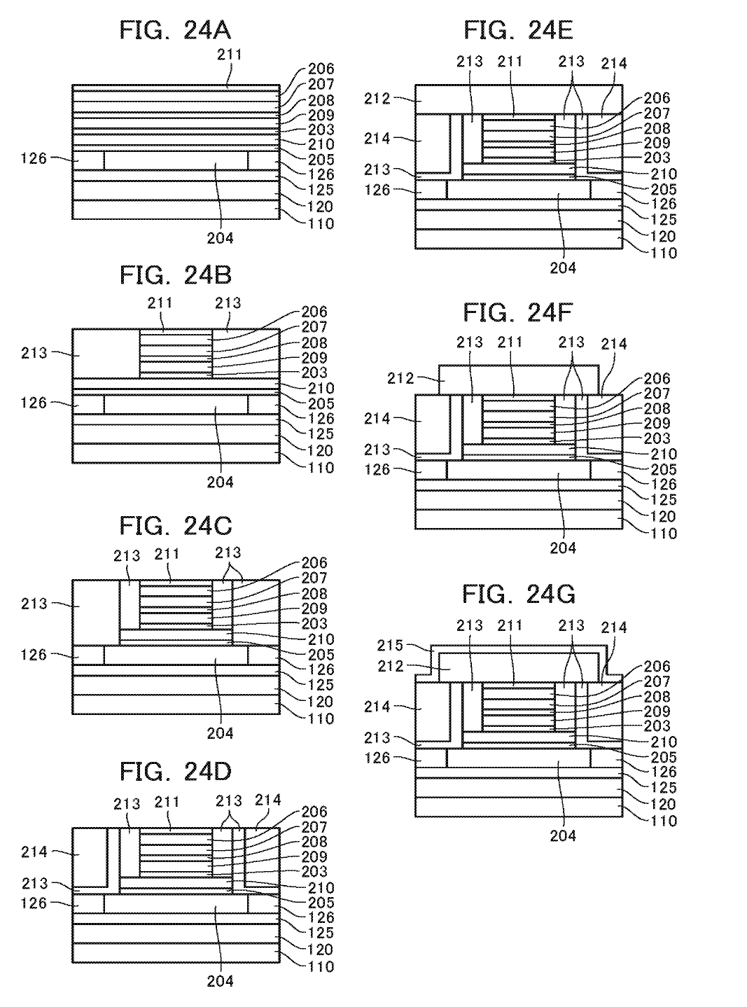

The following describes another method for manufacturing the strain detecting element 200 according to the embodiment with reference to FIG. 24A to FIG. 24G. FIG. 24A to FIG. 24G are, similar to the manufacturing method described with reference to FIG. 22A to FIG. 23H, schematic cross-sectional views illustrating a state for manufacturing, for example, the strain detecting element 200C illustrated in FIG. 14.

In this manufacturing method, the processes illustrated in FIG. 18A to FIG. 18C are performed similar to the method for manufacturing the strain detecting element 200A.

Next, as illustrated in FIG. 24A, the under layer 205, the magnetization free layer 210 (first magnetic layer 201), the intermediate layer 203, the first magnetization fixed layer 209 (second magnetic layer 202), the magnetic coupling layer 208, the second magnetization fixed layer 207, the pinning layer 206, and the cap layer 211 are laminated on the lower electrode 204 in this order. For example, as the under layer 205, Ta (3 nm)/Cu (5 nm) are formed. As the magnetization free layer 210, Co₄₀Fe₄₀B₂₀ (4 nm) is formed on the under layer 205. As the intermediate layer 203, MgO (1.6 nm) is formed on the magnetization free layer 210. As the first magnetization fixed layer 209 (second magnetic layer 202)/the magnetic coupling layer 208/the second magnetization fixed layer 207, Co₄₀Fe₄₀B₂₀ (2 nm)/Fe₅₀Co₅₀ (1 nm)/Ru (0.9 nm)/Co₇₅Fe₂₅ (2.5 nm) are formed on the intermediate layer 203. As the pinning layer 206, the IrMn (7 nm) is formed on the second magnetization fixed layer 207. As the cap layer 211, Cu (3 nm)/Ta (2 nm)/Ru (10 nm) are formed on the pinning layer 206. Here, between the magnetization free layer 210 and the under layer 205, as the diffusion preventing layer (not illustrated), MgO (1.5 nm) may be formed.

Next, as illustrated in FIG. 24B, the intermediate layer 203, the first magnetization fixed, layer 209 (second magnetic layer 202), the magnetic coupling layer 208, the second magnetization fixed layer 207, the pinning layer 206, and the cap layer 211 are removed leaving a part of them. This process patterns a resist by photolithography. Afterwards, using the resist pattern (not illustrated) as a mask, the physical milling or the chemical milling is performed. For example, the Ar ion milling is performed.

Next, the insulating layer 213 is embedded at the periphery of the laminated body including the first magnetization fixed layer 209. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used. This process stops the etching process up to a part of the intermediate layer 203 or the magnetization free layer 210 so as not to process all the planar shapes of the magnetization free layer 210.

Next, as illustrated in. FIG. 24C, the under layer 205, the magnetization free layer 210 (first magnetic layer 201), and the insulating layers 213, which are embedded in the above-described process, are removed leaving a part of them. This process patterns a resist by photolithography. Afterwards, using the resist pattern (not illustrated) as a mask, the physical milling or the chemical milling is performed. For example, the Ar ion milling is performed. This process performs the etching up to the under layer 205 so as to make the planar shape of the magnetization free layer 210 to be larger than the dimensions of the first magnetization fixed layer 209.

Next, the insulating layer 213 is embedded at the periphery of the laminated body including the magnetization free layer 210. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

Next, the magnetic field annealing, which fixes the magnetization direction of the first magnetization fixed layer 209 (second magnetic layer 202), is performed. For example, while applying the external magnetic field at 7 kOe, annealing is performed for one hour at 300° C. Here, as long as performed after the process of FIG. 24A, which forms the laminated body including the second magnetic layer 202, the magnetic field annealing may be performed at any timing.

Hereinafter, as illustrated in FIG. 24D to FIG. 24G, by the processes almost similar to the processes described with reference to FIG. 18I and FIG. 19 J to FIG. 19K, the strain detecting element 200C illustrated in FIG. 14 can be manufactured. When using this manufacturing method, the process described with reference to FIG. 24A can form the laminated structure (the magnetization free layer 210, the intermediate layer 203, and the first magnetization fixed layer 209) near the intermediate layer 203, which, gives a significant influence to the MR effect, at a time in vacuum. Therefore, this is preferable from the aspect of obtaining the high. MR ratio.

### 2. SECOND EMBODIMENT

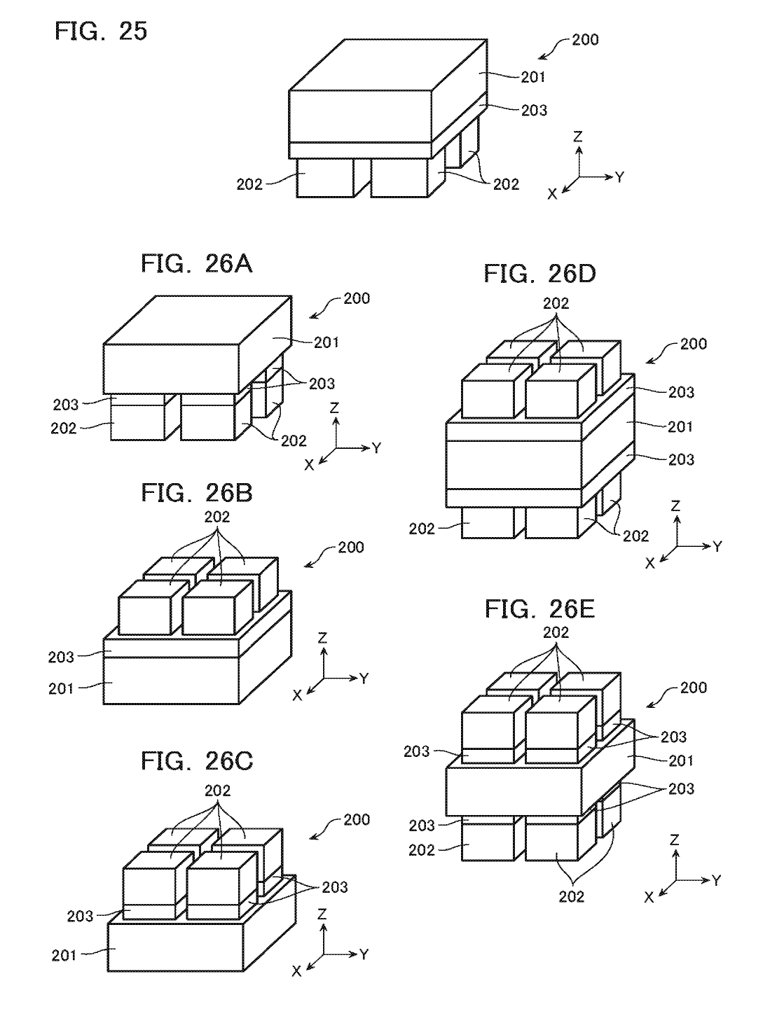

The following describes the configuration of the strain detecting element 200 according to the second embodiment with reference to FIG. 25. FIG. 25 is a schematic perspective view illustrating the configuration of the strain detecting element 200 according to the second embodiment. The strain detecting element 200 according to the embodiment can also be mounted on the pressure sensor illustrated in FIG. 1.

As illustrated in FIG. 25, the strain detecting element 200 according to the embodiment includes the plurality of second magnetic layers 202. In other words, the strain detecting element 200 has a plurality of junctions formed of the first magnetic layer 201, the intermediate layer 203, and the second magnetic layers 202. Therefore, electrically connecting the plurality of junctions in series or in parallel can improve a signal-noise ratio (SNR, SN ratio).

That is, illustrated in FIG. 25, the strain detecting element 200 according to the embodiment includes the first magnetic layer 201, the plurality of second magnetic layers 202, and the intermediate layer 203. The intermediate layer 203 is disposed between the first magnetic layer 201 and the second magnetic layers 202. The strain detecting element 200 according to the embodiment is, similar to the strain detecting element 200 according to the first embodiment, can detect a strain generated at the strain detecting element 200 using the inverse magnetostrictive effect and the MR effect.

In the embodiment, a ferromagnetic material is used for the first magnetic layer 201. The first magnetic layer 201, for example, functions as a magnetization free layer. A ferromagnetic layer is used for the second magnetic layer 202. The second magnetic layer 202, for example, functions as a reference layer. The second magnetic layer 202 may be a magnetization fixed layer or may be a magnetization free layer.

As illustrated in FIG. 25, the strain detecting element 200 includes the plurality of second magnetic layers 202. That is, the bottom surface of the first magnetic layer 201 faces the top surfaces of the plurality of second magnetic layers 202 via the intermediate layer 203. In other words, the second magnetic layers 202 are separated in at least one direction of the X direction and the Y direction. Therefore, the bottom surface of the first magnetic layer 201 partially faces any of the second magnetic layers 202. FIG. 25 illustrates an example where the strain detecting element 200 includes the four second magnetic layers 202. However, the number of the second magnetic layers 202 may be two or may be three or more.

As illustrated in FIG. 25, the first magnetic layer 201 is formed larger than the second magnetic layer 202. That is, the bottom surface of the first magnetic layer 201 facing the second magnetic layers 202 is formed wider than the top surfaces of the second magnetic layers 202 facing the first magnetic layer 201. In other words, dimensions of the X-Y plane of the first magnetic layer 201 are formed larger than dimensions of the X-Y planes of the second magnetic layers 202.

As illustrated in FIG. 25, the bottom surface of the first magnetic layer 201 partially faces the second magnetic layers 202. In contrast to this, the second magnetic layers 202 face the entire top surface of the first magnetic layer 201. In other words, the second magnetic layers 202 are disposed inside of the first magnetic layer 201 in the X-Y plane.

As illustrated in FIG. 25, the dimensions of the X-Y plane of the intermediate layer 203 approximately match the dimensions of the X-Y plane of the first magnetic layer 201.

Here, for example, when N pieces of the strain detecting elements 200 are electrically connected in series, a magnitude of the obtained electrical signal becomes N times. On the other hand, thermal noise and schottky noise become N^{1/2} times. That is, the signal-noise ratio (SNR, SN ratio) becomes N^{1/2} times. Therefore, increasing the number of strain detecting elements 200 N connected in series allows improving the SN ratio.

On the other hand, when disposing the plurality of junctions formed of the first magnetic layer 201, the intermediate layer 203, and the second magnetic layers 202, strain-electrical resistance properties at the respective junctions are desirable to be similar (or complete reverse polarity). To do so, the strain at the region including the plurality of junctions is preferred to be uniform.

Next, assume the case where the plurality of strain detecting elements 200 are disposed in a certain region and these strain detecting elements 200 are connected in series. For example, downsizing the strain detecting elements 200 allows increasing the number of strain detecting elements 200 disposed in this region. This allows connecting more strain detecting elements 200 in series. However, as described with reference to FIG. 4 and FIG. 5, if the dimensions of the strain detecting element 200 are small, due to the influence of the magnetic pole at the edge portion of the first magnetic layer 201, a diamagnetic field may be generated at the inside of the first magnetic layer 201. In this case, the gauge factors at the respective junctions may be reduced.

As illustrated in FIG. 25, the strain detecting element 200 according to the embodiment has the plurality of junctions formed of the first magnetic layer 201, the intermediate layer 203, and the second magnetic layers 202. The above-described MR effect affects the respective electrical resistance values at the plurality of junctions. Accordingly, for example, in the case where one electrode is connected to the first magnetic layer 201 while the other electrode is electrically connected to the plurality of second magnetic layers 202 in parallel, the plurality of strain detecting elements 200 can be connected in parallel. For example, the one electrode is electrically connected to the one second magnetic layer while the other electrode is electrically connected to the other second magnetic layer. This allows connecting the plurality of strain detecting elements 200 in series. This allows improving the SN ratio.

The strain detecting elements 200 according to the embodiment operates as the plurality of strain detecting elements 200 connected in series or in parallel. Therefore, for example, compared with the case where the plurality of strain detecting elements is independently disposed in a limited region, manufacturing the large first magnetic layers 201 is possible. Accordingly, the diamagnetic field inside of the first magnetic layer 201 can be reduced.

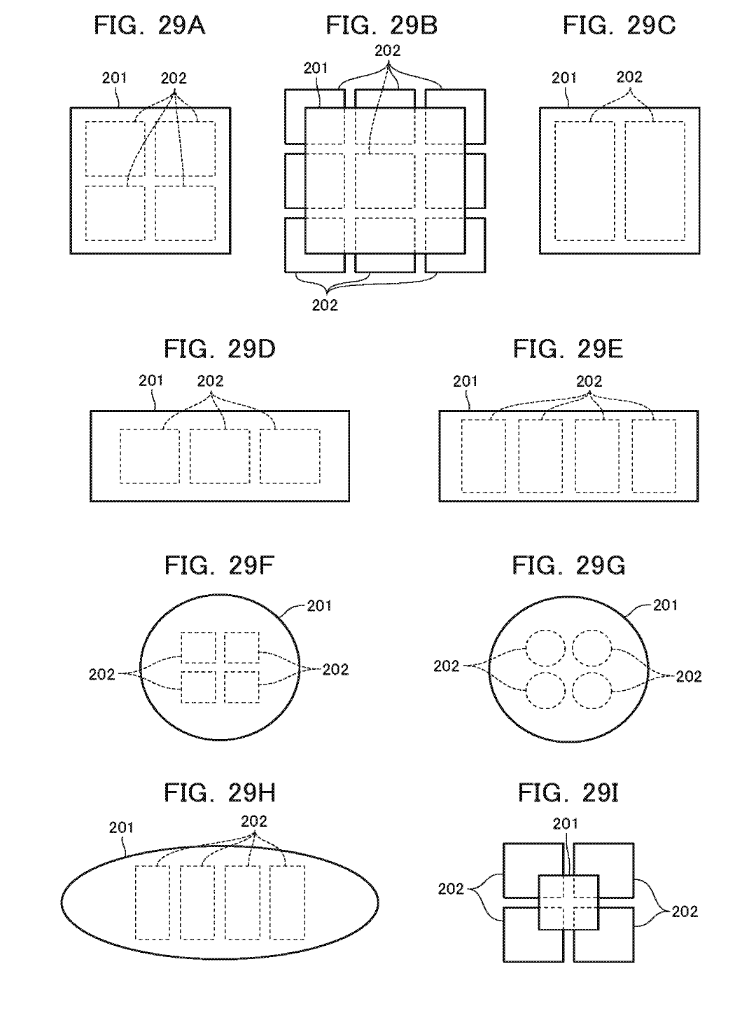

The following describes other exemplary configurations of the strain detecting element 200 with reference to FIG. 26A to FIG. 29I. FIG. 26A to FIG. 28 are schematic perspective views illustrating other exemplary configurations of the strain detecting element 200. FIG. 29A to FIG. 29I are schematic plan views illustrating another exemplary configuration of the strain detecting element 200. The strain detecting elements 200 according to respective exemplary configurations described later and the strain detecting element 200 illustrated in FIG. 25 can be used in combination with one another.

In the example illustrated in FIG. 25, the dimensions of the X-Y plane of the intermediate layer 203 approximately matches the dimensions of the X-Y plane of the first magnetic layer 201. However, as illustrated in FIG. 26A, the dimensions of the respective X-Y planes of the plurality of intermediate layers 203 may approximately match the dimensions of the respective X-Y planes of the plurality of second magnetic layers 202.

In the examples illustrated in FIG. 25 and FIG. 26A, the strain detecting element 200 is configured by laminating the second magnetic layers 202, the intermediate layer (s) 203, and the first magnetic layer 201 in this order. However, as illustrated in FIG. 26B and FIG. 26C, the strain detecting element 200 may be configured by laminating the first magnetic layer 201, the intermediate layer(s) 203, and the second magnetic layers 202 in this order.

In the examples illustrated in FIG. 25, FIG. 26A, FIG. 26B, and FIG. 26C, the strain detecting element 200 is configured by laminating the first magnetic layer 201 and the second magnetic layers 202 via the intermediate layer (s) 203 disposed at any one of an upper or a lower side of the first magnetic layer 201. However, as illustrated in FIG. 26D and FIG. 26E, the strain detecting element 200 may be configured by laminating the first magnetic layer 201 and the second magnetic layers 202 via the intermediate layers 203 disposed at both the upper side and lower side of the first magnetic layer 201.

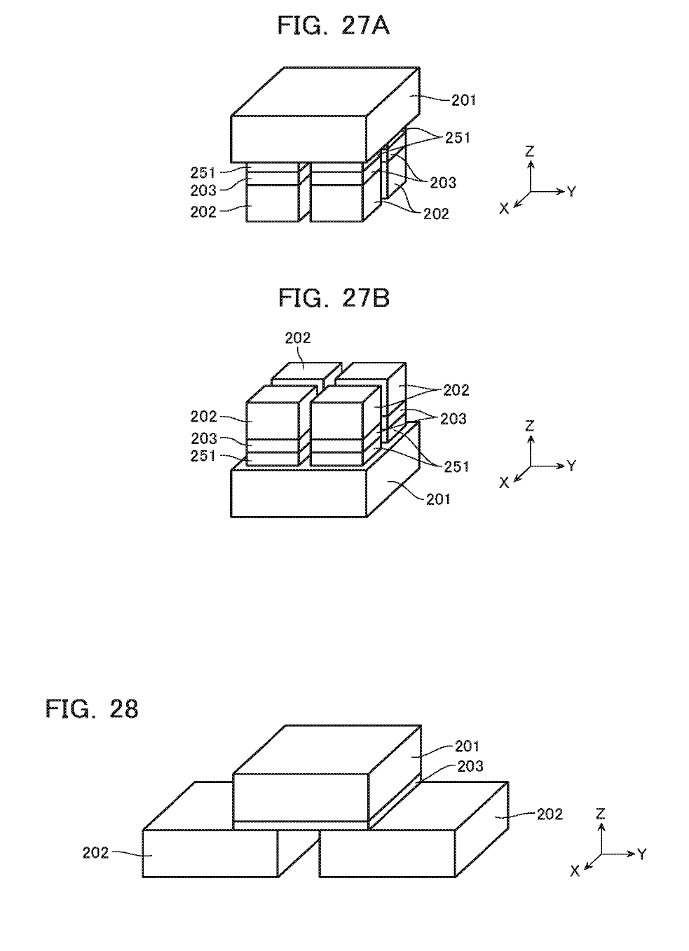

As illustrated in FIG. 27A and FIG. 27B, third magnetic layers 251 may be interposed between the first magnetic layer 201 and the intermediate layers 203. In the examples illustrated in FIG. 27A and FIG. 27B, the dimensions of the X-Y planes of the second magnetic layer 202, the intermediate layer 203, and the third magnetic layer 251 approximately match. These dimensions are smaller than the dimensions of the X-Y plane of the first magnetic layer 201. A ferromagnetic layer is used for the third magnetic layer 251. The third magnetic layers 251 function as the magnetization free layer together with the first magnetic layer 201. That is, the third magnetic layers 251 are magnetically coupled to the first magnetic layer 201. The magnetization direction of the third magnetic layers 251 matches the magnetization direction of the first magnetic layer 201. The use of the structure as illustrated in FIG. 27A and FIG. 27B, as described later, allows manufacturing a laminated structure near the intermediate layer, which significantly contributes to the MR effect among the laminated structure of the magnetization fixed layer/the intermediate layer/the magnetization free layer, at a time in vacuum. This is preferable in manufacturing in an aspect of obtaining a high MR ratio.

In the examples illustrated in FIG. 25, FIG. 26A to FIG. 26E, and FIG. 27A and FIG. 27B, the first magnetic layer 201 is formed larger than the second magnetic layers 202. The second magnetic layers 202 fall within the first magnetic layer 201 in the X-Y plane. However, as illustrated in FIG. 28, the second magnetic layer 202 may be formed to the same extent or larger than the first magnetic layer 201. Alternatively, the second magnetic layer 202 may protrude from the first magnetic layer 201 on the X-Y plane.

As illustrated in FIG. 29A, the second magnetic layers 202 may fall within the inside of the first magnetic layer 201 in the X-Y plane. This aspect is, as described above, preferable in an aspect that the region where the magnetization is disturbed, which is the edge portion of the first magnetic layer 201, included in the region where the first magnetic layer 201 and the second magnetic layer 202 overlap is reduced. Moreover, this is preferable in an aspect of obtaining a high gauge factor. Moreover, the strain detecting element having a high SN ratio can be provided.

However, as illustrated in FIG. 29B and FIG. 29I, the second magnetic layers 202 may protrude from the first magnetic layer 201 in the X-Y plane. This aspect can also provide the strain detecting element having a high SN ratio.

As illustrated in FIG. 29A, FIG. 29B, and FIG. 29C, the shape of the X-Y plane of the first magnetic layer 201 may be an approximately square shape. Alternatively, as illustrated in FIG. 29D and FIG. 29E, the first magnetic layer 201 may be an approximately rectangular shape having a difference between the dimensions in the X direction arid the dimensions in the Y direction so as to provide the shape magnetic anisotropy. Similarly, as illustrated in FIG. 29A, FIG. 29B, and FIG. 29D, the shape of the X-Y plane of the second magnetic layer 202 may be an approximately square shape. Alternatively, as illustrated in FIG. 29C and FIG. 29E, the second magnetic layer 202 may be an approximately rectangular shape having a difference between the dimensions in the X direction and the dimensions in the Y direction so as to provide the shape magnetic anisotropy. The shapes of the X-Y planes of the first magnetic layer 201 and the second magnetic layer 202 are formed as required.

In the case where at least one of the first magnetic layer 201 and the second magnetic layer 202 is formed into the approximately rectangular shape in the X-Y plane, the long axis direction becomes a direction for easy magnetization. Therefore, for example, without the use of the hard bias, the initial magnetization direction of the first magnetic layer 201 can be set. This allows reducing the manufacturing cost of the strain detecting element 200.

As illustrated in FIG. 29F and FIG. 29G, the shape of the X-Y plane of the first magnetic layer 201 may be an approximately circular shape. Alternatively, as illustrated in FIG. 29H, the X-Y plane may be an oval shape (elliptical shape) so as to provide the shape magnetic anisotropy. Alternatively, as illustrated in FIG. 29G, the shape of the X-Y plane of the second magnetic layer 202 may be the approximately circular shape. Further, as illustrated in FIG. 29F, FIG. 29G, and FIG. 29H, these first magnetic layer 201 and second magnetic layer 202 can be used in combination appropriately.

As illustrated in FIG. 29A to FIG. 29H, the size of the X-Y plane of the second magnetic layer 202 may be smaller than the first magnetic layer 201, may be to the same extent as illustrated in FIG. 29I, or more than the first magnetic layer 201.

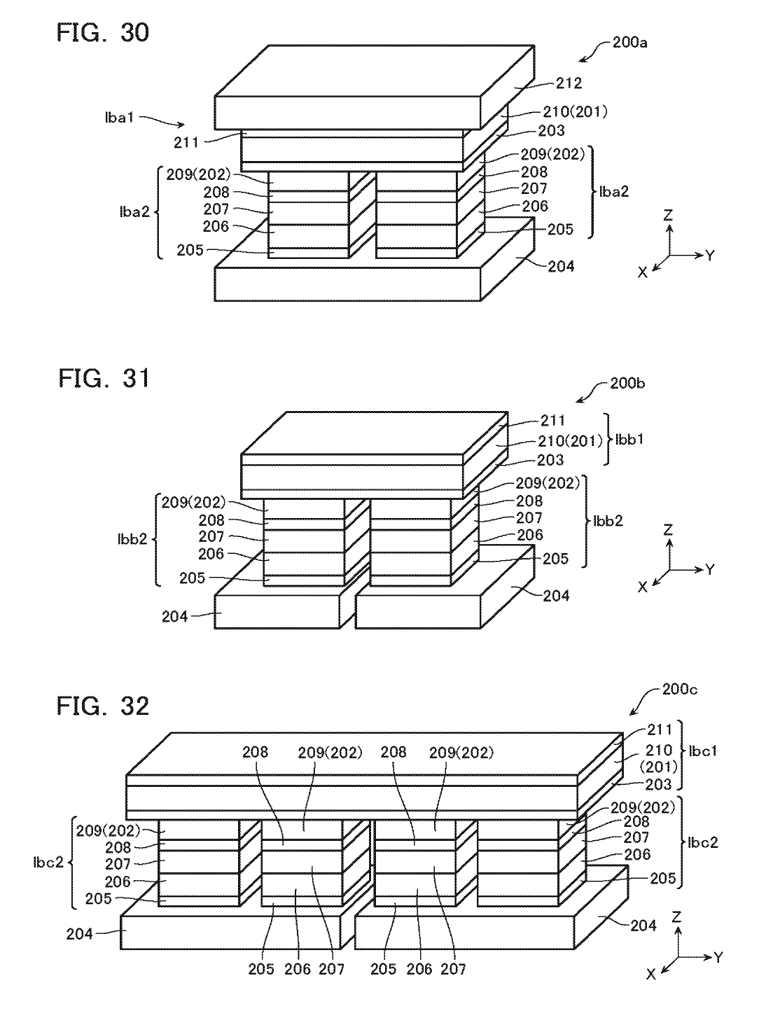

The following describes exemplary configurations of the strain detecting element 200 according to the embodiments with reference to FIG. 30 to FIG. 53.

FIG. 30 is a schematic perspective view illustrating an exemplary configuration 200a of the strain detecting element 200 according to an embodiment. The strain detecting element 200a is constituted by connecting the plurality of junctions formed of the first magnetization fixed layers 209 (second magnetic layers 202), the intermediate layer 203, and the magnetization free layer 210 (first magnetic layer 201) in parallel between the lower electrode 204 and the upper electrode 212.

That is, as illustrated in FIG. 30, the strain detecting element 200a includes the lower electrode 204, a plurality of second laminated bodies lba2, a first laminated body lba1, and the upper electrode 212. The plurality of second laminated bodies lba2 are disposed on the lower electrode 204. The first laminated body lba1 is disposed across the top surfaces of the plurality of second laminated bodies lba2. The upper electrode 212 is disposed on the first laminated body lba1. The plurality of second laminated bodies lba2 are each configured by laminating the under layer 205, the pinning layer 206, the second magnetization fixed layer 207, the magnetic coupling layer 208, and the first magnetization fixed layer 209 (second magnetic layer 202) in this order. The first laminated body lba1 is configured by laminating the intermediate layer 203, the magnetization free layer 210 (first magnetic layer 201), and the cap layer 211 in this order.

The first magnetization fixed layer 209 corresponds to the second magnetic layer 202. The magnetization free layer 210 corresponds to the first magnetic layer 201. The planar shapes of the plurality of first magnetization fixed layers 209 (second magnetic layers 202), the intermediate layer 203, the magnetization free layer 210 (first magnetic layer 201) of the strain detecting element 200a illustrated in FIG. 30 are similar to the structures illustrated in FIG. 25. The strain detecting element 200a illustrated in FIG. 30 may also use the planar shapes of the first magnetization fixed layer 209 (second magnetic layer 202), the intermediate layer 203, and the magnetization free layer 210 (first magnetic layer 201) illustrated in FIG. 26A.

As the under layer 205, for example, Ta/Ru are used. The thickness of this Ta layer (length in the Z-axis direction) is, for example, 3 nanometers (nm). The thickness of this Ru layer is, for example, 2 nm. For the pinning layer 206, for example, the IrMn layer at the thickness of 7 nm is used. For the second magnetization fixed layer 207, for example, a Co₇₅Fe₂₅ layer at the thickness of 2.5 nm is used. For the magnetic coupling layer 208, for example, the Ru layer at the thickness of 0.9 nm is used. For the first magnetization fixed layer 209, for example, a Co₄₀Fe₄₀B₂₀ layer at the thickness of 3 nm is used. For the intermediate layer 203, for example, an MgO layer at the thickness of 1.6 nm is used. For the magnetization free layer 210, for example, the Co₄₀Fe₄₀B₂₀ layer at the thickness of 4 nm is used. For the cap layer 211, for example, Ta/Ru are used. The thickness of this Ta layer is, for example, 1 nm. The thickness of this Ru layer is, for example, 5 nm.

As materials for the respective layers, the materials similar to the materials of the strain detecting element 200A described with reference to FIG. 10 can be used.

FIG. 31 is a schematic perspective view illustrating another exemplary configuration 200b of the strain detecting element 200 according to an embodiment. The strain detecting element 200b is constituted by connecting the plurality of junctions formed of the first magnetization fixed layers 209 (second magnetic layers 202), the intermediate layer 203, and the magnetization free layer 210 (first magnetic layer 201) in series between the two lower electrodes 204. That is, in the strain detecting element 200a illustrated in FIG. 30, one of the lower electrode 204 and the upper electrode 212 is configured as an anode while the other is configured as a cathode. However, in the strain detecting element 200b illustrated in FIG. 31, for example, one of the two lower electrodes 204 is configured as an anode while the other is configured as a cathode.

As illustrated in FIG. 31, the strain detecting element 200b includes the plurality of lower electrodes 204, a plurality of second laminated bodies lbb2, and a first laminated body lbb1. The plurality of second laminated bodies lbb2 are disposed on the plurality of respective lower electrodes 204. The first laminated body lbb1 is disposed across the top surfaces of the plurality of second laminated bodies lbb2. The plurality of second laminated bodies lbb2 are each configured by laminating the under layer 205, the pinning layer 206, the second magnetization fixed layer 207, the magnetic coupling layer 208, and the first magnetization fixed layer 209 (second magnetic layer 202) in this order. The first laminated body lbb1 is configured by laminating the intermediate layer 203, the magnetization free layer 210 (first magnetic layer 201), and the cap layer 211 in this order.

The first magnetization fixed layer 209 corresponds to the second magnetic layer 202. The magnetization free layer 210 corresponds to the first magnetic layer 201. The planar shapes of the plurality of first magnetization fixed layers 209 (second magnetic layers 202), the intermediate layer 203, and the magnetization free layer 210 (first magnetic layer 201) of the strain detecting element 200b illustrated in FIG. 31 are similar to the structures illustrated in FIG. 25. The strain detecting element 200a illustrated in FIG. 31 may also use the planar shapes of the first magnetization fixed layers 209 (second magnetic layers 202), the intermediate layer 203, and the magnetization free layer 210 (first magnetic layer 201) illustrated in FIG. 26A. As the protecting layer, for example, an insulating layer (not illustrated) can be disposed on the cap layer 211. As the insulating layer, for example, SiOₓ, AlOₓ, SiNₓ, and AlNₓ can be used.

As materials for the respective layers, the materials similar to the materials of the strain detecting element 200A described with reference to FIG. 10 can be used.

FIG. 32 is a schematic perspective view illustrating another exemplary configuration 200c of the strain detecting element 200 according to an embodiment. The strain detecting element 200c includes the two lower electrodes 204. The strain detecting element 200c is constituted by connecting the plurality of junctions formed of the first magnetization fixed layers 209 (second magnetic layers 202), the intermediate layer 203, and the magnetization free layer 210 (first magnetic layer 201) in parallel between the respective lower electrodes 204 and the magnetization free layer 210 (first magnetic layer 201). These plurality of junctions connected in parallel are further connected in series between the two lower electrodes 204. That is, in the strain detecting element 200c illustrated in FIG. 32, for example, one of the two lower electrodes 204 is configured as an anode while the other is configured as a cathode.

That is, illustrated in FIG. 32, the strain detecting element 200c includes the plurality of lower electrodes 204, a plurality of second laminated bodies lbc2, and a first laminated body lbc1. The plurality of second laminated bodies lbc2, which are disposed by a plurality of numbers, are further disposed on the plurality of lower electrode 204. The first laminated body lbc1 is disposed across the top surfaces of the plurality of second laminated bodies lba2. The plurality of second laminated bodies lbc2 are each configured by laminating the under layer 205, the pinning layer 206, the second magnetization fixed layer 207, the magnetic coupling layer 208, and the first magnetization fixed layer 209 (second magnetic layer 202) in this order. The first laminated body lba1 is configured by laminating the intermediate layer 203, the magnetization free layer 210 (first magnetic layer 201), and the cap layer 211 in this order. On the one lower electrode 204, the plurality of laminated bodes each formed of the under layer 205, the pinning layer 206, the second magnetization fixed layer 207, the magnetic coupling layer 208, and the first magnetization fixed layer 209 (second magnetic layer 202) are disposed.

The first magnetization fixed layer 209 corresponds to the second magnetic layer 202. The magnetization free layer 210 corresponds to the first magnetic layer 201. As the protecting layer, for example, an insulating layer (not illustrated) can be disposed on the cap layer 211. As the insulating layer, for example, SiOₓ, AlOₓ, SiNₓ, and AlNₓ can be used.

As materials for the respective layers, the materials similar to the materials of the strain detecting element 200A described with reference to FIG. 10 can be used.

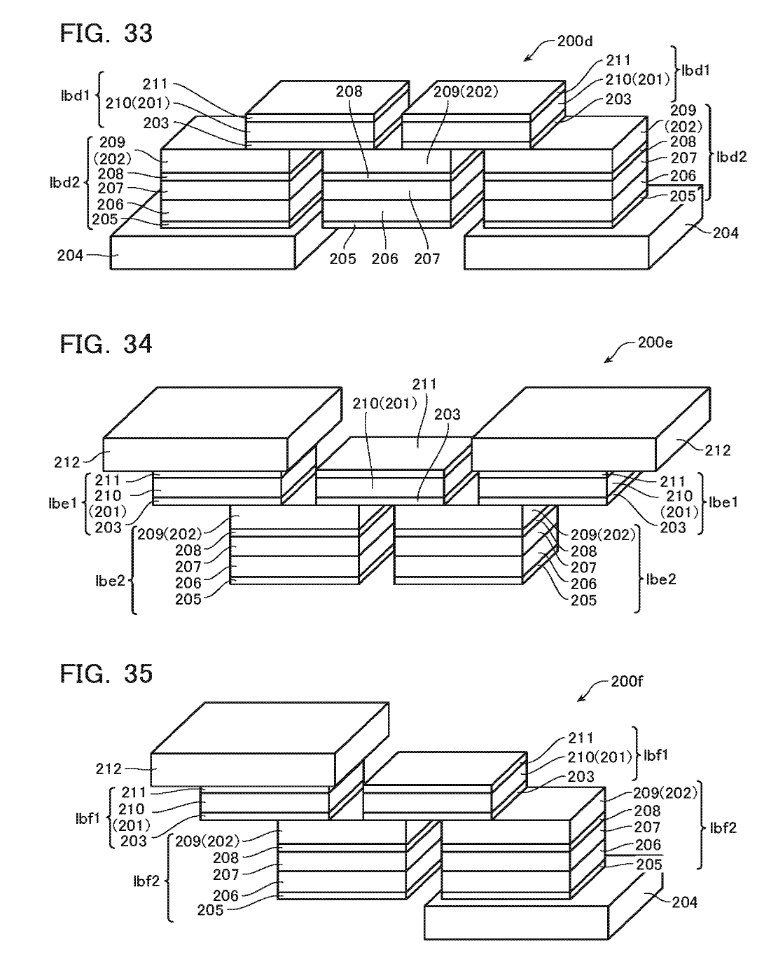

FIG. 33 is a schematic perspective view illustrating another exemplary configuration 200d of the strain detecting element 200 according to an embodiment. The strain detecting element 200d is constituted by connecting the plurality of junctions formed of the first magnetization fixed layers 209 (second magnetic layers 202), the intermediate layers 203, and the magnetization free layers 210 (first magnetic layers 201) in series between the two lower electrodes 204. That is, in the strain detecting element 200d illustrated in FIG. 33, for example, one of the two lower electrodes 204 is configured as an anode while the other is configured as a cathode.

That is, as illustrated in FIG. 33, the strain detecting element 200d includes the two lower electrodes 204, two second laminated bodies lbd2, the second laminated bodies lbd2, and a plurality of first laminated bodies lbd1. The two second laminated bodies lbd2 are disposed on the respective two lower electrodes 204. The second laminated body lbd2 are positioned between these two second laminated bodies lbd2. The plurality of first laminated bodies lbd1 are disposed across the top surfaces of the adjacent two second laminated bodies lbd2. The plurality of second laminate bodies lbd2 are each configured by laminating the under layer 205, the pinning layer 206, the second magnetization fixed layer 207, the magnetic coupling layer 208, and the first magnetization fixed layer 209 (second magnetic layer 202) in this order. The plurality of first laminated bodies lbd1 are each configured by laminating the intermediate layer 203, the magnetization free layer 210 (first magnetic layer 201), and the cap layer 211 in this order.

The plurality of second laminated bodies lbd2 are separate from one another. The upper edges of this plurality of second laminated bodies lbd2 are electrically connected via the plurality of first laminated bodies lbd1. Further, the plurality of first laminated bodies lbd1 are also separate from one another. The plurality of first laminated bodies lbd1 are each formed across the two second laminated bodies lbd2. The under layers 205, which are included in the two second laminated bodies lbd2, are connected to the respective lower electrodes 204. This electrically connects the plurality of second laminated bodies lbd2 in series.

The first magnetization fixed layer 209 corresponds to the second magnetic layer 202. The magnetization free layer 210 corresponds to the first magnetic layer 201. As the protecting layer, for example, an insulating layer (not illustrated) can be disposed on the cap layer 211. As the insulating layer, for example, SiOₓ, AlOₓ, SiNₓ, and AlNₓ can be used.

As materials for the respective layers, the materials similar to the materials of the strain detecting element 200A described with reference to FIG. 10 can be used.

FIG. 34 is a schematic perspective view illustrating another exemplary configuration 200e of the strain detecting element 200 according to an embodiment. The strain detecting element 200e is constituted by connecting the plurality of junctions formed of the first magnetization fixed layers 209 (second magnetic layers 202), the intermediate layers 203, and the magnetization free layers 210 (first magnetic layers 201) in series between the two upper electrodes 212.

That is, as illustrated in FIG. 34, the strain detecting element 200e includes a plurality of second laminated bodies lbe2, a plurality of first laminated bodies lbe1, and the two upper electrodes 212. The plurality of first laminated bodies lbe1 are disposed across the top surfaces of the adjacent two second laminated bodies lbe2. The upper electrodes 212 are disposed on the respective two first laminated bodies lbe1 that are separate most. The plurality of second laminated bodies lbe2 are each configured by laminating the under layer 205, the pinning layer 206, the second magnetization fixed layer 207, the magnetic coupling layer 208, and the first magnetization fixed layer 209 (second magnetic layer 202) in this order. The plurality of first laminated bodies lbe1 are each configured by laminating the intermediate layer 203, the magnetization free layer 210 (first magnetic layer 201), and the cap layer 211 in this order.

The plurality of second laminated bodies lbe2 are separate from one another. The upper edges of these plurality of second laminated bodies lbe2 are electrically connected via the first laminated bodies lbe1. Further, the plurality of first laminated bodies lbe1 are also separate from one another. The first laminated bodies lbe1 are each formed across the two second laminated bodies lbe2. The cap layers 211, which are included in the two first laminated bodies lbe1, are connected to the respective upper electrodes 212. This electrically connects the plurality of second laminated bodies lbe2 in series.

The first magnetization fixed layer 209 corresponds to the second magnetic layer 202. The magnetization free layer 210 corresponds to the first magnetic layer 201.

As materials for the respective layers, the materials similar to the materials of the strain detecting element 200A described with reference to FIG. 10 can be used.

FIG. 35 is a schematic perspective view illustrating another exemplary configuration 200f of the strain detecting element 200 according to an embodiment. The strain detecting element 200f is constituted by connecting the plurality of junctions formed of the first magnetization fixed layers 209 (second magnetic layers 202), the intermediate layers 203, and the magnetization free layers 210 (first magnetic layers 201) in series between the lower electrode 204 and the upper electrode 212.

That is, as illustrated in FIG. 35, the strain detecting element 200f includes the lower electrode 204, second laminated bodies lbf2, first laminated bodies lbf1, and the upper electrode 212. One of the second laminated body lbf2 is disposed on this lower electrode 204. The other of the second laminated body lbf2 is further disposed adjacent to this second laminated body lbf2. One of the first laminated body lbf1 is disposed across the top surfaces of this adjacent two second laminated bodies lbf2. The other of the first laminated body lbf1 is further disposed on the top surface of the second laminated body that is further disposed. The upper electrode 212 is disposed on this first laminated body lbf1 that is further disposed. The two second laminated bodies lbf2 are each configured by laminating the under layer 205, the pinning layer 206, the second magnetization fixed layer 207, the magnetic coupling layer 208, and the first magnetization fixed layer 209 (second magnetic layer 202) in this order. The two first laminated bodies lbf1 are each configured by laminating the intermediate layer 203, the magnetization free layer 210 (first magnetic layer 201), and the cap layer 211 in this order.

The two second laminated bodies lbf2 are separate from one another. The upper edges of these two second laminated bodies lbf2 are electrically connected via the first laminated bodies lbf1. Further, the two first laminated bodies lbf1 are also separate from one another. The one first laminated body lbf1 is formed across the two second laminated bodies lbf2 while the other first laminated body lbf1 is formed on the one second laminated body lbf2. The under layer 205 of the second laminated body lbf2 connected to the one first laminated body lbf1 is coupled to the lower electrode 204. The cap layer 211 of the first laminated body lbf1 connected to the other of the second laminated body lbf2 is coupled to the upper electrode 212. This electrically connects the respective laminated bodies of the plurality of second laminated bodies lbf2 in series.

The first magnetization fixed layer 209 corresponds to the second magnetic layer 202. The magnetization free layer 210 corresponds to the first magnetic layer 201.

As materials for the respective layers, the materials similar to the materials of the strain detecting element 200A described with reference to FIG. 10 can be used.

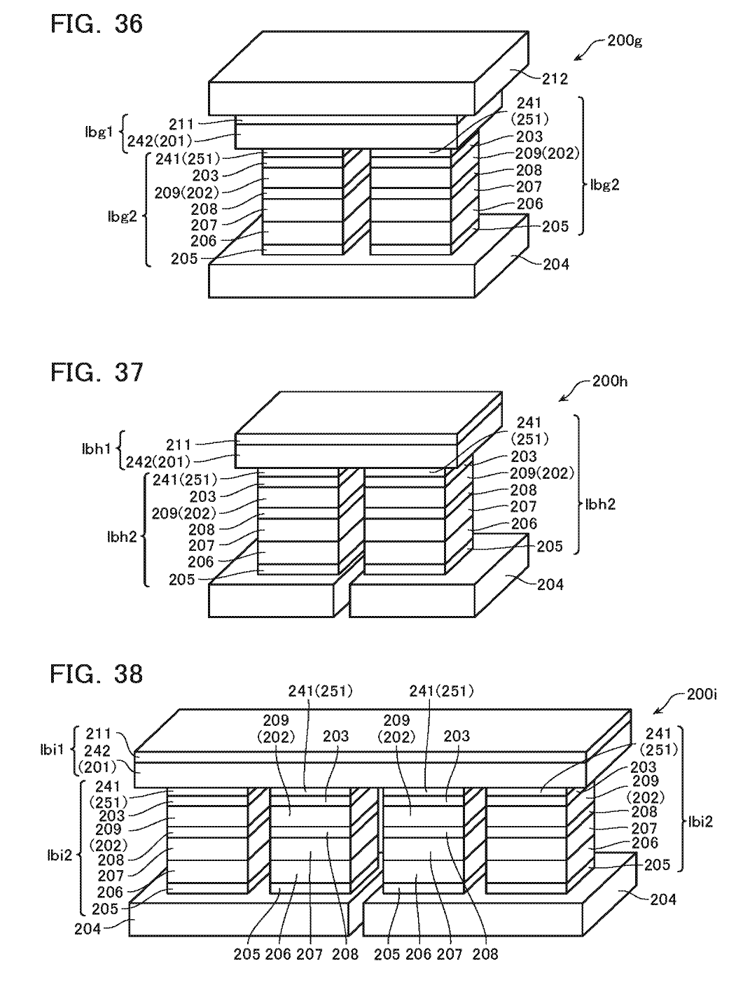

FIG. 36 is a schematic perspective view illustrating an exemplary configuration 200g of the strain detecting element 200 according to an embodiment. The strain detecting element 200g is, different from the strain detecting element 200a, formed by including the third magnetic layer 251 between the intermediate layer 203 and the first magnetic layer 201. The strain detecting element 200g is constituted by connecting the plurality of junctions formed of the first magnetization fixed layers 209 (second magnetic layers 202), the intermediate layers 203, and the magnetization free layer 242 (first magnetic layer 201) in parallel between the lower electrode 204 and the upper electrode 212.

That is, as illustrated in FIG. 36, the strain detecting element 200g includes the lower electrode 204, a plurality of second laminated bodies lbg2, a first laminated body lbg1, and the upper electrode 212. The plurality of second laminated bodies lbg2 are disposed on the lower electrode 204. The first laminated body lbg1 is disposed across the top surfaces of the plurality of second laminated bodies lbg2. The upper electrode 212 is disposed on the first laminated body lbg1. The plurality of second laminated bodies lbg2 are each configured by laminating the under layer 205, the pinning layer 206, the second magnetization fixed layer 207, the magnetic coupling layer 208, the first magnetization fixed layer 209 (second magnetic layer 202), the intermediate layer 203, and the second magnetization free layer 241 (third magnetic layer 251) in this order. The first laminated body lbg1 is configured by laminating the first magnetization free layer 242 (first magnetic layer 201) and the cap layer 211 in this order.

The first magnetization fixed layer 209 corresponds to the second magnetic layer 202. The second magnetization free layer 241 corresponds to the third magnetic layer 251. The first magnetization free layer 242 corresponds to the first magnetic layer 201. The planar shapes of the plurality of first magnetization fixed layers 209 (second magnetic layers 202), the intermediate layer 203, the second magnetization free layer 241 (third magnetic layer 251), and the first magnetization free layer 242 (first magnetic layer 201) of the strain detecting element 200g illustrated in FIG. 36 are similar to the structures illustrated in FIG. 27A.

As the under layer 205, for example, Ta/Ru are used. The thickness of this Ta layer (length in the Z-axis direction) is, for example, 3 nanometers (nm). The thickness of this Ru layer is, for example, 2 nm. For the pinning layer 206, for example, the IrMn layer at the thickness of 7 nm is used. For the second magnetization fixed layer 207, for example, the Co₇₅Fe₂₅ layer at the thickness of 2.5 nm is used. For the magnetic coupling layer 208, for example, the Ru layer at the thickness of 0.9 nm is used. For the first magnetization fixed layer 209, for example, the Co₄₀Fe₄₀B₂₀ layer at the thickness of 3 nm is used. For the intermediate layer 203, for example, the MgO layer at the thickness of 1.6 nm is used. For the second magnetization free layer 241, for example, the Co₄₀Fe₄₀B₂₀ layer at the thickness of 1.5 nm is used. For the first magnetization free layer 242, for example, the Co₄₀Fe₄₀B₂₀ layer at the thickness of 4 nm is used. For the cap layer 211, for example, Ta/Ru are used. The thickness of this Ta layer is, for example, 1 nm. The thickness of this Ru layer is, for example, 5 nm.

In the strain detecting element 200g illustrated in FIG. 36, the planer dimensions of the second magnetization free layer 241 is similar to the planer dimensions of the first magnetization fixed layer 209. Here, the second magnetization free layers 241 magnetically couple to the first magnetization free layer 242, thus allowing functioning as the magnetization free layer. Here, the second magnetization free layer 241 has the element dimensions smaller than the first magnetization free layer 242 similar to the first magnetization fixed layer 209. However, the second magnetization free layer 241 is coupled and magnetically coupled to the first magnetic layer 242 whose dimensions are relatively large and therefore the disturbance of magnetization is small. Accordingly, the disturbance of magnetization of the second magnetization free layer 241 can also be reduced. This allows obtaining the effect of the embodiment. The use of the strain detecting element 200g illustrated in FIG. 36, as described later, allows manufacturing a laminated structure near the intermediate layer 203, which significantly contributes to the MR effect among the laminated structure of the magnetization fixed layer/the intermediate layer/the magnetization free layer, at a time in vacuum. This is preferable in an aspect of obtaining a high MR ratio.

Here, as the material used for the second magnetization free layer 241, the material similar to the material used for the above-described magnetization free layer 210 (FIG. 10) can be used. If the film thickness of the second magnetization free layer 241 is too thick, an effect of reducing the disturbance of magnetization due to the magnetic coupling with the first magnetization free layer 242 is degraded. Accordingly, the film thickness is preferable to be 4 nm or less and more preferable to be 2 nm or less. As the material used for the first magnetization free layer 242, the material similar to the material used for the above-described magnetization free layer 210 (FIG. 10) can be used. As materials for other respective layers, the materials similar to the materials of the strain detecting element 200A can be used.

The strain detecting element 200g illustrated in FIG. 36 is configured by connecting the junctions formed of the first magnetic layer 201, the intermediate layers 203, and the second magnetic layers 202 in parallel. However, for example, as the strain detecting element 200h illustrated in FIG. 37, the junctions may be connected in series. Alternatively, as a strain detecting element 200i illustrated in FIG. 38, the junctions may be connected in parallel and in series.

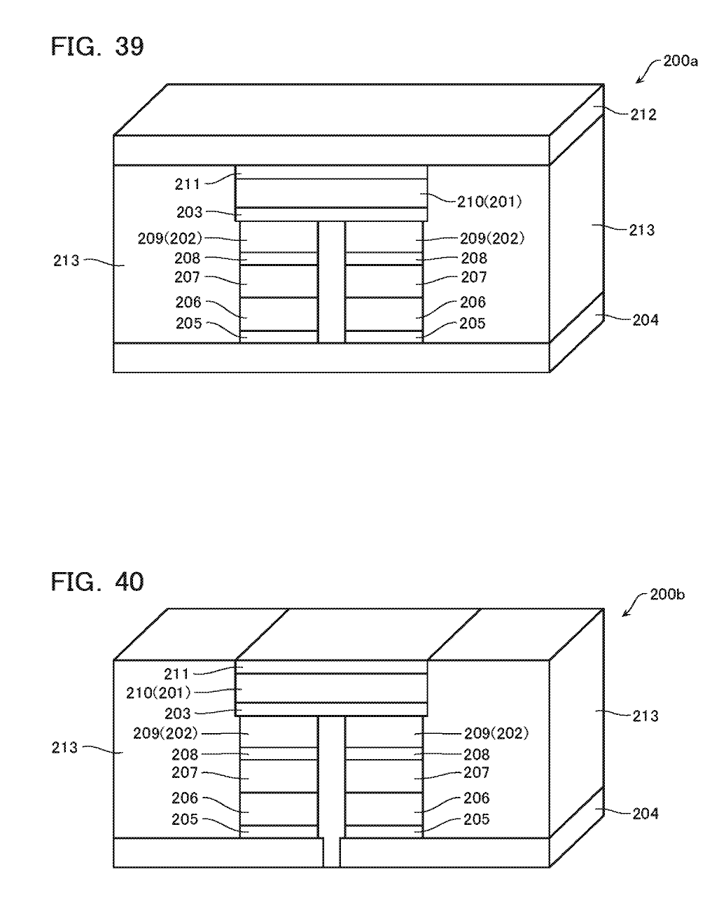

FIG. 39 is a schematic perspective view illustrating an exemplary configuration of the strain detecting element 200a. FIG. 40 is a schematic perspective view illustrating an exemplary configuration of the strain detecting element 200b. As exemplified in FIG. 39 and FIG. 40, the strain detecting element 200 may Include the insulating layer (insulating part) 213. The insulating layer 213 is filled between the lower electrode 204 and the upper electrode 212.

For the insulating layer 213, for example, an aluminum oxide (such as Al₂O₃), a silicon oxide (such as SiO₂) or the like can be used. The insulating layer 213 can reduce a leak current of the strain detecting element 200a.

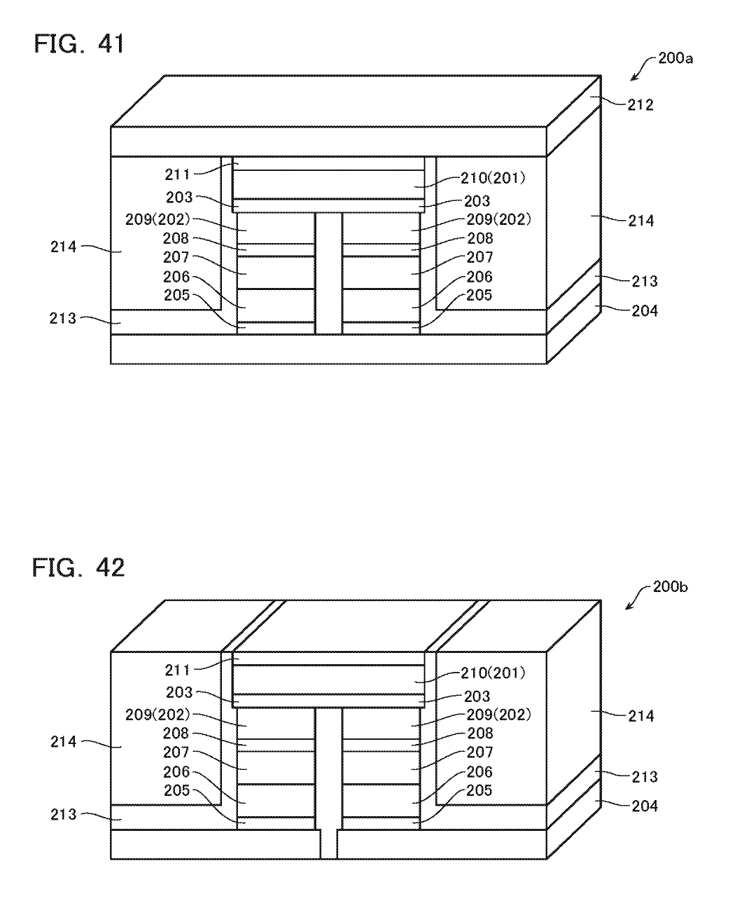

FIG. 41 is a schematic perspective view illustrating an exemplary configuration of the strain detecting element 200a. FIG. 42 is a schematic perspective view illustrating another exemplary configuration of the strain detecting element 200b. As exemplified in FIG. 41 and FIG. 42, the strain detecting element 200a may include the two hard bias layers (hard bias parts) 214 and the insulating layers 213. The hard bias layers 214 are disposed between the lower electrode 204 and the upper electrode 212 so as to be separate from one another. The insulating layers 213 are filled between the lower electrode 204 and the hard bias layers 214.

The hard bias layer 214 sets the magnetization direction of the magnetization free layer 210 (first magnetic layer 201) a desired direction by magnetization of the hard bias layer 214. With the hard bias layer 214, in a state where external pressure is not applied to the film portion, the magnetization direction of the magnetization free layer 210 (first magnetic layer 201) can be set to the desired direction.

The material similar to the material of the hard bias layer 214 described with reference to FIG. 13 is applicable as the material of the hard bias layer 214 and the periphery layers of the hard bias layer 214.

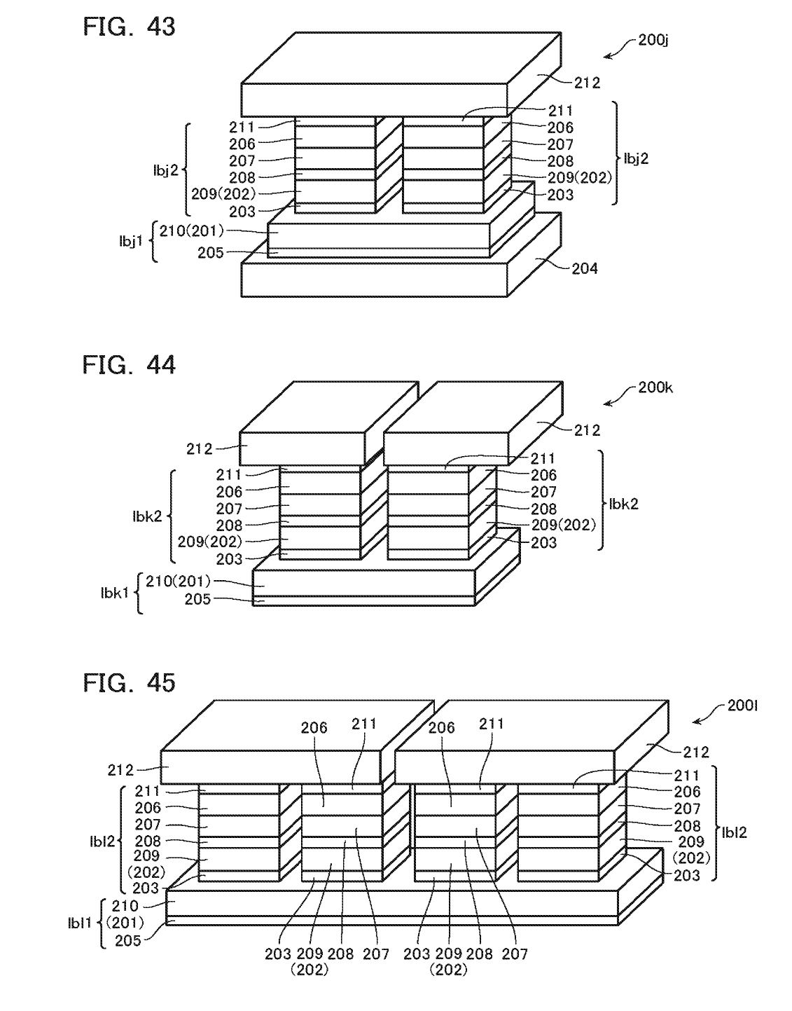

FIG. 43 is a schematic perspective view illustrating another exemplary configuration 200j of the strain detecting element 200. The strain detecting element 200j has the top spin-valve type. The strain detecting element 200j is constituted by connecting the plurality of junctions formed of the first magnetization fixed layers 209 (second magnetic layers 202), the intermediate layers 203, and the magnetization free layer 210 (first magnetic layer 201) in parallel between the lower electrode 204 and the upper electrode 212.

That is, as illustrated in FIG. 43, the strain detecting element 200j includes the lower electrode 204, a first laminated body lbj1, a plurality of second laminated bodies lbj2, and the upper electrode 212. The first laminated body lbj1 is disposed on the lower electrode 204. The plurality of second laminated bodies lbj2 are disposed on the top surface of the first laminated body lbj1. The upper electrode 212 is disposed across on the plurality of second laminated bodies lbj2. The plurality of first laminated bodies lbj1 are each configured by laminating the under layer 205 and the magnetization free layer 210 (first magnetic layer 201) in this order. The second laminated bodies lbj2 are each configured by laminating the intermediate layer 203, the first magnetization fixed layer 209 (second magnetic layer 202), the magnetic coupling layer 208, the second magnetization fixed layer 207, the pinning layer 206, and the cap layer 211 in this order.

The first magnetization fixed layer 209 corresponds to the second magnetic layer 202. The magnetization free layer 210 corresponds to the first magnetic layer 201. The planar shapes of the first magnetization fixed layer 209 (second magnetic layer 202), the intermediate layer 203, and the magnetization free layer 210 (first magnetic layer 201) of the strain detecting element 200j illustrated in FIG. 43 are similar to the structures illustrated in FIG. 26C. The strain detecting element 200j illustrated in FIG. 43 may also use the planar shapes of the first magnetization fixed layer 209 (second magnetic layer 202), the intermediate layer 203, and the magnetization free layer 210 (first magnetic layer 201) illustrated in FIG. 26B. The structure as illustrated in FIG. 27B where the third magnetic layer 251 is added may be used.

For the under layer 205, for example, Ta/Cu are used. The thickness of this Ta layer (length in the Z-axis direction) is, for example, 3 nm. The thickness of this Cu layer is, for example, 5 nm. For the magnetization free layer 210, for example, the Co₄₀Fe₄₀B₂₀ layer at the thickness of 4 nm is used. For the intermediate layer 203, for example, the MgO layer at the thickness of 1.6 nm is used. For the first magnetization fixed layer 209, for example, the Co₄₀Fe₄₀B₂₀/Fe₅₀Co₅₀ are used. The thickness of this Co₄₀Fe₄₀B₂₀ layer is, for example, 2 nm. The thickness of this Fe₅₀Co₅₀ layer is, for example, 1 nm. For the magnetic coupling layer 208, for example, the Ru layer at the thickness of 0.9 nm is used. For the second magnetization fixed layer 207, for example, the Co₇₅Fe₂₅ layer at the thickness of 2.5 nm is used. For the pinning layer 206, for example, the IrMn layer at the thickness of 7 nm is used. For the cap layer 211, for example, Ta/Ru are used. The thickness of this Ta layer is, for example, 1 nm. The thickness of this Ru layer is, for example, 5 nm.

In the strain detecting element 200a, the first magnetization fixed layer 209 (second magnetic layer 202) is formed lower than the magnetization free layer 210 (first magnetic layer 201) (−Z-axis direction). In contrast to this, in the strain detecting element 200j, the first magnetization fixed layer 209 (second magnetic layer 202) is formed above the magnetization free layer 210 (first magnetic layer 201) (+Z-axis direction). Therefore, the materials of the respective layers contained in the strain detecting element 200j can be used by vertically inverting the materials of the respective layers contained in the strain detecting element 200a.

The strain detecting element 200j illustrated in FIG. 43 is configured by connecting the junctions formed of the first magnetic layer 201, the intermediate layers 203, and the second magnetic layers 202 in parallel. However, for example, as a strain detecting element 200k illustrated in FIG. 44, the junctions may be connected in series. Alternatively, as a strain detecting element 200l illustrated in FIG. 45, the junctions may be connected in parallel and in series.

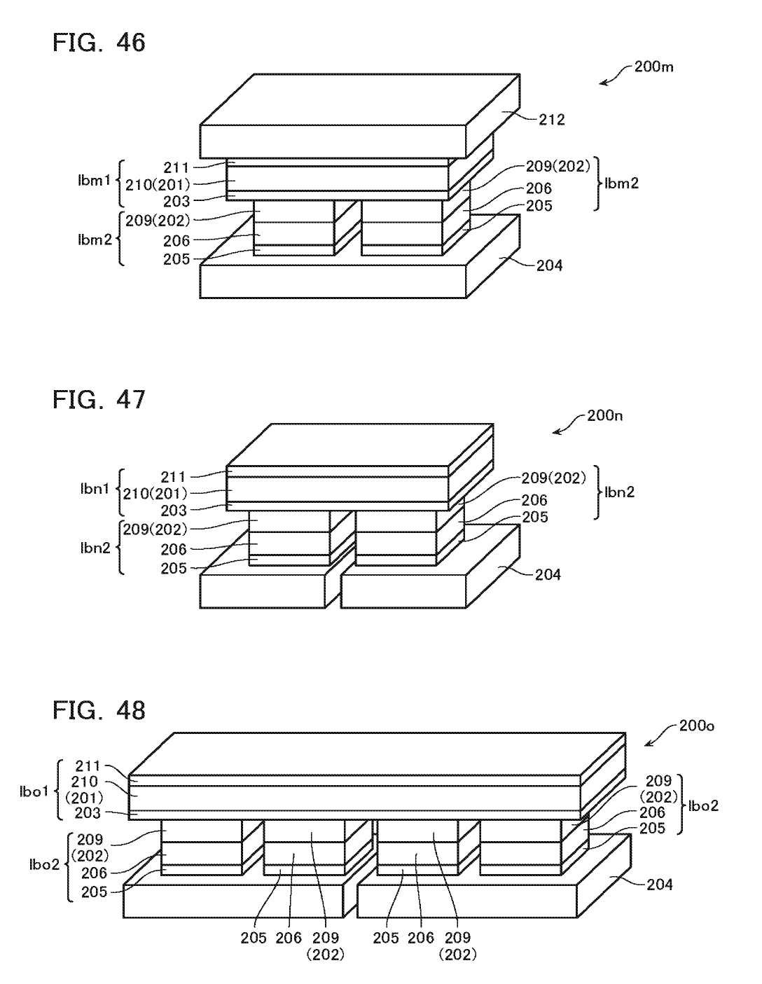

FIG. 46 is a schematic perspective view illustrating another exemplary configuration 200m of the strain detecting element 200. The single pin structure using a single magnetization fixed layer is applied to the strain detecting element 200m. The strain detecting element 200m is constituted by connecting the plurality of junctions formed of the first magnetization fixed layers 209 (second magnetic layers 202), the intermediate layer 203, and the magnetization free layer 210 (first magnetic layer 201) in parallel between the lower electrode 204 and the upper electrode 212.

That is, as illustrated in FIG. 46, the strain detecting element 200m includes the lower electrode 204, a plurality of second laminated bodies lbm2, a first laminated body lbm1, and the upper electrode 212. The plurality of second laminated bodies lbm2 are disposed on the lower electrode 204. The first laminated body lbm1 is disposed across the top surfaces of the plurality of second laminated bodies lbm2. The upper electrode 212 is disposed on the first laminated body lbm1. The plurality of second laminated bodies lbm2 are each configured by laminating the under layer 205, the pinning layer 206, and the first magnetization fixed layer 209 (second magnetic layer 202) in this order. The first laminated body lbm1 is configured by laminating the intermediate layer 203, the magnetization free layer 210 (first magnetic layer 201), and the cap layer 211 in this order.

The first magnetization fixed layer 209 corresponds to the second magnetic layer 202. The magnetization free layer 210 corresponds to the first magnetic layer 201. The planar shapes of the plurality of first magnetization fixed layers 209 (second magnetic layers 202), the intermediate layer 203, and the magnetization free layer 210 (first magnetic layer 201) of the strain detecting element 200m illustrated in FIG. 46 are similar to the structures illustrated in FIG. 25. The strain detecting element 200m illustrated in FIG. 46 may also use the planar shapes of the first magnetization fixed layer 209 (second magnetic layer 202), the intermediate layer 203, and the magnetization free layer 210 (first magnetic layer 201) illustrated in FIG. 26A. As illustrated in FIG. 27A, the third magnetic layer 251 may be interposed between the first magnetic layer 201 and the intermediate layer 203.

As the under layer 205, for example, Ta/Ru are used. The thickness of this Ta layer (length in the Z-axis direction) is, for example, 3 nm. The thickness of this Ru layer is, for example, 2 nm. For the pinning layer 206, for example, the IrMn layer at the thickness of 7 nm is used. For the first magnetization fixed layer 209, for example, the Co₄₀Fe₄₀B₂₀ layer at the thickness of 3 nm is used. For the intermediate layer 203, for example, the MgO layer at the thickness of 1.6 nm is used. For the magnetization free layer 210, for example, the Co₄₀Fe₄₀B₂₀ layer at the thickness of 4 nm is used. For the cap layer 211, for example, Ta/Ru are used. The thickness of this Ta layer is, for example, 1 nm. The thickness of this Ru layer is, for example, 5 nm.

For the materials of the respective layers of the strain detecting element 200m, the materials similar to the materials of the respective layers of the strain detecting element 200A can be used.

The strain detecting element 200m illustrated in FIG. 46 is configured by connecting the junctions formed of the first magnetic layer 201, the intermediate layer 203, and the second magnetic layers 202 in parallel. However, for example, as a strain detecting element 200n illustrated in FIG. 47, the junctions may be connected in series. Alternatively, as a strain detecting element 200o illustrated in FIG. 48, the junctions may be connected in parallel and in series.

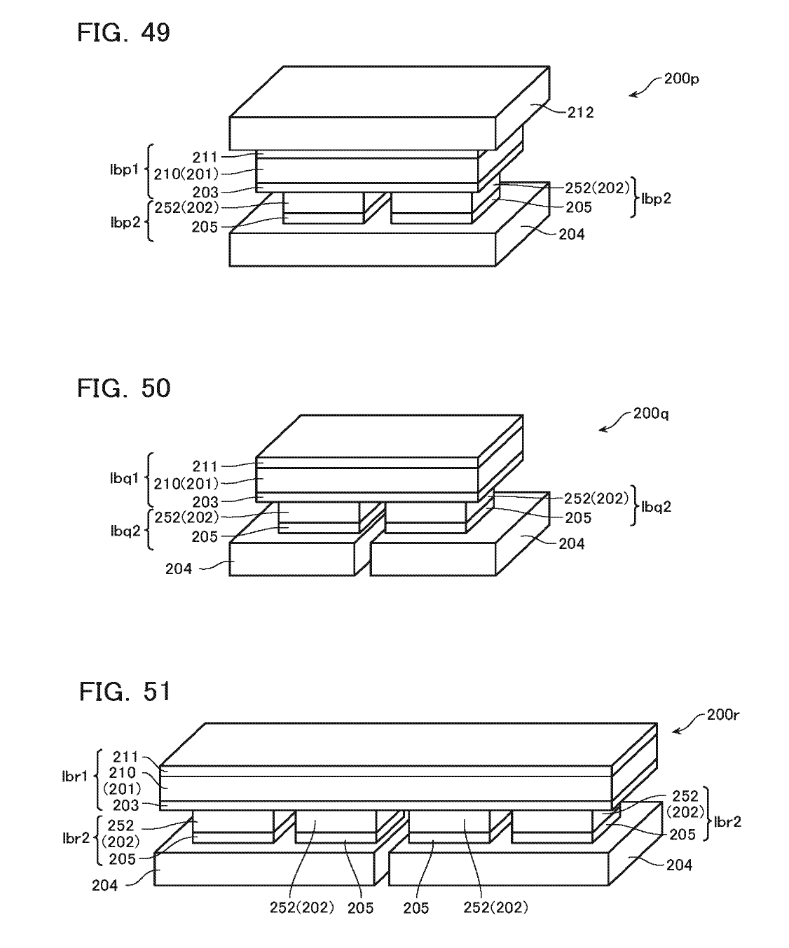

FIG. 49 is a schematic perspective view illustrating another exemplary configuration 200p of the strain detecting element 200. In the strain detecting element 200p, the second magnetic layer 202 is made function as the reference layer 252, not as the magnetization fixed layer. The strain detecting element 200p is constituted by connecting the plurality of junctions formed of the reference layers 252 (second magnetic layers 202), the intermediate layer 203, and the magnetization free layer 210 (first magnetic layer 201) in parallel between the lower electrode 204 and the upper electrode 212.

That is, as illustrated in FIG. 49, the strain detecting element 200p includes the lower electrode 204, a plurality of second laminated bodies lbp2, a first laminated body lbp1, and the upper electrode 212. The plurality of second laminated bodies lbp2 are disposed on the lower electrode 204. The first laminated body lbp1 is disposed across the top surfaces of the plurality of second laminated bodies lbp2. The upper electrode 212 is disposed on the first laminated body lbp1. The plurality of second laminated bodies lbp2 are each configured by laminating the under layer 205 and the reference layer 252 (second magnetic layer 202) in this order. The first laminated body lbp1 is configured by laminating the intermediate layer 203, the magnetization free layer 210 (first magnetic layer 201), and the cap layer 211 in this order.

The reference layer 252 corresponds to the second magnetic layer 202. The magnetization free layer 210 corresponds to the first magnetic layer 201. The planar shapes of the reference layer 252 (second magnetic layer 202), the intermediate layer 203, and the magnetization free layer 210 (first magnetic layer 201) of the strain detecting element 200p illustrated in FIG. 49 are similar to the structures illustrated in FIG. 25. The strain detecting element 200p illustrated in FIG. 49 may also use the planar shapes of the reference layer 252 (second magnetic layer 202), the intermediate layer 203, and the magnetization free layer 210 (first magnetic layer 201) illustrated in FIG. 26A. As illustrated in FIG. 27A, the third magnetic layer 251 may be interposed between the first magnetic layer 201 and the intermediate layer 203.

As the under layer 205, for example, Cr is used. The thickness of this Cr layer (length in the Z-axis direction) is, for example, 5 nm. For the reference layer 252, for example, the Co₈₀Pt₂₀ layer at the thickness of 10 nm is used. For the intermediate layer 203, for example, the MgO layer at the thickness of 1.6 nm is used. For the magnetization free layer 210, for example, the Co₄₀Fe₄₀B₂₀ layer at the thickness of 4 nm is used. For the cap layer 211, for example, Ta/Ru are used. The thickness of this Ta layer is, for example, 1 nm. The thickness of this Ru layer is, for example, 5 nm.

Here, a material used for the reference layer 252 can be selected such that an aspect of a change in the magnetization direction caused by the same strain may be different from the material used for the magnetization free layer 210. For example, for the reference layer 252, a material that is less likely to change the magnetization caused by the strain compared with the magnetization free layer 210 can be used.

The strain detecting element 200p illustrated in FIG. 49 is configured by connecting the junctions formed of the first magnetic layer 201, the intermediate layer 203, and the second magnetic layers 202 in parallel. However, for example, as a strain detecting element 200q illustrated in FIG. 50, the junctions may be connected in series. Alternatively, as a strain detecting element 200r illustrated in FIG. 51, the junctions may be connected in parallel and in series.

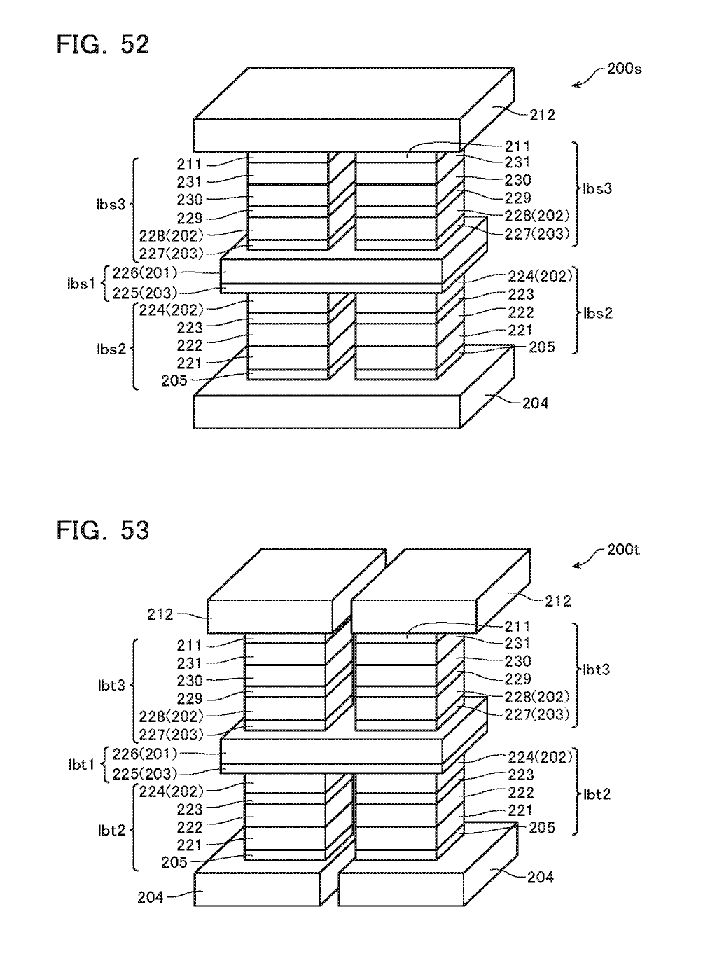

FIG. 52 is a schematic perspective view illustrating another exemplary configuration 200s of the strain detecting element 200. As illustrated in FIG. 52, in the strain detecting element 200s, the second magnetic layers 202 are formed above and below the first magnetic layer 201 via the intermediate layers 203. The strain detecting element 200s is constituted by connecting the plurality of junctions formed of the second magnetic layers 202, the intermediate layer 203, and the first magnetic layer 201 in series and in parallel between the lower electrode 204 and the upper electrode 212.

That is, as illustrated in FIG. 52, the strain detecting element 200s includes the lower electrode 204, a plurality of second laminated bodies lbs2, a first laminated body lbs1, a plurality of third laminated bodies lbs3, and the upper electrode 212. The plurality of second laminated bodies lbs2 are disposed on the lower electrode 204. The first laminated body lbs1 is disposed across the top surfaces of the plurality of second laminated bodies lbs2. The plurality of third laminated bodies lbs3 are disposed on the first laminated body lbs1. The upper electrode 212 is disposed across the top surfaces of the plurality of third laminated bodies lbs3. The plurality of second laminated bodies lbs2 are each configured by laminating the under layer 205, the lower pinning layer 221, the lower second magnetization fixed layer 222, the lower magnetic coupling layer 223, and the lower first magnetization fixed layer 224 in this order. The first laminated body lbs1 is configured by laminating the lower intermediate layer 225 and the magnetization free layer 226 in this order. The plurality of third laminated bodies lbs3 are each configured by laminating the upper intermediate layer 227, the upper first magnetization fixed layer 228, the upper magnetic coupling layer 229, the upper second magnetization fixed layer 230, the upper pinning layer 231, and the cap layer 211 in this order.

The lower first magnetization fixed layer 224 and the upper first magnetization fixed layer 228 correspond to the second magnetic layers 202. The magnetization free layer 226 corresponds to the first magnetic layer 201. The planar shapes of the lower first magnetization fixed layer 224 (second magnetic layer 202), the lower intermediate layer 225 (intermediate layer 203), the magnetization free layer 226 (first magnetic layer 201), the upper intermediate layer 227 (intermediate layer 203), and the upper first magnetization fixed layer 228 (second magnetic layer 202) of the strain detecting element 200s illustrated in FIG. 52 are a combination of the structures illustrated in FIG. 26D and FIG. 26E.

As the under layer 205, for example, Ta/Ru are used. The thickness of this Ta layer (length in the Z-axis direction) is, for example, 3 nanometers (nm). The thickness of this Ru layer is, for example, 2 nm. For the lower pinning layer 221, for example, the IrMn layer at the thickness of 7 nm is used. For the lower second magnetization fixed layer 222, for example, the Co₄₀Fe₄₀B₂₀ layer at the thickness of 2.5 nm is used. For the lower magnetic coupling layer 223, for example, the Ru layer at the thickness of 0.9 nm is used. For the lower first magnetization fixed layer 224, for example, the Co₄₀Fe₁₀B₂₀ layer at the thickness of 3 nm is used. For the lower intermediate layer 225, for example, the MgO layer at the thickness of 1.6 nm is used. For the magnetization free layer 226, for example, the Co₄₀Fe₄₀B₂₀ layer at the thickness of 4 nm is used. For the upper intermediate layer 227, for example, the MgO layer at the thickness of 1.6 nm is used. For the upper first magnetization fixed layer 228, for example, the Co₄₀Fe₄₀B₂₀/Fe₅₀Co₅₀ are used. The thickness of this Co₄₀Fe₄₀B₂₀ layer is, for example, 2 nm. The thickness of this Fe₅₀Co₅₀ layer is, for example, 1 nm. For the upper magnetic coupling layer 229, for example, the Ru layer at the thickness of 0.9 nm is used. For the upper second magnetization fixed layer 230, for example, the Co₇₅Fe₂₅ layer at thickness of 2.5 nm is used. For the upper pinning layer 231, for example, the IrMn layer at the thickness of 7 nm is used. For the cap layer 211, for example, Ta/Ru are used. The thickness of this Ta layer is, for example, 1 nm. The thickness of this Ru layer is, for example, 5 nm.

For the materials of the respective layers of the strain detecting element 200s, the materials similar to the materials of the respective layers of the strain detecting element 200A can be used.

The strain detecting element 200s illustrated in FIG. 52 is configured by connecting the junctions formed of the first magnetic layer 201, the intermediate layers 203, and the second magnetic layers 202 in series and in parallel. However, for example, the junctions may be connected in series and in parallel as a strain detecting element 200t illustrated in FIG. 53.

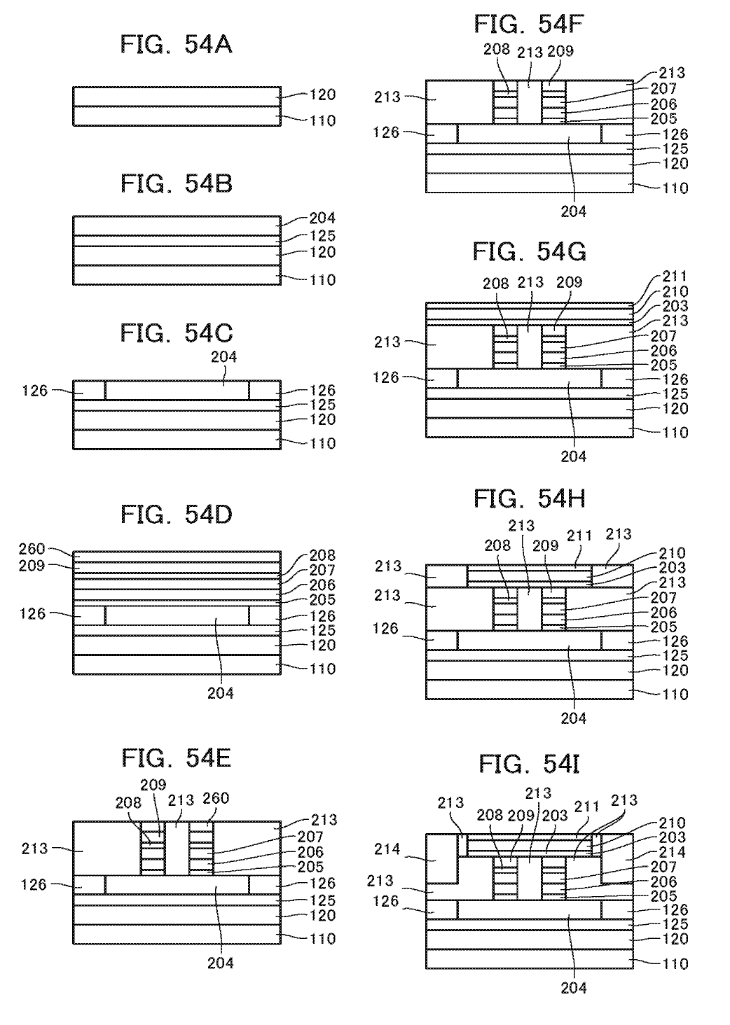

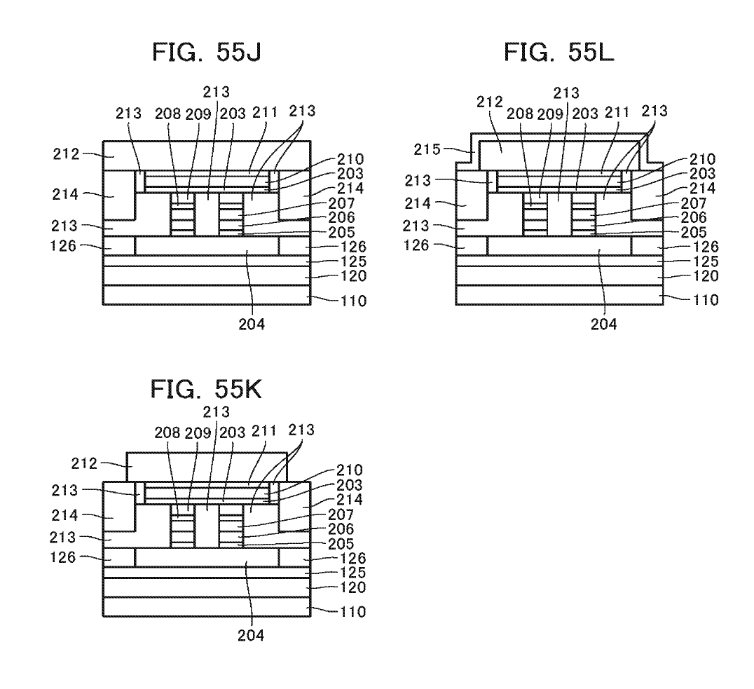

The following describes a method for manufacturing the strain detecting element 200 according to the embodiment with reference to FIG. 54A to FIG. 54I and FIG. 55J to FIG. 55K. FIG. 54A to FIG. 54I and FIG. 55J to FIG. 55K are schematic cross-sectional views illustrating a state for manufacturing, for example, the strain detecting element 200a illustrated in FIG. 30.

This manufacturing method performs the processes illustrated in FIG. 54A to FIG. 54D similar to the processes illustrated in FIG. 18A to FIG. 18D, which are the processes for manufacturing the strain detecting element 200A.

Next, as illustrated in FIG. 54E, the under layer 205, the pinning layer 206, the second magnetization fixed layer 207, the magnetic coupling layer 208, the first magnetization fixed layer 209 (second magnetic layer 202), and the intermediate cap layer 260 are removed leaving a part of them. This process patterns a resist by photolithography. Afterwards, using the resist pattern (not illustrated) as a mask, the physical milling or the chemical milling is performed. For example, the Ar ion milling is performed. This process plurally separates the laminated body including the second magnetic layer 202, thus forming the plurality of second magnetic layers 202.

Next, the insulating layer 213 is embedded at the periphery of the laminated body including the first magnetization fixed layer 209. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

Next, as illustrated in FIG. 54F, the intermediate cap layer 260, which is the outermost surface of the laminated body, a part of the first magnetization fixed layer 209, and a part of the insulating layer 213 are removed. This removal process performs the physical milling or a similar process. For example, the Ar ion milling or the substrate bias process using Ar plasma is performed. The process illustrated in FIG. 54F is performed inside of the apparatus that forms the laminated body including the magnetization free layer 210 (first magnetic layer 201), which is formed later. Thus, in a state where the outermost surface of the first magnetization fixed layer 209 (second magnetic layer 202) is purified, the process can transition to a formation of the intermediate layer in vacuum. For example, after completely removing the MgO (3 nm) of the intermediate cap layer 260 and removing 5 nm from the Co₄₀Fe₄₀B₂₀ (8 nm) of the first magnetization fixed layer 209, as the first magnetization fixed layer 209, Co₄₀Fe₄₀B₂₀ (3 nm) is formed.

Next, as illustrated in FIG. 54G, the intermediate layer 203, the magnetization free layer 210 (first magnetic layer 201), and the cap layer 211 are laminated on the first magnetization fixed layer 209 in this order. For example, as the intermediate layer 203, MgO (1.6 nm) is formed. As the magnetization free layer 210, Co₄₀Fe₄₀B₂₀ (4 nm) is formed on the intermediate layer 203. As the cap layer 211, Cu (3 nm)/Ta (2 nm)/Ru (10 nm) are formed on the magnetization free layer 210. Between the magnetization free layer 210 and the cap layer 211, as the diffusion preventing layer (not illustrated), MgO (1.5 nm) may be formed.

Next, as illustrated in FIG. 54H, the intermediate layer 203, the magnetization free layer 210 (first magnetic layer 201), and the cap layer 211 are removed leaving a part of them. This process patterns a resist by photolithography. Afterwards, using the resist pattern (not illustrated) as a mask, the physical milling or the chemical milling is performed. For example, the Ar ion milling is performed. Here, the planer dimensions of the laminated body including the magnetization free layer 210 (first magnetic layer 201) are processed so as to overlap with the planer dimensions of the laminated body including the first magnetization fixed layer 209 (second magnetic layer 202).

Next, the insulating layer 213 is embedded at the periphery of the laminated body including the magnetization free layer 210. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

Next, the magnetic field annealing, which fixes the magnetization direction of the first magnetization fixed layer 209 (second magnetic layer 202), is performed. For example, while applying the external magnetic field at 7 kOe, annealing is performed for one hour at 300° C. Here, as long as performed after the process of FIG. 54D, which forms the laminated body including the second magnetic layer 202, the magnetic field annealing may be performed at any timing.

Next, as illustrated in FIG. 54I, the hard bias layer 214 is embedded into the insulating layer 213. For example, a hole where the hard bias layer 214 is embedded is formed at the insulating layer 213. This process patterns a resist by photolithography. Afterwards, using the resist pattern (not illustrated) as a mask, the physical milling or the chemical milling is performed. This process may form the hole up to the depth penetrating the peripheral insulating layer 213 or may be stopped in midstream. FIG. 54I exemplifies the case where the formation of the hole is stopped in midstream so as not to penetrate the insulating layer 213. If the hole is etched up to the depth of penetrating the insulating layer 213, at the embedding process of the hard bias layer 214 illustrated in FIG. 54I, an insulating layer (not illustrated) needs to be formed below the hard bias layer 214.

Next, the hard bias layer 214 is embedded into the formed hole. In this process, for example, the liftoff process is performed. For example, while leaving the resist pattern, which is formed by the photolithography, the hard bias layer 214 is formed on the entire surface, and the resist pattern is removed. Here, for example, as an under layer for hard bias layer, Cr (5 nm) is formed. As the hard bias layer 214, for example, Co₈₀Pt₂₀ (20 nm) is formed on the under layer for hard bias layer. Further, a cap layer (not illustrated) may be formed on the hard bias layer 214. As this cap layer, the materials described above as the materials applicable to the cap layer of the strain detecting element 200A may be used. Alternatively, as this cap layer, an insulating layer made of a material such as SiOₓ, AlOₓ, SiNₓ, and AlNₓ may be used.

Next, the external magnetic field is applied at room temperature, thus setting the magnetization direction of the hard magnetic material contained in the hard bias layer 214. The magnetization direction of the hard bias layer 214 may be set by the external magnetic field at any timing as long as performed after the embedding of the hard bias layer 214.

The embedding process of the hard bias layer 214 illustrated in FIG. 54I may be performed simultaneously with the embedding process of the insulating layer 213 illustrated in FIG. 54H. The embedding process of the hard bias layer 214 illustrated in FIG. 54I is not necessarily performed.

Next, as illustrated in FIG. 55J, the upper electrode 212 is laminated on the cap layer 211. Next, as illustrated in FIG. 55K, the upper electrode 212 is removed leaving a part of the upper electrode 212. This process patterns a resist by photolithography. Afterwards, using the resist pattern (not illustrated) as a mask, the physical milling or the chemical milling is performed.

Next, as illustrated in FIG. 55L, the protecting layer 215 is formed. The protecting layer 215 covers the upper electrode 212 and the hard bias layers 214. For example, as the protecting layer 215, an insulating layer made of a material such as SiOₓ, AlOₓ, SiNₓ, and AlNₓ may be used. The protecting layer 215 is not necessarily to be disposed.

Although not illustrated in FIG. 54A to FIG. 55L, a contact hole to the lower electrode 204 or the upper electrode 212 may be formed.

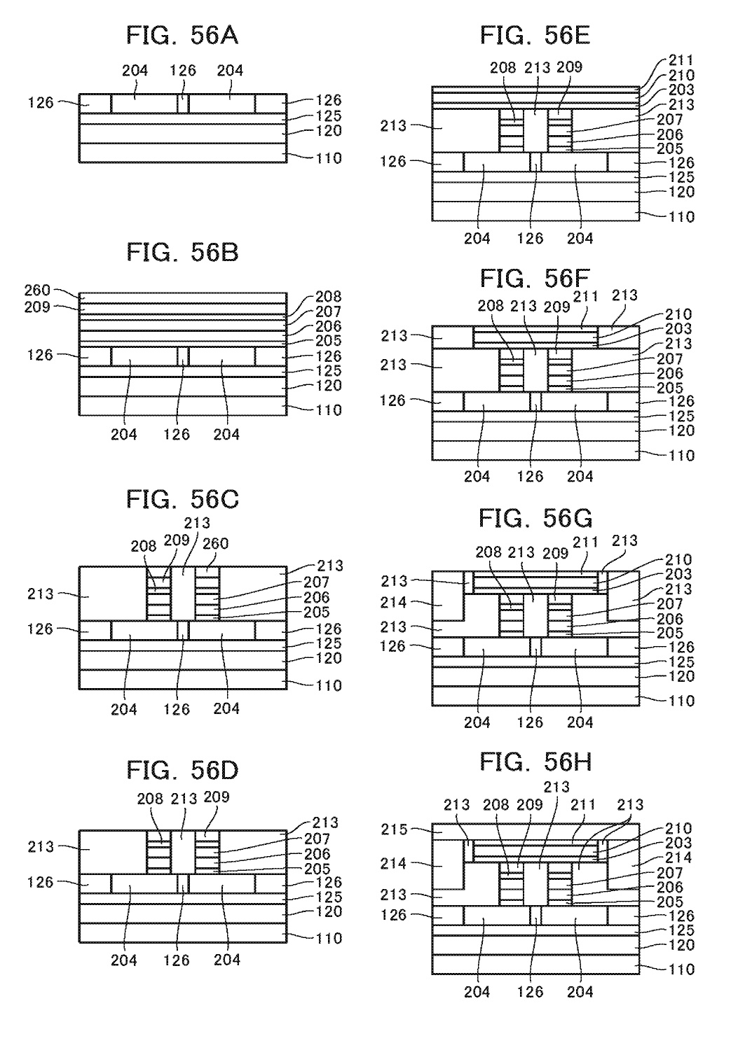

The following describes another method for manufacturing the strain detecting element 200 according to the embodiment with reference to FIG. 56A to FIG. 56H. FIG. 56A to FIG. 56H are schematic cross-sectional views illustrating a state for manufacturing, for example, the strain detecting element 200b illustrated in FIG. 31.

In this manufacturing method, the processes illustrated in FIG. 18A and FIG. 18B are performed similar to the method for manufacturing the strain detecting element 200A.

Next, as illustrated in FIG. 56A, the planar shape of the lower electrode 204 is processed. This process patterns a resist by photolithography. Afterwards, using the resist pattern (not illustrated) as a mask, the physical milling or the chemical milling is performed. For example, the Ar ion milling is performed. This process plurally separates the planar shape of the lower electrode 204. That is, a first lower electrode and a second lower electrode are formed.

Furthermore, the insulating layer 126 is embedded at the periphery of the lower electrodes 204. In this process, for example, the liftoff process is performed. For example, while leaving the resist pattern, which is formed by the photolithography, the insulating layer 126 is formed on the entire surface, and the resist pattern is removed. As the insulating layer 126, for example, SiOₓ, AlOₓ, SiNₓ, and AlNₓ can be used.

Next, as illustrated in FIG. 56B, the under layer 205, the pinning layer 206, the second magnetization fixed layer 207, the magnetic coupling layer 208, the first magnetization fixed layer 209, and the intermediate cap layer 260 are laminated on the lower electrodes 204 in this order. This process can be performed similar to the method described with reference to FIG. 18D.

Next, as illustrated in FIG. 56C, a part of the under layer 205, the pinning layer 206, the second magnetization fixed layer 207, the magnetic coupling layer 208, the first magnetization fixed layer 209 (second magnetic layer 202), and the intermediate cap layer 260 are removed leaving a part of them. This process patterns a resist by photolithography. Afterwards, using the resist pattern (not illustrated) as a mask, the physical milling or the chemical milling is performed. For example, the Ar ion milling is performed. This process is performed such that the laminated bodies including the second magnetic layers 202 are independently disposed respectively on the lower electrodes 204, which are separated in the process described with reference to FIG. 56A.

Next, the insulating layer 213 is embedded at the periphery of the laminated body including the first magnetization fixed layer 209. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

As illustrated in FIG. 56D to FIG. 56G, the following performs processes almost similar to the processes described with reference to FIG. 54F to FIG. 54I.

Next, as illustrated in FIG. 56H, the protecting layer 215 is formed. The protecting layer 215 covers the cap layer 211 and the hard bias layers 214. For example, as the protecting layer 215, an insulating layer made of a material such as SiOₓ, AlOₓ, SiNₓ, and AlNₓ may be used. The protecting layer 215 is not necessarily to be disposed.

Although not illustrated in FIG. 56A to FIG. 56H, a contact hole to the lower electrode 204 or the upper electrode 212 may be formed.

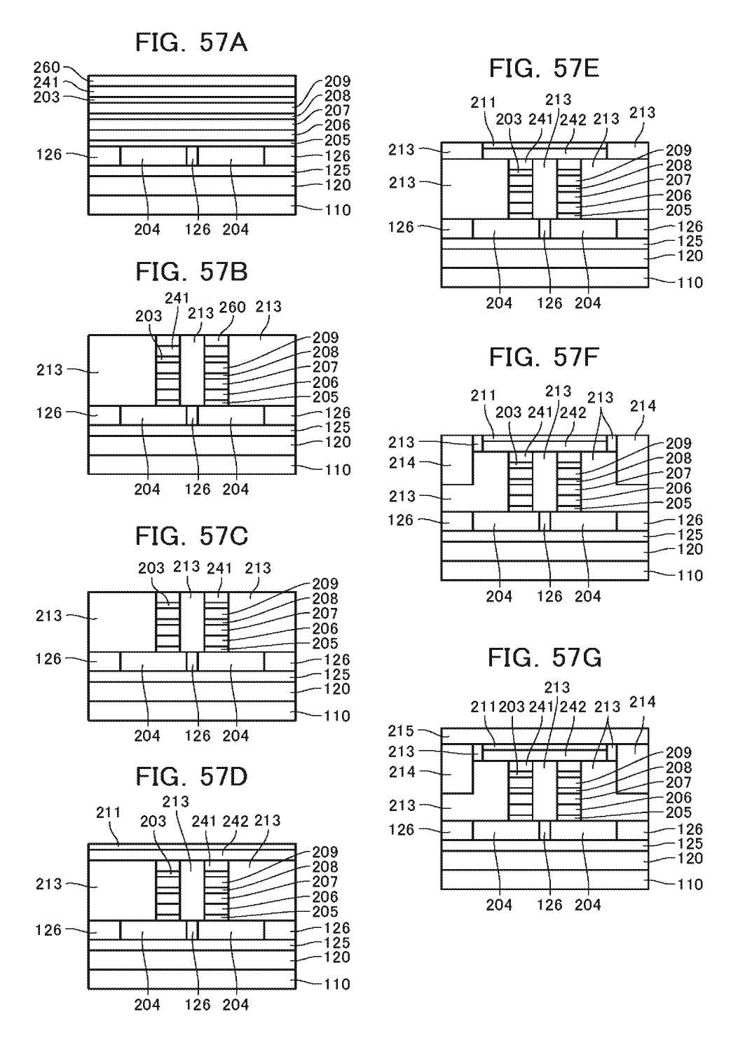

The following describes another method for manufacturing the strain detecting element 200 according to the embodiment with reference to FIG. 57A to FIG. 57G. FIG. 57A to FIG. 57G are schematic cross-sectional views illustrating a state for manufacturing, for example, the strain detecting element 200h illustrated in FIG. 37.

In this manufacturing method, the processes illustrated in FIG. 18A and FIG. 18B are performed similar to the method for manufacturing the strain detecting element 200A. The process illustrated in FIG. 56A is performed similar to the method for manufacturing the strain detecting element 200b.

Next, as illustrated in FIG. 57A, the under layer 205, the pinning layer 206, the second magnetization fixed layer 207, the magnetic coupling layer 208, the first magnetization fixed layer 209, the intermediate layer 203, the second magnetization free layer 241 (third magnetic layer 251), and the intermediate cap layer 260 are laminated on the lower electrodes 204 in this order. For example, as the under layer 205, Ta (3 nm)/Ru (2 nm) are formed. As the pinning layer 206, IrMn (7 nm) is formed on the under layer 205. As the second magnetization fixed layer 207/the magnetic coupling layer 208/the first magnetization fixed layer 209, Co₇₅Fe₂₅ (2.5 nm)/Ru (0.9 nm)/Co₄₀Fe₄₀B₂₀ (3 nm) are formed on the pinning layer 206. As the intermediate layer 203, MgO (1.6 nm) is formed on the first magnetization fixed layer 209. As the second magnetization free layer 241 (third magnetic layer 251), Co₄₀Fe₄₀B₂₀ (4 nm) is formed on the intermediate layer 203. Further, as the intermediate cap layer 260, MgO (3 nm) is formed on the second magnetization free layer 241. Here, the intermediate cap layer 260 and a part of the second magnetization free layer 241 are removed in a process described later.

Next, as illustrated in FIG. 57B, the under layer 205, the pinning layer 206, the second magnetization fixed layer 207, the magnetic coupling layer 208, the first magnetization fixed layer 209 (second magnetic layer 202), the intermediate layer it 203, the second magnetization free layer 241 (third magnetic layer 251), and the intermediate cap layer 260 are removed leaving a part of them. This process patterns a resist by photolithography. Afterwards, using the resist pattern (not illustrated) as a mask, the physical milling or the chemical milling is performed. For example, the Ar ion milling is performed. This process is performed such that the laminated bodies including the second magnetic layers 202 are independently disposed respectively on the lower electrodes 204, which are separated in the process described with reference to FIG. 56A.

Next, the insulating layer 213 is embedded at the periphery of the laminated body including the first magnetization fixed layer 209. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

Next, as illustrated in FIG. 57C, the intermediate cap layer 260, which is the outermost surface of the laminated body, a part of the second magnetization free layer 241, and a part of the insulating layer 213 are removed. This removal process performs the physical milling or a similar process. For example, the Ar ion milling or the substrate bias process using Ar plasma is performed. The process illustrated in FIG. 57C is performed inside of the apparatus that forms the laminated body including the first magnetization free layer 242 (first magnetic layer 201), which is formed later. Thus, in a state where the outermost surface of the first magnetization fixed layer 209 (second magnetic layer 202) is purified, the process can transition to a formation of the intermediate layer in vacuum. For example, after completely removing the MgO (3 nm) of the intermediate cap layer 260 and removing 3 nm from the Co₄₀Fe₄₀B₂₀ (4 nm) of the second magnetization free layer 241, as the second magnetization free layer 241, Co₄₀Fe₄₀B₂₀ (1 nm) is formed.

Next, as illustrated in FIG. 57D, the first magnetization free layer 242 (first magnetic layer 201) and the cap layer 211 are laminated on the second magnetization free layers 241 in this order. For example, as the first magnetization free layer 242 (first magnetic layer 201), the Co₄₀Fe₄₀B₂₀ (4 nm) is formed. As the cap layer 211, Cu (3 nm)/Ta (2 nm)/Ru (10 nm) are formed on the first magnetization free layer 242. Between the first magnetization free layer 242 and the cap layer 211, as the diffusion preventing layer (not illustrated), MgO (1.5 nm) may be formed.

Next, as illustrated in FIG. 57E, the first magnetization free layers 242 (first magnetic layers 201) and the cap layer 211 are removed leaving a part of them. This process patterns a resist by photolithography. Afterwards, using the resist pattern (not illustrated) as a mask, the physical milling or the chemical milling is performed. For example, the Ar ion milling is performed. Here, the planer dimensions of the laminated body including the first magnetization free layer 242 (first magnetic layer 201) are processed so as to overlap with the planer dimensions of the laminated body including the first magnetization fixed layers 209 (second magnetic layers 202).

Next, the insulating layer 213 is embedded at the periphery of the laminated body including the magnetization free layer 210. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

Next, the magnetic field annealing, which fixes the magnetization direction of the first magnetization fixed layer 209 (second magnetic layer 202), is performed. For example, while applying the external magnetic field at 7 kOe, annealing is performed for one hour at 300° C. Here, as long as performed after the process of FIG. 57A, which forms the laminated body including the second magnetic layer 202, the magnetic field annealing may be performed at any timing.

Hereinafter, as illustrated in FIG. 57F, by the process almost similar to the process described with reference to FIG. 56H, the strain detecting element 200h illustrated in FIG. 37 can be manufactured. When using this manufacturing method, the process can form the laminated structure (the first magnetization fixed layer 209, the intermediate layer 203, and the second magnetization free layer 241) near the intermediate layer 203, which gives a significant influence to the MR effect, at a time in vacuum. Therefore, this is preferable from the aspect of obtaining the high MR ratio.

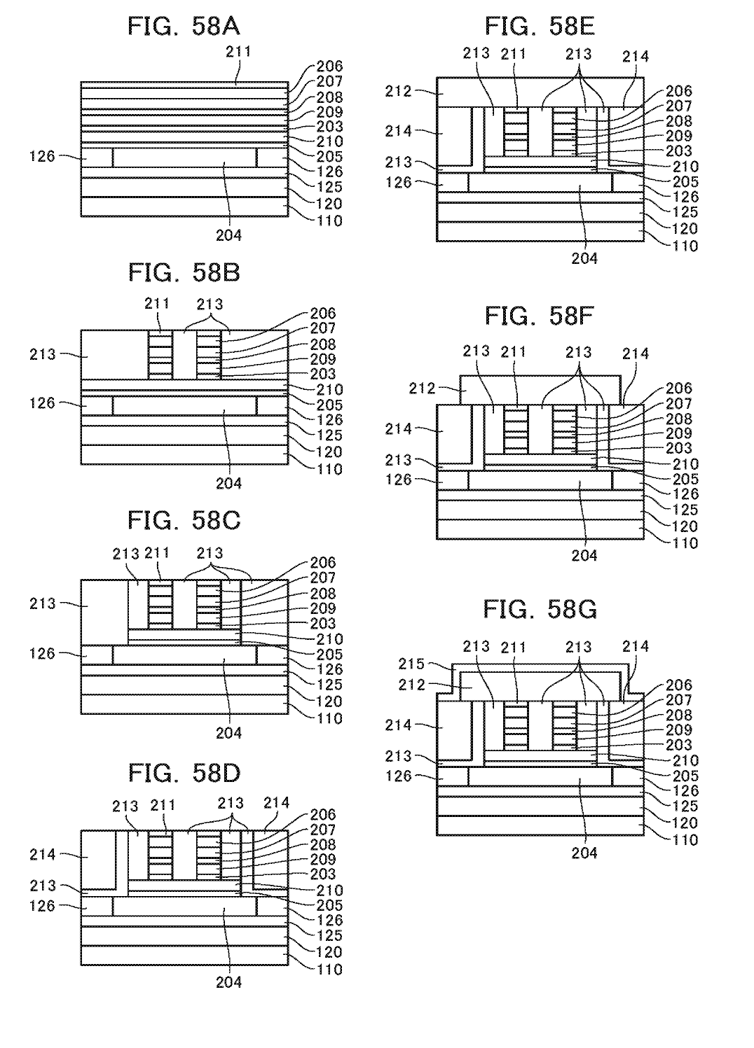

The following describes another method for manufacturing the strain detecting element 200 according to the embodiment with reference to FIG. 58A to FIG. 58G. FIG. 58A to FIG. 58G are schematic cross-sectional views illustrating a state for manufacturing, for example, the strain detecting element 200j illustrated in FIG. 43.

In this manufacturing method, the processes illustrated in FIG. 18A to FIG. 18C are performed similar to the method for manufacturing the strain detecting element 200A.

Next, as illustrated in FIG. 58A, the under layer 205, the magnetization free layer 210 (first magnetic layer 201), the intermediate layer 203, the first magnetization fixed layer 209 (second magnetic layer 202), the magnetic coupling layer 208, the second magnetization fixed layer 207, the pinning layer 206, and the cap layer 211 are laminated on the lower electrode 204 in this order. For example, as the under layer 205, Ta (3 nm)/Cu (5 nm) are formed. As the magnetization free layer 210, Co₄₀Fe₄₀B₂₀ (4 nm) is formed on the under layer 205. As the intermediate layer 203, MgO (1.6 nm) is formed on the magnetization free layer 210. As the first magnetization fixed layer 209 (second magnetic layer 202)/the magnetic coupling layer 208/the second magnetization fixed layer 207, Co₄₀Fe₄₀B₂₀ (2 nm)/Fe₅₀Co₅₀ (1 nm)/Ru (0.9 nm)/Co₇₅Fe₂₅ (2.5 nm) are formed on the intermediate layer 203. As the pinning layer 206, the IrMn (7 nm) is formed on the second magnetization fixed layer 207. As the cap layer 211, Cu (3 nm)/Ta (2 nm)/Ru (10 nm) are formed on the pinning layer 206. Here, between the magnetization free layer 210 and the under layer 205, as the diffusion preventing layer (not illustrated), MgO (1.5 nm) may be formed.

Next, as illustrated in FIG. 58B, the intermediate layer 203, the first magnetization fixed layer 209 (second magnetic layer 202), the magnetic coupling layer 208, the second magnetization fixed layer 207, the pinning layer 206, and the cap layer 211 are removed leaving a part of them. This process patterns a resist by photolithography. Afterwards, using the resist pattern (not illustrated) as a mask, the physical milling or the chemical milling is performed. For example, the Ar ion milling is performed. This process plurally separates the laminated body including the second magnetic layer 202, thus forming the plurality of second magnetic layers 202.

Next, the insulating layer 213 is embedded at the periphery of the laminated body including the first magnetization fixed layer 209. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used. This process stops the etching process up to a part of the intermediate layer 203 or the magnetization free layer 210 so as not to process all the planar shapes of the magnetization free layer 210.

Next, as illustrated in FIG. 58C, the under layer 205, the magnetization free layer 210 (first magnetic layer 201), and the insulating layers 213, which are embedded in the above-described process, are removed leaving a part of them. This process patterns a resist by photolithography. Afterwards, using the resist pattern (not illustrated) as a mask, the physical milling or the chemical milling is performed. For example, the Ar ion milling is performed. This process performs the etching up to the under layer 205 so as to make the planar shape of the magnetization free layer 210 to be larger than the dimensions of the first magnetization fixed layers 209.

Next, the insulating layer 213 is embedded at the periphery of the laminated body including the magnetization free layer 210. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

Next, the magnetic field annealing, which fixes the magnetization direction of the first magnetization fixed layer 209 (second magnetic layer 202), is performed. For example, while applying the external magnetic field at 7 kOe, annealing is performed for one hour at 300° C. Here, as long as performed after the process of FIG. 58A, which forms the laminated body including the second magnetic layer 202, the magnetic field annealing may be performed at any timing.

Hereinafter, as illustrated in FIG. 58D to FIG. 58G, by the processes almost similar to the processes described with reference to FIG. 54I and FIG. 55J to FIG. 55L, the strain detecting element 200j illustrated in FIG. 43 can be manufactured. When using this manufacturing method, the process described with reference to FIG. 58A can form the laminated structure (the magnetization free layer 210, the intermediate layer 203, and the first magnetization fixed layer 209) near the intermediate layer 203, which gives a significant influence to the MR effect, at a time in vacuum. Therefore, this is preferable from the aspect of obtaining the high MR ratio.

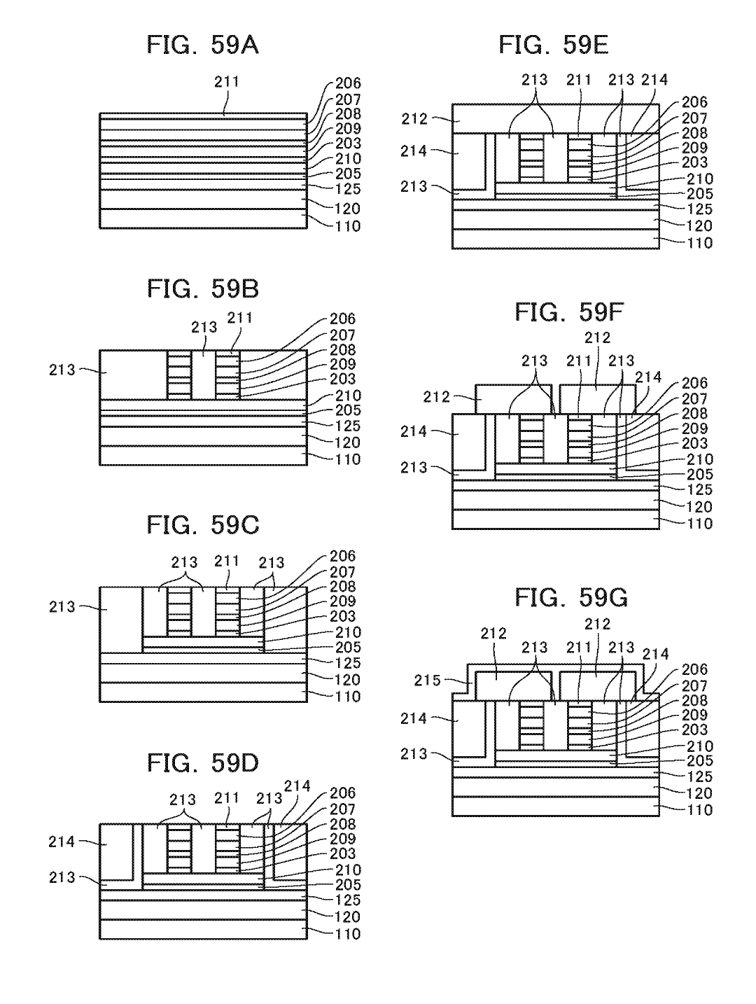

The following describes another method for manufacturing the strain detecting element 200 according to the embodiment with reference to FIG. 59A to FIG. 59G. FIG. 59A to FIG. 59G are schematic cross-sectional views illustrating a state for manufacturing, for example, the strain detecting element 200k illustrated in FIG. 44.

In this manufacturing method, the processes illustrated in FIG. 18A and FIG. 18B are performed similar to the method for manufacturing the strain detecting element 200A.

Next, as illustrated in FIG. 59A, the under layer 205, the magnetization free layer 210 (first magnetic layer 201), the intermediate layer 203, the first magnetization fixed layer 209 (second magnetic layer 202), the magnetic coupling layer 208, the second magnetization fixed layer 207, the pinning layer 206, and the cap layer 211 are laminated on the film portion 120 in this order. For example, as the under layer 205, Ta (3 nm)/Cu (5 nm) are formed. As the magnetization free layer 210, the Co₄₀Fe₄₀B₂₀ (4 nm) is formed on the under layer 205. As the intermediate layer 203, MgO (1.6 nm) is formed on the magnetization free layer 210. As the first magnetization fixed layer 209 (second magnetic layer 202)/the magnetic coupling layer 208/the second magnetization fixed layer 207, Co₄₀Fe₄₀B₂₀ (2 nm)/Fe₅₀Co₅₀ (1 nm)/Ru (0.9 nm)/Co₇₅Fe₂₅ (2.5 nm) are formed on the intermediate layer 203. As the pinning layer 206, the IrMn (7 nm) is formed on the second magnetization fixed layer 207. As the cap layer 211, Cu (3 nm)/Ta (2 nm)/Ru (10 nm) are formed on the pinning layer 206. Here, between the magnetization free layer 210 and the under layer 205, as the diffusion preventing layer (not illustrated), MgO (1.5 nm) may be formed.

Next, as illustrated in FIG. 59B, the intermediate layer 203, the first magnetization fixed layer 209 (second magnetic layer 202), the magnetic coupling layer 208, the second magnetization fixed layer 207, the pinning layer 206, and the cap layer 211 are removed leaving a part of them. This process patterns a resist by photolithography. Afterwards, using the resist pattern (not illustrated) as a mask, the physical milling or the chemical milling is performed. For example, the Ar ion milling is performed. This process plurally separates the laminated body including the second magnetic layer 202, thus forming the plurality of second magnetic layers 202.

Next, the insulating layer 213 is embedded at the periphery of the laminated body including the first magnetization fixed layer 209. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used. This process stops the etching process up to a part of the intermediate layer 203 or the magnetization free layer 210 so as not to process all the planar shapes of the magnetization free layer 210.

Next, as illustrated in FIG. 59C, the under layer 205, the magnetization free layer 210 (first magnetic layer 201), and the insulating layers 213, which are embedded in the above-described process, are removed leaving a part of them. This process patterns a resist by photolithography. Afterwards, using the resist pattern (not illustrated) as a mask, the physical milling or the chemical milling is performed. For example, the Ar ion milling is performed. This process performs the etching up to the under layer 205. This process is performed such that the plurality of first magnetization fixed layers 209 separated in FIG. 59B overlap with the magnetization free layer 210 viewed from the X-Y plane.

Next, the insulating layer 213 is embedded at the periphery of the laminated body including the magnetization free layer 210. In this process, for example, the liftoff process is performed. For example, while leaving the resist pattern, which is formed by the photolithography, the insulating layer 213 is formed on the entire surface, and the resist pattern is removed. As the insulating layer 213, for example, SiOₓ, AlOₓ, SiNₓ, and AlNₓ can be used.

Next, the magnetic field annealing, which fixes the magnetization direction of the first magnetization fixed layer 209 (second magnetic layer 202), is performed. For example, while applying the external magnetic field at 7 kOe, annealing is performed for one hour at 300° C. Here, as long as performed after the process of FIG. 59A, which forms the laminated body including the second magnetic layer 202, the magnetic field annealing may be performed at any timing.

Next, for example, as illustrated in FIG. 59D, the hard bias layers 214 are embedded into the insulating layers 213. This process, for example, can be performed by the similar process described with reference to FIG. 54E.

Next, as illustrated in FIG. 59E, the upper electrode 212 is laminated on the cap layers 211. Next, as illustrated in FIG. 59F, the upper electrode 212 is removed leaving a part of the upper electrode 212. This process patterns a resist by photolithography. Afterwards, using the resist pattern (not illustrated) as a mask, the physical milling or the chemical milling is performed. This process plurally separates the planar shape of the upper electrode 212. That is, a first upper electrode and a second upper electrode are formed.

Next, as illustrated in FIG. 59G, the protecting layer 215 is formed. The protecting layer 215 covers the upper electrodes 212 and the hard bias layers 214. For example, as the protecting layer 215, an insulating layer made of a material such as SiOₓ, AlOₓ, SiNₓ, and AlNₓ may be used. The protecting layer 215 is not necessarily to be disposed.

Although not illustrated in FIG. 59A to FIG. 59G, a contact hole to the lower electrode 204 or the upper electrode 212 may be formed. When using this manufacturing method, the process described with reference to FIG. 59A can form the laminated structure (the magnetization free layer 210, the intermediate layer 203, and the first magnetization fixed layer 209) near the intermediate layer 203, which gives a significant influence to the MR effect, at a time in vacuum. Therefore, this is preferable from the aspect of obtaining the high MR ratio.

### 3. THIRD EMBODIMENT

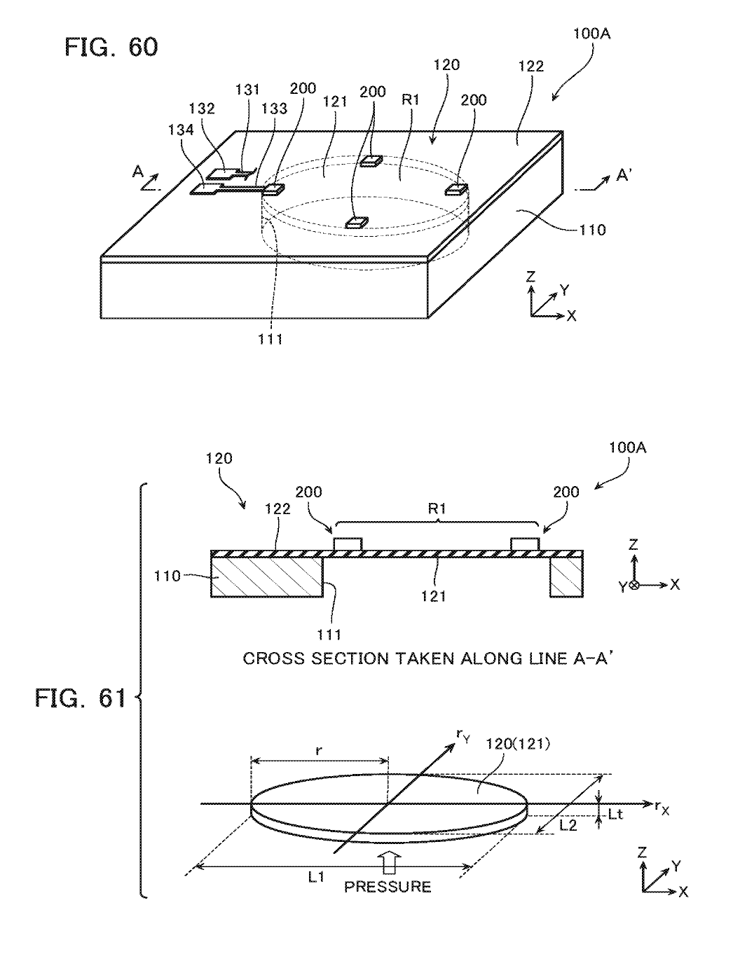

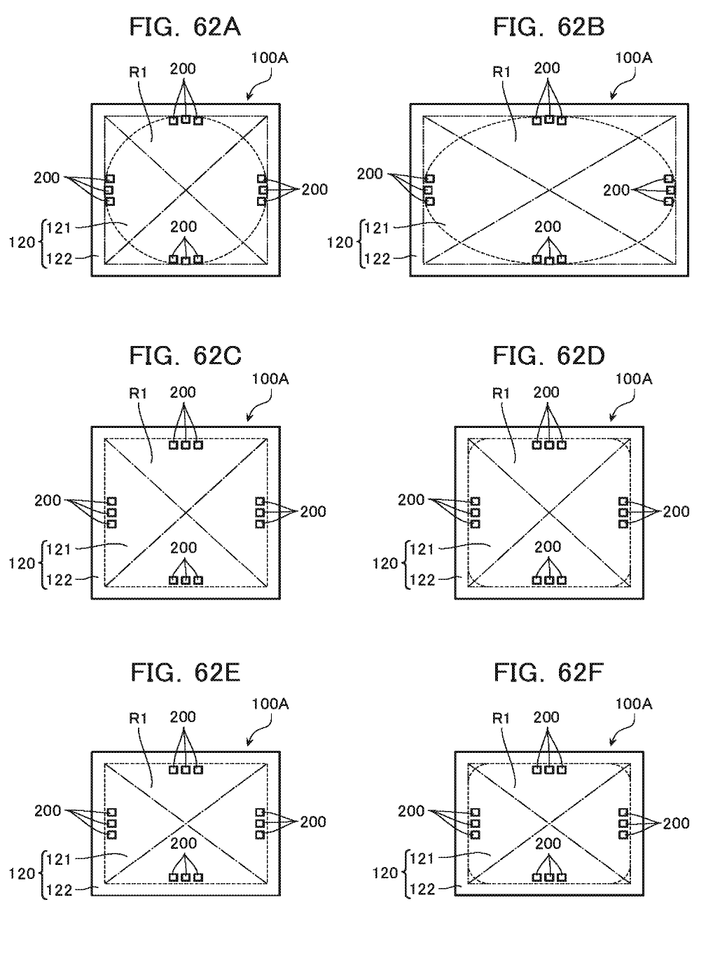

The following describes an exemplary configuration 100 of a pressure sensor that mounts the strain detecting element 200 according to first and second embodiments. FIG. 60 is a schematic perspective view illustrating a configuration of the pressure sensor 100 according to an embodiment. FIG. 61 are schematic cross-sectional views viewed from the line A-A′ in FIG. 1. FIG. 62A to 62F are schematic plan views illustrating a configuration of the pressure sensor 100.

As illustrated in FIG. 60, the pressure sensor 100 includes the substrate 110, the film portion 120, and the strain detecting elements 200. The film portion 120 is disposed at one surface of the substrate 110. The strain detecting elements 200 are disposed on the film portion 120. The strain detecting element 200 is the strain detecting element 200 according to the first or the second embodiment. The strain detecting elements 200 are disposed on a part of the film portion 120. On the film portion 120, a wiring 131, a pad 132, a wiring 133, and a pad 134, which are connected to the strain detecting element 200, are disposed.

As illustrated in FIG. 61, the substrate 110 is a plate-shaped substrate having a void portion 111. The substrate 110 functions as a supporting portion that supports the film portion 120 such that the film portion 120 bends according to an external pressure. In the embodiment, the void portion 111 is a cylindrically-shaped hole penetrating the substrate 110. The substrate 110 is, for example, made of a semiconductor material such as silicon, a conductive material such as metal, or an insulating material. The substrate 110, for example, may contain silicon oxide and silicon nitride.

The inside of the void portion 111 is designed so as to bend the film portion 120. For example, the inside of the void portion 111 may be a decompressed state or a vacuum state. The inside of the void portion 111 may be filled with gas such as air or liquid. Further, the void portion 111 may communicate with the outside.

As illustrated in FIG. 61, the film portion 120 is formed thinner than the substrate 110. The film portion 120 includes a vibrating portion 121 and a supported portion 122. The vibrating portion 121 is positioned immediately above the void portion 111. The vibrating portion 121 bends according to the external pressure. The supported portion 122 is integrally formed with the vibrating portion 121 and is supported by the substrate 110. The strain detecting elements 200 are disposed at a part of the vibrating portion 121. For example, as illustrated in FIG. 62A, the supported portion 122 surrounds the vibrating portion 121. Hereinafter, a region positioned immediately above the void portion 111 of the film portion 120 is referred to as a first region R1.

The first region R1 can be formed into various shapes. For example, as illustrated in FIG. 62A, the first region R1 may be formed into an approximately perfect circle shape, may be formed into an oval shape (for example, a flat circular shape) as illustrated in FIG. 62B, may be formed into an approximately square shape as illustrated in FIG. 62C, or may be formed into a rectangular shape as illustrated in FIG. 62E. When forming the first region R1 into, for example, the approximately square shape or the approximately rectangular shape, as illustrated in FIG. 62D or FIG. 62F, roundly forming the four corner parts is also possible. Further, the first region R1 can be formed into a polygonal or regular polygonal shape.

As the material of the film portion 120, for example, an insulating material such as SiOₓ and SiNₓ, or flexible plastic material such as polyimide or paraxylylene-based polymer may be used. The material of the film portion 120 may contain, for example, at least any of silicon oxide, silicon nitride, and silicon oxynitride. For the material of the film portion 120, for example, a semiconductor material such as silicon may be used or a metallic material such as Al may be used.

The film portion 120 is formed thinner than the substrate 110. The thickness of the film portion 120 (width in the Z direction) is, for example, 0.1 micrometers (μm) or more to 3 μm or less. The thickness of the film portion 120 is preferable to be 0.2 μm or more to 1.5 μm or less. For the film portion 120, for example, the laminated body constituted of the silicon oxide film at the thickness of 0.2 μm and a silicon film at the thickness of 0.4 μm may be used.

As illustrated in FIG. 62A to FIG. 62F, the plurality of strain detecting elements 200 can be arranged in the first region R1 on the film portion 120. The respective strain detecting elements 200 are arranged along the outer edge of the first region R1. That is, in the examples illustrated in FIG. 62A to FIG. 62F, distances between the plurality of respective strain detecting elements 200 and the outer edge of the first region R1 (shortest distance Lmin) are the same as one another. The number of strain detecting elements 200 arranged in the first region R1 on the film portion 120 may be one.

For example, as illustrated in FIG. 62A and FIG. 62B, when the outer edge of the first region R1 is a curved line, the strain detecting elements 200 are arranged along the curved line. For example, as illustrated in FIGS. 62C and 62D, when the outer edge of the first region R1 is a straight line, the strain detecting elements 200 are linearly arranged along the straight line.

FIG. 62A to FIG. 62F illustrate the circumscribed rectangular with the film portion 120 and a diagonal line of the rectangular by one dot chain lines. Supposing that regions on the film portion 120 separated by this rectangular and the one dot chain lines are referred to as first to fourth planar regions. Then, the plurality of strain detecting elements 200 are arranged along the outer edge of the first region R1 in the first to fourth planar regions.

The strain detecting elements 200 are connected to the pad 132 via the wiring 131 and connected to the pad 134 via the wiring 133, which are illustrated in FIG. 60. When detecting pressure by the pressure sensor 100, a voltage is applied to the strain detecting elements 200 via these pads 132 and 134. Additionally, the electrical resistance value of the strain detecting element 200 is measured. Between the wiring 131 and the wiring 133, an inter-layer insulating layer may be disposed.

As the strain detecting element 200, for example, as the strain detecting element 200A illustrated in FIG. 10, assume the case of using the configuration including the lower electrode 204 and the upper electrode 212. For example, the wiring 131 is connected to the lower electrode 204 and the wiring 133 is connected to the upper electrode 212. Meanwhile, as the strain detecting element. 200b illustrated in FIG. 31, assume the case of using the configuration not including the upper electrode but including the two lower electrodes 204, or as the strain detecting element 200e illustrated in FIG. 34, the case of using the configuration not including the lower electrode but including the two upper electrodes 212. The wiring 131 is connected to the one lower electrode 204 or the one upper electrode 212 and the wiring 133 is connected to the other lower electrode 204 or the other upper electrode 212. The plurality of strain detecting elements 200 may be connected in series or in parallel via wirings (not illustrated). This allows increasing the SN ratio.

The size of the strain detecting element 200 may be extremely small. The area of the X-Y plane of the strain detecting element 200 can be sufficiently smaller than the area of the first region R1. For example, the area of the strain detecting element 200 can be reduced to be one-fifth or less of the area of first region R1. For example, the area of the first magnetic layer 201 included in the strain detecting element 200 can be reduced to be one-fifth or less of the area of first region R1. By connecting the plurality of strain detecting elements 200 in series or in parallel, even if using the strain detecting elements 200 sufficiently smaller than the area of the first region R1, the high gauge factor or the high SN ratio can be ensured.

For example, in the case where the diameter of the first region R1 is around 60 μm, first dimensions of the strain detecting element 200 (or the first magnetic layer 201) can be 12 μm or less. For example, in the case where the diameter of the first region R1 is around 600 μm, the dimensions of the strain detecting element 200 (or the first magnetic layer 201) can be 120 μm or less. Considering a process accuracy of the strain detecting element 200 or similar specifications, the dimensions of the strain detecting element 200 (or the first magnetic layer 201) needs not to be excessively small. Accordingly, the dimensions of the strain detecting element 200 (or the first magnetic layer 201), for example, can be 0.05 μm or more to 30 μm or less.

The examples illustrated in FIG. 60 to FIG. 62F configure the substrate 110 and the film portion 120 separately. However, the film portion 120 maybe formed integrally with the substrate 110. For the film portion. 120, the same material as the substrate 110 may be used, or a different material may be used. When forming the film portion. 120 integrally with the substrate 110, a part of the substrate 110 formed thin becomes the film portion 120 (vibrating portion 121). Further, the vibrating portion 121 may be consecutively supported along the outer edge of the first region R1 as illustrated in FIG. 60 to FIG. 62F. Alternatively, the vibrating portion 121 may be supported at a part of the outer edge of the first region R1.

In the examples illustrated in FIG. 62A to FIG. 62F, the plurality of strain detecting elements 200 are disposed on the film portion 120. However, for example, only the one strain detecting element 200 may be disposed on the film portion 120.

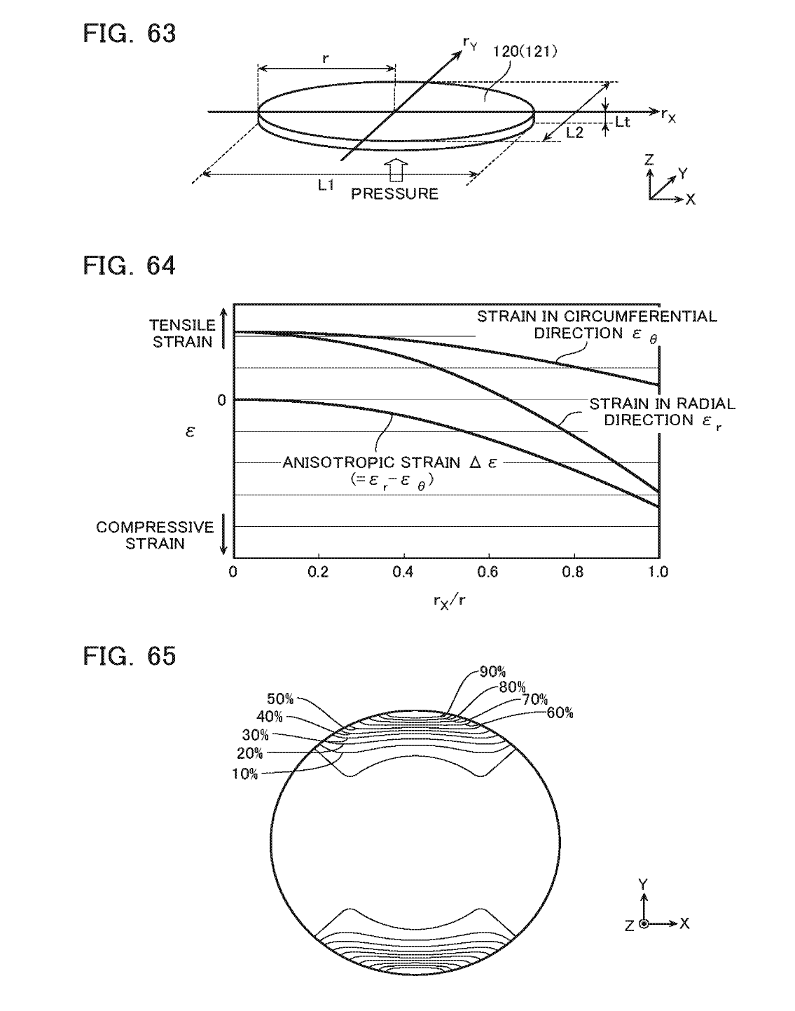

Next, with reference to FIG. 63 to FIG. 65, the following describes a simulation result conducted on the pressure sensor 100. This simulation calculates a magnitude of strains ε at the respective positions on the film portion 120 under application of pressure to the film portion 120. This simulation plurally divides the surface of the film portion 120 by finite element method analysis. Then, the Hooke's law is applied to the divided respective components.

FIG. 63 is a schematic perspective view for describing a model used for the simulation. As illustrated in FIG. 63, in the simulation, the vibrating portion 121 of the film portion 120 was formed into a circular shape. A diameter L1 (diameter L2) of the vibrating portion 121 was set to 500 μm and a thickness Lt of the film portion 120 was set to 2 μm. Further, the outer edge of the vibrating portion 121 was formed to a fixed end that is completely restrained.

The simulation assumes silicon as the material of the film portion 120. Therefore, the Young's modulus of the film portion 120 was set to 165 GPa, and the Poisson's ratio was set to 0.22.

Further, as illustrated in FIG. 63, it was assumed that pressure was applied to the film portion 120 from the bottom surface, the magnitude of pressure was 13.33 kPa, and the pressure was uniformly applied to the vibrating portion 121. The finite element method divided the vibrating portion 121 to a mesh size of 5 μm in the X-Y plane and divided at an interval of 2 μm in the Z direction.

Next, with reference to FIG. 64 and FIG. 65, the following describes a simulation result. FIG. 64 is a graph for describing a result of the simulation. The vertical axis indicates the magnitude of the strain ε. The horizontal axis indicates a value rₓ/r found by normalizing a distance rₓ from the center of the vibrating portion 121 by a radius r. FIG. 64 indicates the strain in the tensile direction as a strain in a positive value while a strain in the compressive direction as a strain in a negative value.

FIG. 64 shows a strain in the radial direction εᵣ (X direction), a strain in a circumferential direction ε_{θ}, and an anisotropic strain Δε, a difference of these strains (=εᵣ−ε_{θ}). This anisotropic strain Δε contributes to the change in the magnetization direction of the first magnetic layer 201 caused by the inverse magnetostrictive effect, which is described with reference to FIGS. 3A to 3C.

As shown in in FIG. 64, at near the center of the vibrating portion 121 convexly bent, the strain εᵣ in the radial direction and the strain ε_{θ} in the circumferential direction are tensile strain. In contrast to this, near the outer edge hollowly bent, the strain εᵣ in the radial direction and the strain ε_{θ} in the circumferential direction are compressive strain. At near the center, the anisotropic strain Δε indicates zero, thus exhibiting isotropic strain. At near the outer edge, the anisotropic strain As shows a compression value. At the part nearest to the outer edge, the largest anisotropic strain can be obtained. With the circular vibrating portion 121, this anisotropic strain Δε can be always obtained similarly in the radiation direction from the center. Therefore, arranging the strain detecting element 200 close to the outer edge of the vibrating portion 121 allows detection of a strain at good sensitivity. Thus, the strain detecting elements 200 can be arranged at a part near the outer edge of the vibrating portion 121.

FIG. 65 is a contour drawing illustrating an X-Y in-plane distribution of the anisotropic strain As generated at the vibrating portion 121. FIG. 65 exemplifies a result of converting the anisotropic strain Δε (Δε_{r-θ}) in the polar coordinates system shown in FIG. 64 into the anisotropic strain Δε (Δε_{X-Y}) in the Cartesian coordinate system and analyzing the anisotropic strain Δε (Δε_{X-Y}) at the entire surface of the vibrating portion 121.

In FIG. 65, the lines indicated by the characters “90%” to “10%” indicate positions where the respective anisotropic strains Δε of 90% to 10% of the largest anisotropic strain Δε_{X-Y} value (absolute value), which is obtained at the part nearest of the outer edge of the vibrating portion 121, are obtained. As illustrated in FIG. 65, the anisotropic strain Δε_{X-Y} at a similar magnitude can be obtained in a limited region.

Here, for example, as illustrated in FIG. 62A, in the case where the plurality of strain detecting elements 200 are disposed on the film portion 120, since the directions of magnetization of the magnetization fixed layer align in the magnetic field annealing direction aiming for pin fixation, thus heading for the same direction. Therefore, arranging the strain detecting elements 200 in a range where the anisotropic strain at approximately uniform magnitude is generated is desirable.

In this respect, the strain detecting element 200 described in the first embodiment can ensure the high gauge factor (strain detection sensitivity) even if the strain detecting element 200 is comparatively small. Accordingly, even if the dimensions of the film portion 120 are small, as long as the strain detecting elements 200 are arranged in the range where the anisotropic strain at the approximately uniform magnitude is generated, the high gauge factor can be obtained. When arranging the plurality of strain detecting elements 200 on the film portion 120 and attempting to obtain a change in the electrical resistance due to similar pressure (for example, polarity), it is preferred that the strain detecting elements 200 be arranged close to the region near the outer edge where the similar anisotropic strain Δε_{X-Y} is obtained as illustrated in FIG. 65. Even if the strain detecting elements 200 described in the first embodiment are comparatively small, the high gauge factor (strain detection sensitivity) can be ensured. This allows arranging the many strain detecting elements 200 at the region near the outer edge where the similar anisotropic strain Δε_{X-Y} can be obtained.

The use of the strain detecting element 200 with a structure having the plurality of second magnetic layers 202 with respect to the first magnetic layer 201 according to the second embodiment achieves the following. The dimensions of the first magnetic layer 201 are not excessively decreased according to a required resolution of the strain to reduce the disturbance of magnetization due to the influence from the diamagnetic field as much as possible. Only the dimensions of the coupled second magnetic layer 202 are decreased. Further, disposing the plurality of junctions of the first magnetic layer 201/the intermediate layer 203/the second magnetic layer 202 allows obtaining an increased effect of the above-described SN ratio. With the strain detecting element 200 according to the second embodiment, the planer dimensions of the first magnetic layer 201 are configured so as not to be excessively small. Additionally, the junctions of the first magnetic layer 201/the intermediate layer 203/the second magnetic layer 202 are arranged close to the region near the outer edge where the similar anisotropic strain Δε_{X-Y} can be obtained. This allows ensuring the pressure sensor at high SN ratio.

Here, as described with reference to FIG. 62A to FIG. 62F, the plurality of strain detecting elements 200 according to the embodiment are arranged in the first to fourth planar regions along the outer edge of the first region R1. Therefore, the plurality of strain detecting elements 200 arranged in the first to fourth planar regions allows uniformly detecting a strain.

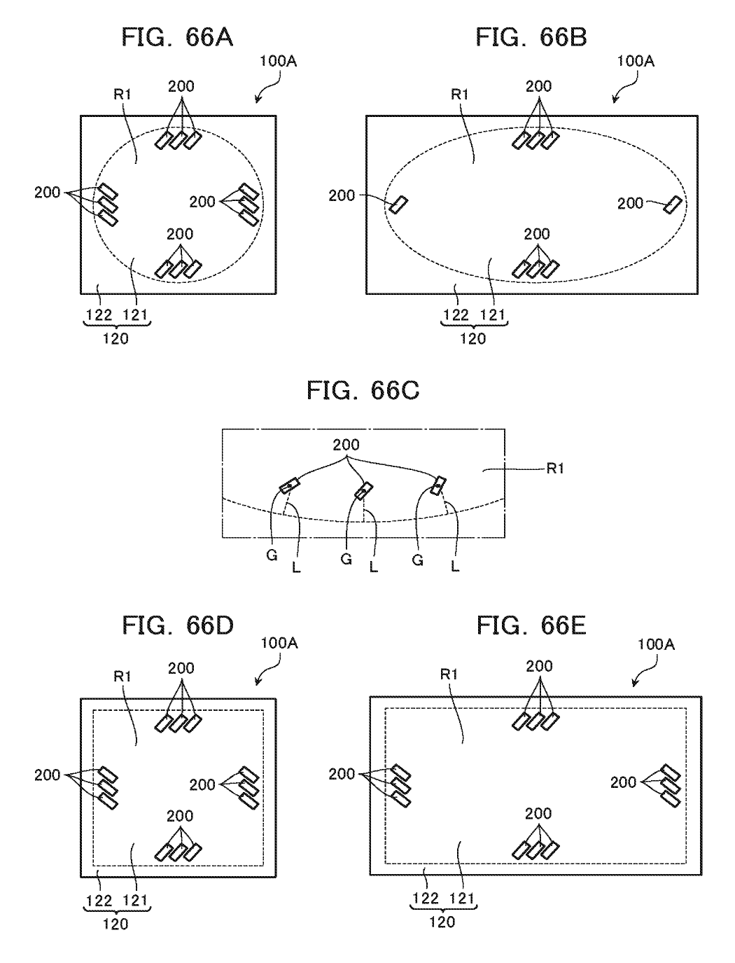

The following describes other exemplary configurations of the pressure sensor 100 with reference to FIG. 66A to FIG. 66E. FIG. 66A to FIG. 66E are plan views illustrating other exemplary configurations of the pressure sensor 100. The pressure sensors 100A illustrated in FIG. 66A to FIG. 66E are configured approximately similar to the pressure sensor 100A illustrated in FIG. 62A to FIG. 62F. However, the pressure sensors 100A illustrated in FIG. 66A to FIG. 66E differ in that the first magnetic layer 201 included in the strain detecting element 200 is formed into not an approximately square shape but an approximately rectangular shape.

FIG. 66A illustrates an aspect where the vibrating portion 121 of the film portion 120 has an approximately circular shape. FIG. 66B illustrates an aspect where the vibrating portion 121 of the film portion 120 has an approximately oval shape (elliptical shape). FIG. 66D illustrates an aspect where the vibrating portion 121 of the film portion 120 has an approximately square shape. FIG. 66E illustrates an aspect where the vibrating portion 121 of the film portion 120 has an approximately rectangular shape. FIG. 66C is an enlarged view of a part of FIG. 66B.

As illustrated in FIG. 66C, the plurality of strain detecting elements 200 are arranged on the film portion 120 along the outer edge of the first region R1. Here, assume that a straight line connecting a centroid G of the strain detecting element 200 and the outer edge of the first region R1 at the shortest distance as a straight line L. An angle of the direction of this straight line L with respect to the longitudinal direction of the first magnetic layer 201, which is included in the strain detecting element 200, is set so as to be larger than 0° and smaller than 90°.

As described above, when forming the first magnetic layer 201, which is included in the strain detecting element 200, into the rectangular shape, the oval shape, or a similar shape so as to have the shape magnetic anisotropy, the initial magnetization direction of the magnetization free layer 210 can be set to the longitudinal direction. The directions of the straight lines L illustrated in FIG. 66C indicate the directions of strains generated at the strain detecting element 200. Accordingly, by setting the angle of the direction of the straight line L with respect to the longitudinal direction of the first magnetic layer 201, which is included in the strain detecting element 200, larger than 0° and smaller than 90° allows adjusting the initial magnetization direction of the magnetization free layer 210 and the direction of strain generated at the strain detecting element 200. This allows manufacturing the pressure sensor sensitive to a positive/negative pressure. This angle is more preferable to be 30 degrees or more to 60 degrees or less.

In the case where a difference between the maximum value and the minimum value of the angle is set to be, for example, 5 degrees or less, similar pressure-electrical resistance properties can be obtained among the plurality of strain detecting elements 200.

In the examples illustrated in FIG. 66A to FIG. 66E, the pressure sensor 100 includes the plurality of strain detecting elements 200; however, the pressure sensor 100 may include only one strain detecting element 200.

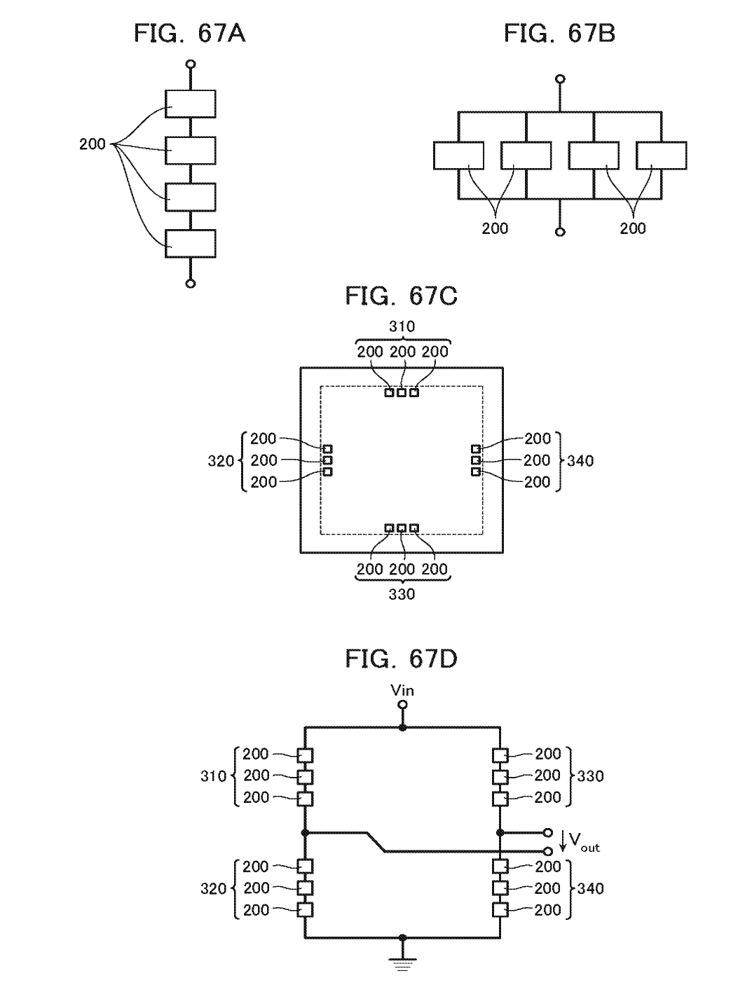

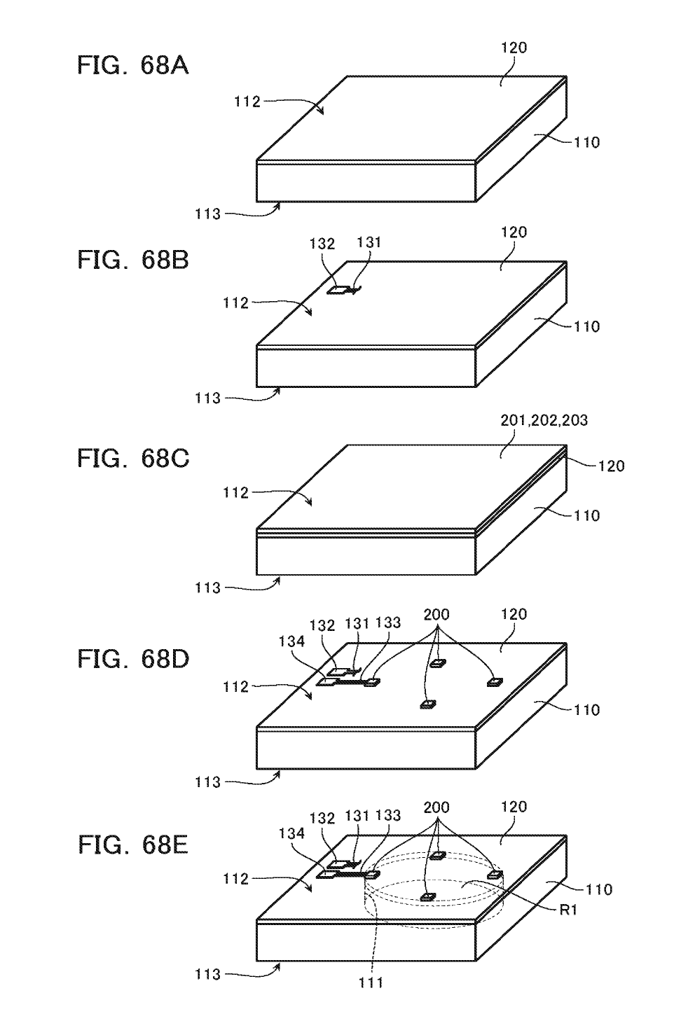

The following describes a wiring pattern for the strain detecting element 200 with reference to FIG. 67A to FIG. 67D. FIG. 67A, FIG. 67B, and FIG. 67D are circuit diagrams for describing the wiring pattern for the strain detecting element 200. FIG. 67C is a schematic plan view for describing the wiring pattern for the strain detecting element 200.

When disposing the plurality of strain detecting elements 200 on the pressure sensor 100, for example, as illustrated in FIG. 67A, the all strain detecting elements 200 may be connected in series. Here, a bias voltage of the strain detecting elements 200 is, for example, 50 millivolts (mV) or more to 150 mV or less. When the N pieces of strain detecting elements 200 are connected in series, the bias voltage becomes 50 mV×N or more to 150 mV×N or less. For example, in the case where the number of strain detecting elements N connected in series is 25, the bias voltage becomes 1 V or more to 3.75 V or less.

When the bias voltage value is 1 V or more, an electric circuit that processes an electrical signal obtained from the strain detecting element 200 can be easily designed, being practically preferable. On the other hand, the excess of the bias voltage (inter-terminal voltage) of 10 V is not preferable for the electric circuit that processes the electrical signal obtained from the strain detecting element 200. In the embodiment, the number of strain detecting elements 200 N connected, in series and the bias voltage are set so as to be an adequate voltage range.

For example, a voltage when the plurality of strain detecting elements 200 are electrically connected in series is preferable to be 1 V or more to 10 V or less. For example, a voltage applied across the terminals (between the terminal at the one end and the terminal at the other end) of the plurality of strain detecting elements 200 electrically connected in series is 1 V or more to 10 V or less.

To generate this voltage, in the case where the bias voltage applied to the one strain detecting element 200 is 50 mV, the number of strain detecting elements 200 N connected in series is preferable to be 20 or more to 200 or less. In the case where the bias voltage applied to the one strain detecting element 200 is 150 mV, the number of strain detecting elements 200 N connected in series is preferable to be 7 or more to 66 or less.

The plurality of strain detecting elements 200, for example, as illustrated in FIG. 67C, may be all connected in parallel.

For example, as illustrated in FIG. 67C, assume the case where the plurality of strain detecting elements 200 are arranged at the respective first to fourth planar regions, which are described with reference to FIG. 62A to FIG. 62F, and the strain detecting elements 200 are referred to as first to fourth strain detecting element groups 310, 320, 330, and 340. As illustrated in FIG. 67D, the first to fourth strain detecting element groups 310, 320, 330, and 340 may configure a Wheatstone bridge circuit. Here, the first strain detecting element group 310 illustrated and the third strain detecting element group 330 illustrated in FIG. 67D can obtain the strain-electrical resistance properties in the same polarity. The second strain detecting element group 320 and the fourth strain detecting element group 340 can obtain the strain-electrical resistance properties in the reversed polarity from the first strain detecting element group 310 and the third strain detecting element group 330. The number of strain detecting elements 200 included in the first to fourth strain detecting element groups 310, 320, 330, and 340 may be one. This, for example, allows temperature compensation for a detection property.

The following describes the method for manufacturing the pressure sensor 100 according to the embodiment in more detail with reference to FIG. 68A to FIG. 68E. FIG. 68A to FIG. 68E are schematic perspective views illustrating the method for manufacturing the pressure sensor 100.

In the method for manufacturing the pressure sensor 100 according to the embodiment, as illustrated in FIG. 68A, the film portion 120 is formed at one surface 112 of the substrate 110. For example, when the substrate 110 is an Si substrate, as the film portion 120, a thin film made of SiOₓ/Si may be formed by sputtering.

For example, in the case where a Silicon On Insulator (SOI) substrate is used as the substrate 110, the laminated film made of SiO₂/Si on the Si substrate can also be used as the film portion 120. In this case, the film portion 120 is formed by pasting the Si substrate and the laminated film of SiO₂/Si.

Next, as illustrated in FIG. 68B, the wiring 131 and the pad 132 are formed on the one surface 112 of the substrate 110. That is, a conductive film that will be the wiring 131 and the pad 132 are formed. The conductive film is removed leaving a part of the conductive film. This process may use the photolithography and the etching or may use the liftoff.

The periphery of the wiring 131 and the pad 132 may be embedded with an insulating film (not illustrated). In this case, for example, the liftoff may be used. In the liftoff, for example, after etching the wiring 131 and pad 132 patterns and before peeling off the resists, an insulating film (not illustrated) is formed on the entire surface. Then, the resists are removed.

Next, as illustrated in FIG. 68C, on the one surface 112 of the substrate 110, the first magnetic layer 201, the second magnetic layer 202, and the intermediate layer 203 are formed. The intermediate layer 203 is positioned between the first magnetic layer 201 and the second magnetic layer 202.

Next, as illustrated in FIG. 68D, the first magnetic layer 201, the second magnetic layer 202, and the intermediate layer 203 are removed leaving a part of them, thus forming the strain detecting elements 200. This process may use the photolithography and the etching or may use the liftoff.

The periphery of the strain detecting element 200 may be embedded with an insulating film (not illustrated). In this case, for example, the liftoff may be used. In the liftoff, for example, after etching the strain detecting element 200 patterns and before peeling off the resists, an insulating film (not illustrated) is formed on the entire surface. Then, the resists are removed.

Next, as illustrated in FIG. 68D, the wiring 133 and the pad 134 are formed on the one surface 112 of the substrate 110. That is, a conductive film that will be the wiring 133 and the pad 134 are formed. The conductive film is removed leaving a part of the conductive film. This process may use the photolithography and the etching or may use the liftoff.

The periphery of the wiring 133 and the pad 134 may be embedded with an insulating film (not illustrated). In this case, for example, the liftoff may be used. In the liftoff, for example, after etching the wiring 133 and pad 134 patterns and before peeling off the resists, an insulating film (not illustrated) is formed on the entire surface. Then, the resists are removed.

Next, a part of the substrate 110 is removed from another surface 113 of the substrate 110 as illustrated in FIG. 68E, thus forming the void portion 111 at the substrate 110. The region removed by this process is a part corresponding to the first region R1 of the substrate 110. The embodiment removes the all parts positioned in the first region R1 of the substrate 110. However, leaving a part of the substrate 110 is also possible. For example, to integrally form the film portion 120 and the substrate 110, a part of the substrate 110 is removed and the thin film is formed. The thinned film part may be configured as the film portion 120.

The embodiment uses the etching in the process illustrated in FIG. 68E. For example, when the film portion 120 is the laminated film made of SiO₂/Si, this process may be performed by deep process from the other surface 113 of the substrate 110. This process can use a double side aligner exposure apparatus. This allows patterning a hole pattern of the resist to the other surface 113 aligning the hole pattern to the position of the strain detecting element 200.

The etching, for example, can use a Bosch process using RIE. The Bosch process, for example, repeats the etching process using SF₆ gas and a deposition process using C₄F₈ gas. This reduces etching a sidewall of the substrate 110 while selectively etching the substrate 110 in the depth direction (Z-axis direction). As an end point of the etching, for example, an SiOₓ layer is used. That is, the SiOₓ layer, which has a different etch selectivity from Si, is used to terminate the etching. The SiOₓ layer functions as an etching stopper layer may be used as a part of the film portion 110. The SiOₓ layer may be removed by, for example, a process using anhydrous hydrogen fluoride, alcohol, or a similar material after the etching. The substrate 110 may be etched by anisotropic etching by a wet process and etching using a sacrificial layer in addition to the Bosch process.

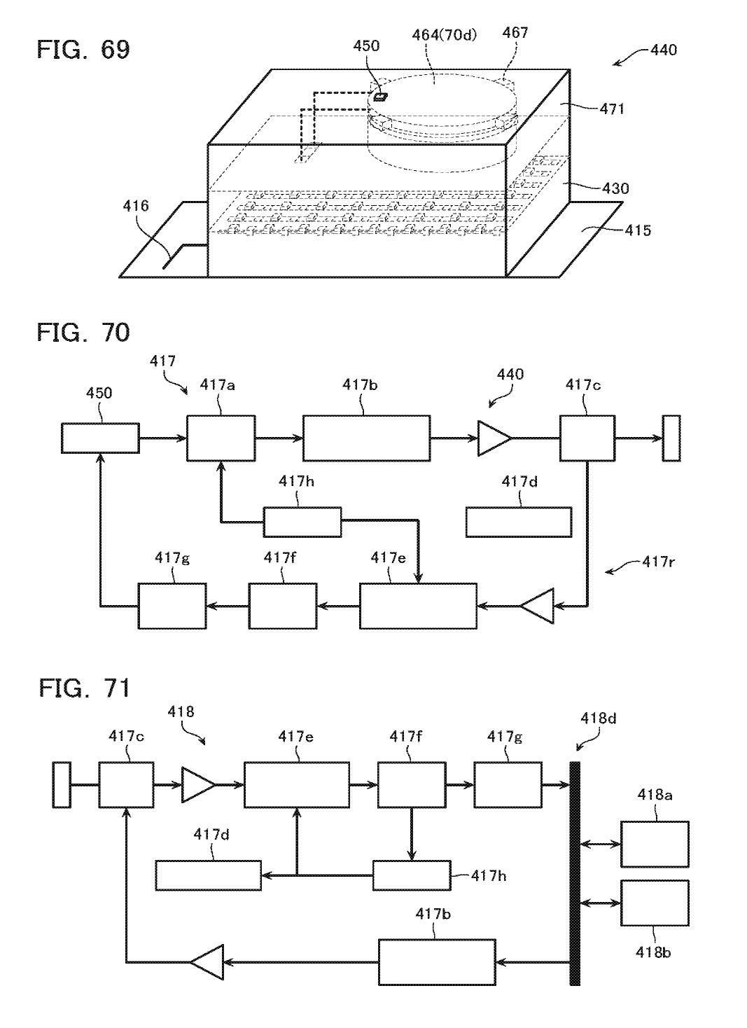

The following describes an exemplary configuration 440 of a pressure sensor 100 according to the embodiment with reference to FIG. 69 to FIG. 71.

FIG. 69 is a schematic perspective view illustrating a configuration of the pressure sensor 440. FIG. 70 and FIG. 71 are block diagrams exemplifying the pressure sensor 440.

As illustrated in FIG. 69 and FIG. 70, the pressure sensor 440 includes a base portion 471, a sensing unit 450, a semiconductor circuit unit 430, an antenna 415, an electrical wiring 416, a transmission circuit 417, and a reception circuit 417r. The sensing unit 450 according to the embodiment is, for example, the strain detecting element 200 according to the first or second embodiment.

The antenna 415 is electrically connected to the semiconductor circuit unit 4 30 via the electrical wiring 416.

The transmission circuit 417 wirelessly transmits data based on an electrical signal flowing through the sensing unit 450. At least a part of the transmission circuit 417 can be disposed at the semiconductor circuit unit 430.

The reception circuit 417r receives a control signal from an electronic device 418d. At least a part of the reception circuit 417r can be disposed at the semiconductor circuit unit 430. Disposing the reception circuit 417r allows, for example, controlling the operation of the pressure sensor 440 by operating the electronic device 418d.

As illustrated in FIG. 70, the transmission circuit 417, for example, can include an AD converter 417a and a Manchester-encoding unit 417b, which are connected to the sensing unit 450. Disposing a switching unit 417c allows switching the transmission and the reception. In this case, a timing controller 417d can be disposed. The timing controller 417d can control the switch by the switching unit 417c. Furthermore, a data correction unit 417e, a synchronizer 417f, a determining unit 417g, and a voltage controlled oscillator (VCO) 417h can be disposed.

As illustrated in FIG. 71, the electronic device 418d, which is used in combination with the pressure sensor 440, includes a receiving unit 418. As the electronic device 418d, for example, an electronic device such as a mobile terminal can be exemplified.

In this case, the pressure sensor 440, which includes the transmission circuit 417, and the electronic device 418d, which includes the receiving unit 418, can be used in combination.

The electronic device 418d can include the Manchester-encoding unit 417b, the switching unit 417c, the timing controller 417d, the data correction unit 417e, the synchronizer 417f, the determining unit 417g, the voltage controlled oscillator 417h, a storage unit 418a, and a Central Processing Unit (CPU) 418b.

In this example, the pressure sensor 440 further includes a securing unit 467. The securing unit 467 secures a film portion 464 (70d) to the base portion 471. A thickness dimension of the securing unit 467 can be thicker than the thickness dimension of the film portion 464 such that the securing unit 467 is less likely to be bent even if the external pressure is applied.

The securing units 467, for example, can be disposed at the peripheral edge of the film portion 464 at a regular interval. The securing units 467 can also be disposed so as to consecutively surround the entire peripheral area of the film portion 464 (70d). The securing unit 467, for example, can be formed of the same material as the material of the base portion 471. In this case, the securing unit 467 can be formed of, for example, silicon. The securing unit 467, for example, can also be formed of the same material as the material of the film portion 464 (70d).

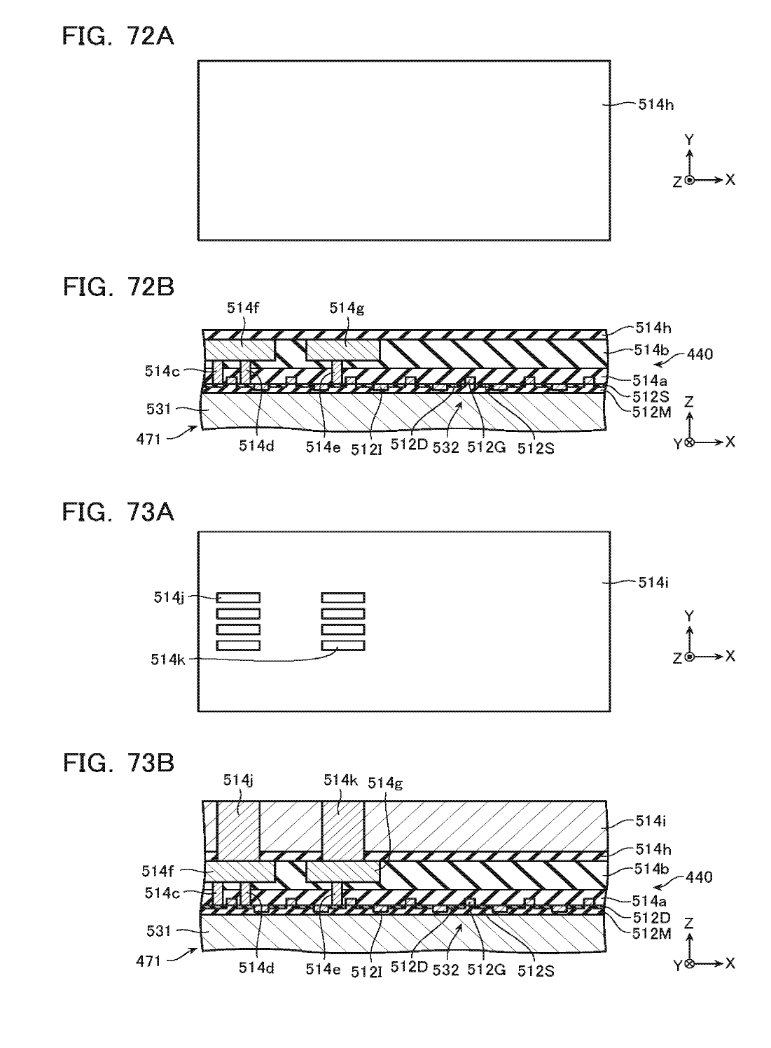

The following exemplifies the method for manufacturing the pressure sensor 440 with reference to FIG. 72A to FIG. 83B. FIG. 72A to FIG. 83B are schematic plan views and cross-sectional views exemplifying the method for manufacturing the pressure sensor 440.

As illustrated in FIG. 72A and FIG. 72B, a semiconductor layer 512M is formed at the surface part of a semiconductor substrate 531. Subsequently, at the top surface of the semiconductor layer 512M, element isolation insulating layers 512I are formed. Subsequently, gates 512G are formed on the semiconductor layer 512M via an insulating layer (not illustrated). Subsequently, a source 512S and a drain 512D are formed at both sides of the gate 512G, thus forming a transistor 532. Subsequently, an interlayer insulating film 514a is formed on the semiconductor layer 512M and further forms an interlayer insulating film 514b.

Subsequently, trenches and holes are formed at a part of the interlayer insulating films 514a and 514b, which are regions being non-void portions. Subsequently, conductive materials are embedded into the holes, thus forming connecting pillars 514c to 514e. In this case, for example, the connecting pillar 514c is electrically connected to the source 512S of the one transistor 532, and a connecting pillar 514d is electrically connected to the drain 512D. For example, the connecting pillar 514e is electrically connected to the source 512S of another transistor 532. Subsequently, the conductive materials are embedded into the trenches, thus forming wiring portions 514f and 514g. The wiring portion 514f is electrically connected to the connecting pillar 514c and the connecting pillar 514d. The wiring portion 514g is electrically connected to the connecting pillar 514e. Subsequently, on the interlayer insulating film 514b, an interlayer insulating film 514h is formed.

As illustrated in FIG. 73A and FIG. 73B, on the interlayer insulating film 514h, an interlayer insulating film 514i made of silicon oxide (SiO₂) is, formed by, for example, Chemical Vapor Deposition (CVD) method. Subsequently, holes are formed at predetermined positions of the interlayer insulating film 514i. The conductive materials (for example, metallic materials) are embedded into the holes. Then, the top surface is flattened by the Chemical Mechanical Polishing (CMP) method. This forms a connecting pillar 514j and a connecting pillar 514k. The connecting pillar 514j is connected to the wiring portion 514f . The connecting pillar 514k is connected to the wiring portion 514g.

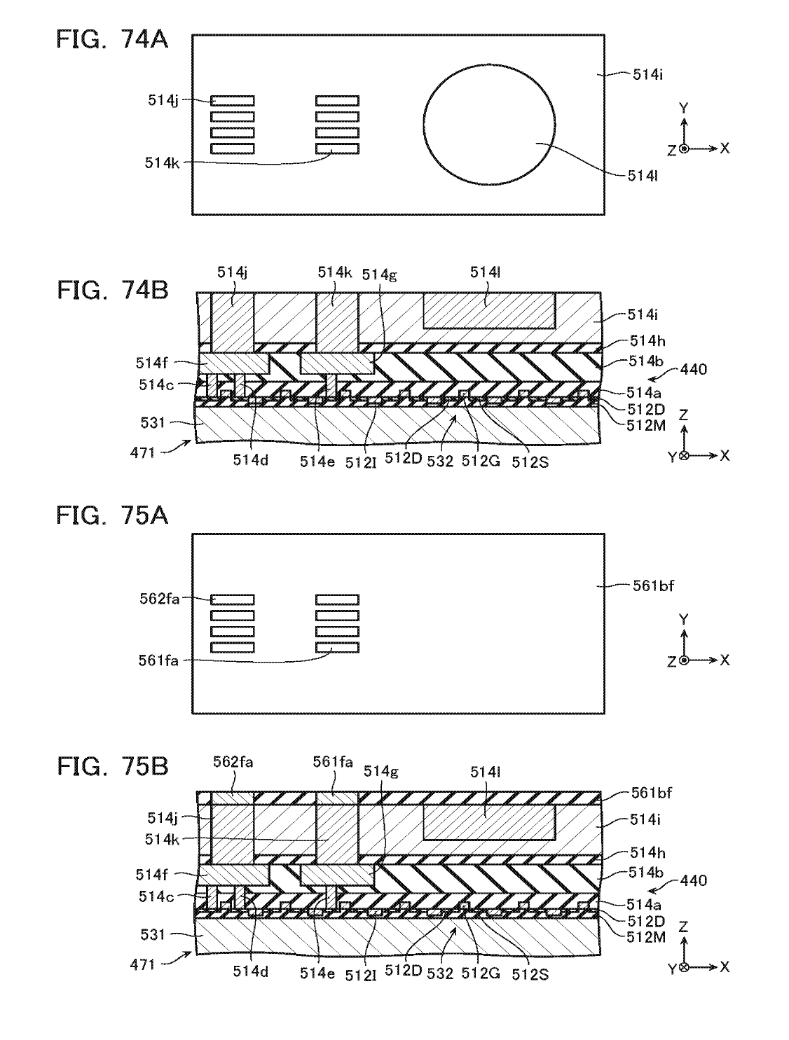

As illustrated in FIG. 74A and FIG. 74B, a concave portion is formed at a region being a void portion 570 of the interlayer insulating film 514i. A sacrificial layer 5141 is embedded into the concave portion. The sacrificial layer 5141, for example, can be formed using a material from which a film can be formed at a low temperature. The material from which the film can be formed at a low temperature is, for example, silicon germanium (SiGe).

As illustrated in FIG. 75A and FIG. 75B, on the interlayer insulating film 514i and the sacrificial layer 514l, an insulating film 561bf, which becomes a film portion 564 (70d), is formed. The insulating film 561bf, for example, can be formed using, for example, silicon oxide (SiO₂). A plurality of holes is provided at the insulating film 561bf. Conductive materials (for example, metallic materials) are embedded into the plurality of holes. Thus, a connecting pillar 561fa and a connecting pillar 562fa are formed. The connecting pillar 561fa is electrically connected to the connecting pillar 514k. The connecting pillar 562fa is electrically connected to the connecting pillar 514j.

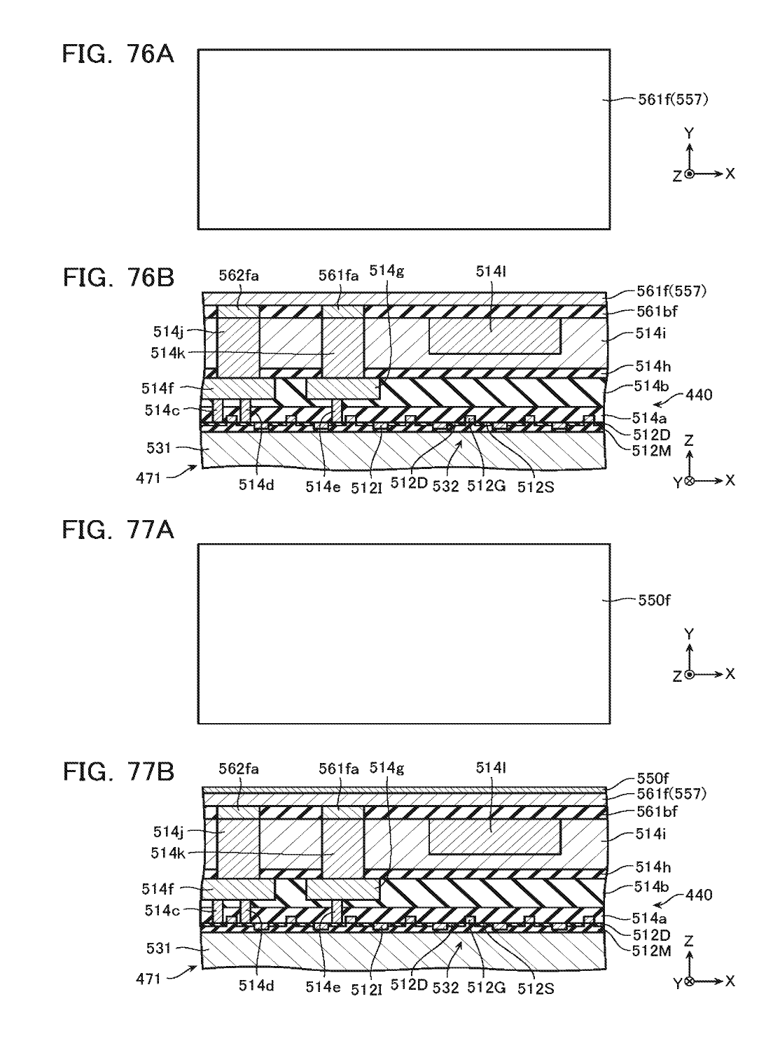

As illustrated in FIG. 76A and FIG. 76B, on the insulating film 561bf, the connecting pillar 561fa, and the connecting pillar 562fa, a conducting layer 561f, which becomes a wiring 557, is formed.

As illustrated in FIG. 11A and FIG. 77B, a laminated film 550f is formed on the conducting layer 561f. The laminated film 550f may be contain the first magnetic layer 201, the second magnetic layer 202 and the intermediate layer 203 according to the first embodiment or the second embodiment.

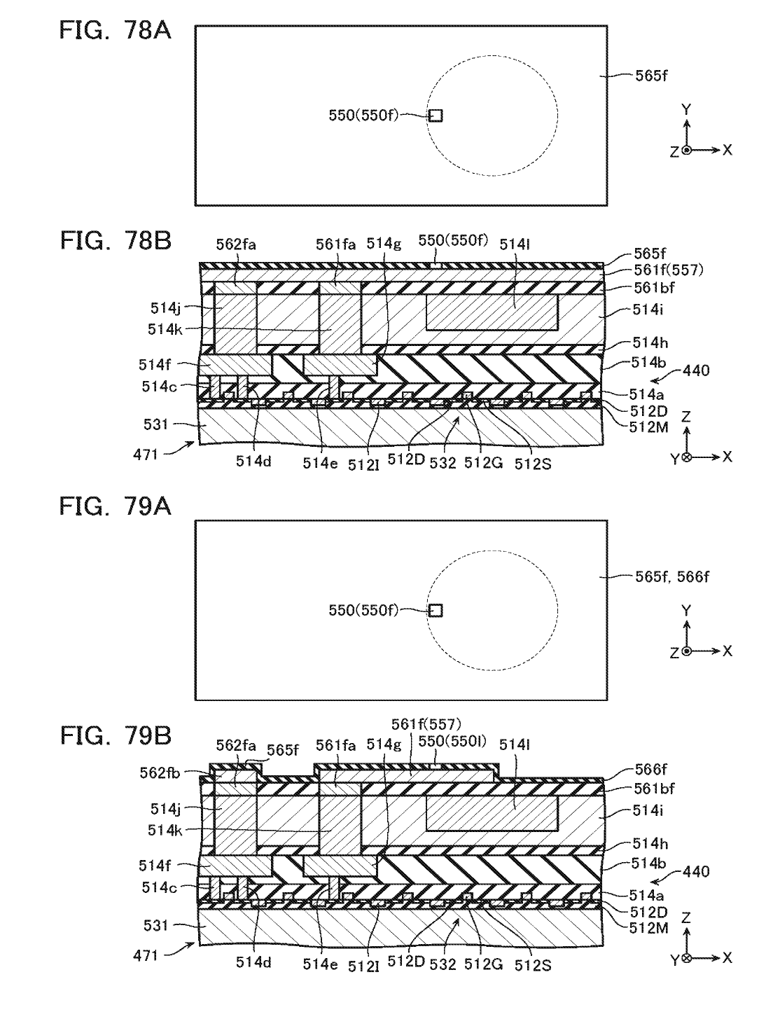

As illustrated in FIG. 78A and FIG. 78B, the laminated film 550f is processed into a predetermined shape. The laminated film 550f may be formed so that the laminated film 550f forms the sensing unit 450 (FIG. 69). An insulating film 565f, which becomes an insulating layer 565, is formed on the laminated film 550f. The insulating film 565f, for example, can be formed using, for example, silicon oxide (SiO₂).

As illustrated in FIG. 79A and FIG. 79B, a part of the insulating film 565f is removed and the conducting layer 561f is processed into the predetermined shape. This forms the wiring 557. At this time, a part of the conducting layer 561f becomes a connecting pillar 562fb electrically connected to the connecting pillar 562fa. Furthermore, on the connecting pillar 562fb, an insulating film 566f that becomes an insulating layer 566 is formed.

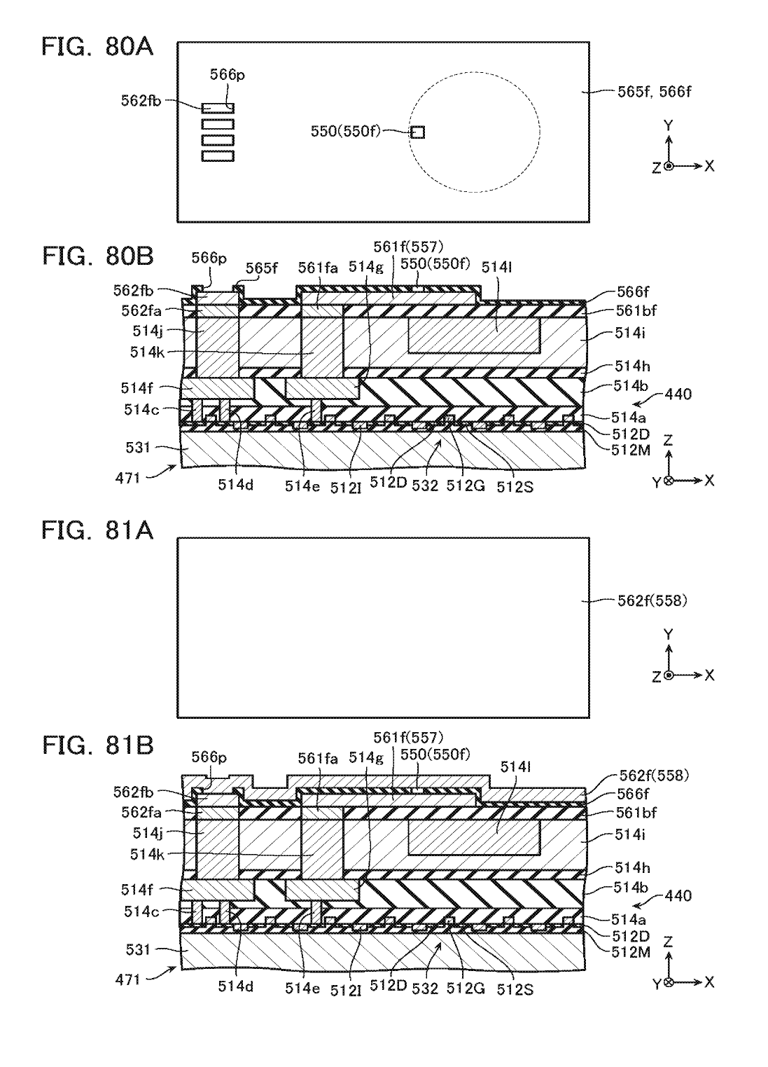

As illustrated in FIG. 80A and FIG. 80B, openings 566p are formed at the insulating film 565f. This exposes the connecting pillar 562fb.

As illustrated in FIG. 81A and FIG. 81B, a conducting layer 562f that becomes a wiring 558 is formed at the top surface. A part of the conducting layer 562f is electrically connected to the connecting pillar 562fb.

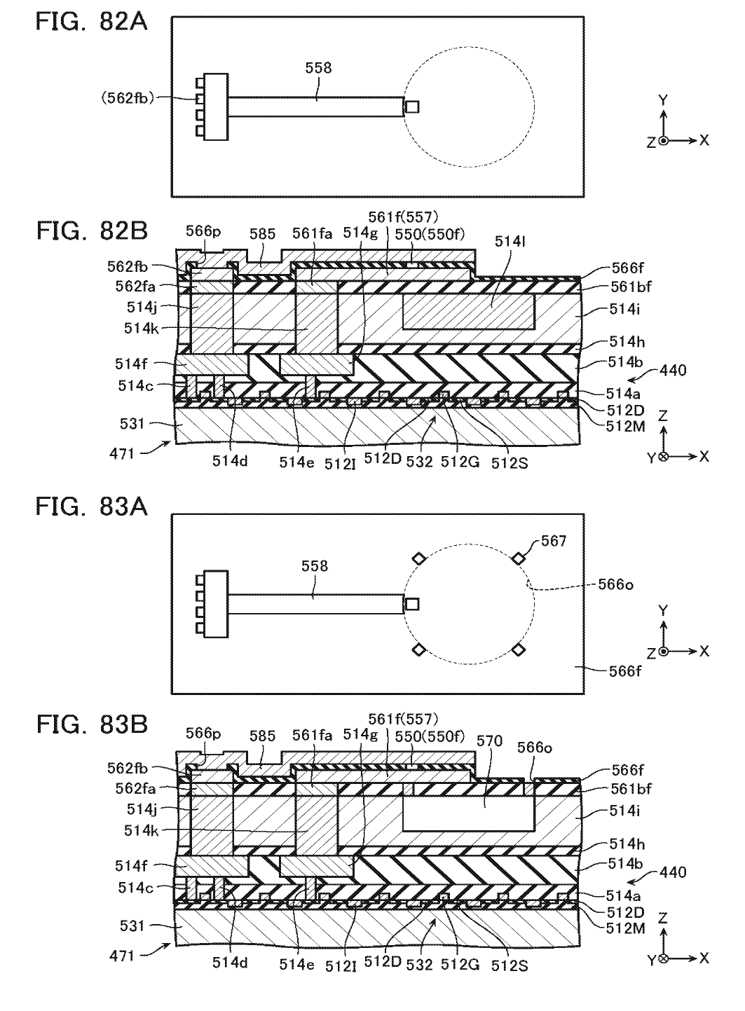

As illustrated in FIG. 82A and FIG. 82B, the conducting layer 562f is processed into the predetermined shape. This forms the wiring 558. The wiring 558 is electrically connected to the connecting pillar 562fb.

As illustrated in FIG. 83A and FIG. 83B, an opening 566ohaving a predetermined shape is formed at the insulating film 566f. The insulating film 561bf is processed via the opening 566o. Further, the sacrificial layer 5141 is removed via the opening 566o. This forms the void portion 570. The sacrificial layer 5141 can be removed by, for example, wet etching method.

To form securing units 567 in a ring arrangement, for example, between an edge of the non-void portion at the upper side of the void portion 570 and the film portion 564 are embedded with the insulating film.

As described above, the pressure sensor 440 is formed.

### 4. FOURTH EMBODIMENT

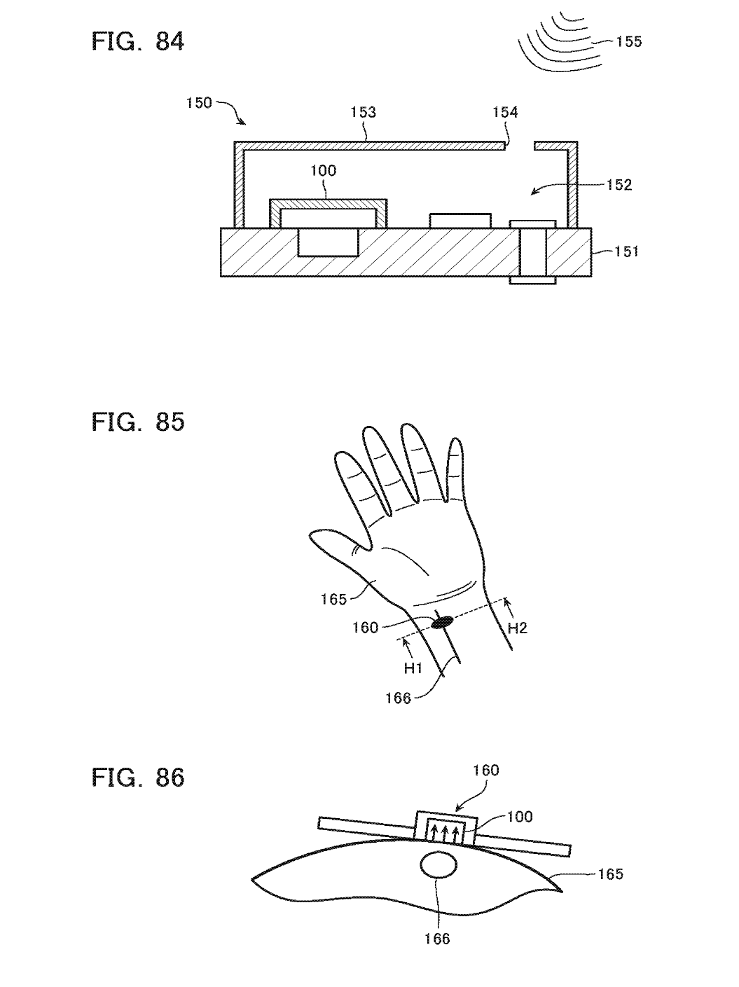

With reference to FIG. 84, the following describes the fourth embodiment. FIG. 84 is a schematic cross-sectional view illustrating a configuration of a microphone 150 according to the embodiment. The pressure sensor 100 according to the first to the third embodiments, for example, can be mounted to the microphone.

The microphone 150 according to the embodiment includes a printed circuit board 151, an electronic circuit 152, and a cover 153. The printed circuit board 151 mounts the pressure sensor 100. The electronic circuit 152 mounts the printed circuit board 151. The cover 153 covers the pressure sensor 100 and the electronic circuit 152 together with the printed circuit board 151. The pressure sensor 100 is the pressure sensor 100 according to the first to the third embodiments.

The cover 153 has an acoustic hole 154. A sound wave 155 enters from the acoustic hole 154. When the sound wave 155 enters inside of the cover 153, the pressure sensor 100 senses the sound wave 155. The electronic circuit 152, for example, passes a current to the strain detecting elements mounted on the pressure sensor 100 and detects a change in the resistance value of the pressure sensor 100. The electronic circuit 152 may amplify this current value with an amplifier circuit or a similar circuit.

The pressure sensor manufactured by the method according to the first to fourth embodiments features high sensitivity. Accordingly, the microphone 150 mounting this pressure sensor can detect the sound wave 155 at good sensitivity.

### 5. FIFTH EMBODIMENT

With reference to FIG. 85 and FIG. 86, the following describes the fifth embodiment. FIG. 85 is a schematic view illustrating a configuration of a blood pressure sensor 160 according to the fifth embodiment. FIG. 86 is a schematic cross-sectional view viewed from the line H1-H2 of the blood pressure sensor 160. The pressure sensor 100 according to the first to the third embodiments, for example, can be mounted to the blood pressure sensor 160.

As illustrated in FIG. 85, the blood pressure sensor 160 is, for example, pasted on an artery 166 of a human's arm 165. As illustrated in FIG. 86, the blood pressure sensor 160 mounts the pressure sensor 100 according to the first to the third embodiments. This allows measuring blood pressure.

The pressure sensor 100 according to the first to the third embodiments features high sensitivity. Accordingly, the blood pressure sensor 160 mounting the pressure sensor 100 can detect the blood pressure continuously at good sensitivity.

### 6. SIXTH EMBODIMENT

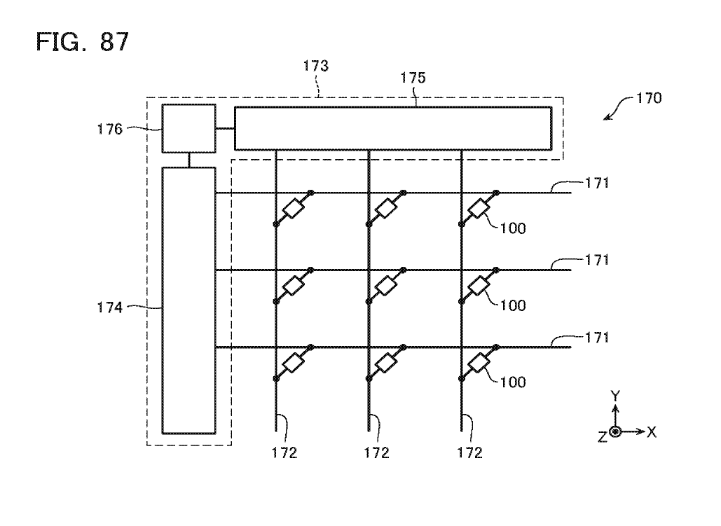

With reference to FIG. 87, the following describes the sixth embodiment. FIG. 87 is a schematic circuit diagram illustrating a configuration of a touch panel 170 according to the sixth embodiment. The touch panel 170 is mounted to at least any of the inside and the outside of a display (not illustrated).

The touch panel 170 includes the plurality of pressure sensors 100, a plurality of first wirings 171, a plurality of second wirings 172, and a control unit 173. The pressure sensors 100 are arranged in a matrix. The plurality of first wirings 171 are arranged in the Y direction. The first wirings 171 are connected to one end of the plurality of respective pressure sensors 100 arranged in the X direction. The plurality of second wirings 172 are arranged in the X direction. The second wirings 172 are connected to the other end of the plurality of respective pressure sensors 100 arranged in the Y direction. The control unit 173 controls the plurality of first wirings 171 and the plurality of second wirings 172. The pressure sensor 100 is the pressure sensor according to the first to the third embodiments.

The control unit 17 3 includes a first control circuit 174, a second control circuit 175, and a third control circuit 176. The first control circuit 174 controls the first wirings 171. The second control circuit 175 controls the second wirings 172. The third control circuit 176 controls the first control circuit 174 and the second control circuit 175.

For example, the control unit 173 passes a current to the pressure sensor 100 via the plurality of first wirings 171 and the plurality of second wirings 172. Here, pressing a touch surface (not illustrated) causes the pressure sensor 100 to change the resistance value of the strain detecting element according to the pressure. By detecting this change in resistance value, the control unit 173 specifies the position of the pressure sensor 100 that detects the pressure by the pressing.

The pressure sensor 100 according to the first to the third embodiments features high sensitivity. Accordingly, the touch panel 170 mounting the pressure sensor 100 can detect the pressure caused by pressing at good sensitivity. Since the pressure sensor 100 is a compact, allowing manufacturing the high-resolution touch panel 170.

The touch panel 170 may include a detection component for detection of a touch in addition to the pressure sensor 100.

### 7. OTHER APPLICATION EXAMPLES

With reference to the specific examples, the application examples of the pressure sensor 100 according to the first to the third embodiments are described above. Note that the pressure sensor 100 is applicable to various pressure sensor devices such as an atmospheric pressure sensor and a pneumatic sensor for tires, in addition to the embodiments described in the fourth to the sixth embodiments.

Specific configurations of the respective components such as the film portion, the strain detecting element, the first magnetic layer, the second magnetic layer, and the intermediate layer, which are included in the strain detecting element 200, the pressure sensor 100, the microphone 150, the blood pressure sensor 160, and the touch panel 170, are encompassed within the scope of the invention as long as those skilled in the art can similarly practice the invention and achieve similar effects by suitably selecting such configuration from conventionally known scopes.

Further, any two or more components of the respective specific examples may be combined within the extent of technical feasibility and are included in the scope of the invention to the extent that the spirit of the invention is included.

Besides, all the strain detecting element, the pressure sensor 100, the microphone 150, the blood pressure sensor 160, and the touch panel 170 that can be suitably designed, modified, and implemented by those skilled in the art based on the strain detecting element, the pressure sensor 100, the microphone 150, the blood pressure sensor 160, and the touch panel 170 described above in the embodiments of the present invention are also encompassed within the scope of the invention as long as they fall within the spirit of the invention.

### 8. OTHER EMBODIMENTS

The embodiments of the present invention are described above. The present invention can also be implemented by the following aspects.

[Aspect 1]

A strain detecting element is disposed on a deformable film portion. The strain detecting element includes a first magnetic layer, a second magnetic layer, and an intermediate layer. A magnetization direction of the first magnetic layer is variable according to a deformation of the film portion. The first magnetic layer has a first magnetic surface. The second magnetic layer has a second facing surface. The second facing surface faces the first facing surface. The intermediate layer is disposed between the first magnetic layer and the second magnetic layer. The first magnetic layer faces the second facing surface at a part of the first facing surface.

[Aspect 2]

The strain detecting element according to the aspect 1 maybe configured as follows. The first facing surface has an area larger than an area of the second facing surface.

[Aspect 3]

The strain detecting element according to the aspect 1 or 2 may be configured as follows. The second facing surface faces the first facing surface at an entirety of the second facing surface.

[Aspect 4]

A strain detecting element is disposed on a deformable film portion. The strain detecting element includes a first magnetic layer, a plurality of second magnetic layers, and an intermediate layer. A magnetization direction of the first magnetic layer is variable according to a deformation of the film portion. The first magnetic layer has a first facing surface. The plurality of second magnetic layers have respective second facing surfaces. The second facing surfaces face the first facing surface. The intermediate layer is disposed between the first magnetic layer and the second magnetic layers.

[Aspect 5]

The strain detecting element according to the aspect 4 may be configured as follows. The first magnetic layer faces the second facing surface at a part of the first facing surface.

[Aspect 6]

The strain detecting element according to the aspect 4 or 5 may be configured as follows. The strain detecting element further includes a first electrode and a second electrode. The first electrode is electrically connected to the first magnetic layer. The second electrode is electrically connected to the plurality of second magnetic layers in parallel. Junctions of the first magnetic layer and the plurality of second magnetic layers via the intermediate layer are electrically connected in parallel between the first electrode and the second electrode.

[Aspect 7]

The strain detecting element according to the aspect 4 or 5 may be configured as follows. The strain detecting element further includes a first electrode and a second electrode. The first electrode is electrically connected to one of the second magnetic layers. The second electrode is electrically connected to another of the second magnetic layers. Junctions of the first magnetic layer and the plurality of second magnetic layers via the intermediate layer are electrically connected in series between the first electrode and the second electrode.

[Aspect 8]

The strain detecting element according to any one of the aspects 1 to 7 may be configured as follows. A magnetization direction of the second magnetic layer is fixed to one direction.

[Aspect 9]

The strain detecting element according to the aspect 8 may be configured as follows. The magnetization direction of the second magnetic layer is fixed to one direction by an antiferromagnetic layer adjacent in a laminated direction.

[Aspect 10]

The strain detecting element according to any one of the aspects 1 to 9 may be configured as follows. The strain detecting element further includes a third magnetic layer disposed between the intermediate layer and the first magnetic layer.

[Aspect 11]

The strain detecting element according to the aspects 1 to 10 may be configured as follows. A planar shape of the intermediate layer is the same as a planar shape of the first magnetic layer.

[Aspect 12]

The strain detecting element according to the aspects 1 to 10 may be configured as follows. A planar shape of the intermediate layer is the same as a planar shape of the second magnetic layer.

[Aspect 13]

The strain detecting element according to the aspects 1 to 12 may be configured as follows. The first magnetic layer is disposed between the second magnetic layer and the film portion.

[Aspect 14]

A pressure sensor includes a supporting portion, the film portion, and the strain detecting element according to any one of the aspects 1 to 13. The film portion is supported by the supporting portion. The strain detecting element is disposed on the film portion.

[Aspect 15]

The strain detecting element according to the aspects 1 to 13 may be configured as follows. The first magnetic layer is formed longer in a first in-plane direction than in a second in-plane direction. The first in-plane direction is in an in-plane perpendicular to a laminated direction. The second in-plane direction is perpendicular to the laminated direction and the first in-plane direction.

[Aspect 16]

A pressure sensor includes a supporting portion, the film portion, and the strain detecting element according to the aspect 15. The film portion is supported by the supporting portion. The strain detecting element is disposed on the film portion. The first magnetic layer is disposed such that a relative angle formed by a straight line connecting a centroid of the first magnetic layer and art outer edge of the first region at a shortest distance and the first in-plane direction is larger than 0° and smaller than 90°.

[Aspect 17]

The pressure sensor according to the aspect 14 or 16 may be configured as follows. The plurality of strain detecting elements is disposed on the film portion.

[Aspect 18]

A pressure sensor includes a supporting portion, the film portion, and the strain detecting elements according to the aspect 15. The film portion is supported by the supporting portion. The plurality of strain detecting elements is disposed on the film portion. In the first magnetic layer, assume that a relative angle formed by a straight line connecting a centroid of the first magnetic layer and an outer edge of the first region at a shortest distance and the first in-plane direction is a third angle. In the plurality of strain detecting elements, a difference between a maximum third angle and a minimum third angle is 5 degrees or less.

[Aspect 19]

A pressure sensor includes a supporting portion, the film portion, and the strain detecting elements according to the aspects 1 to 13 or the aspect 15. The film portion is supported by the supporting portion. The plurality of strain detecting elements is disposed on the film portion. Among the plurality of strain detecting elements, at least two of the strain detecting elements are electrically connected in series.

[Aspect 20]

A microphone includes the pressure sensor according to the aspect 14 or the aspects 16 to 19.

[Aspect 21]

A blood pressure sensor includes the pressure sensor according to the aspect 14 or the aspects 16 to 19.

[Aspect 22]

A touch panel includes the pressure sensor according to the aspect 14 or the aspects 16 to 19.

### 9. OTHERS

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1-15. (canceled)

16. A pressure sensor comprising:
a supporting portion;
a deformable film supported by the supporting portion; and
a strain detecting element disposed on the deformable film,
the strain detecting element comprising:
a first electrode layer and a second electrode layer aligned in a first direction;
a first magnetic layer disposed between the first electrode layer and the second electrode layer;
an intermediate layer disposed between the first magnetic layer and the first electrode layer; and
a second magnetic layer and a third magnetic layer disposed between the intermediate layer and the first electrode layer, and
the second magnetic layer and the third magnetic layer being aligned in a second direction, the second direction crossing the first direction.

17. The pressure sensor according to claim 16,
the first direction crossing a surface of the deformable film.

18. The pressure sensor according to claim 16,
an electrical resistance between the first electrode layer and the second electrode layer changing according to a deformation of the deformable film.

19. The pressure sensor according to claim 16,
the intermediate layer including oxygen (O).

20. The pressure sensor according to claim 19,
the intermediate layer further including at least one of magnesium (Mg), aluminum (Al), zinc (Zn), and gallium (Ga).

21. A pressure sensor comprising:
a supporting portion:
a deformable film supported by the supporting portion; and
a strain detecting element disposed on the deformable film,
the strain detecting element comprising:
a first electrode layer and a second electrode layer aligned in a first direction;
a first magnetic layer disposed between the first electrode layer and the second electrode layer;
a second magnetic layer and a third magnetic layer disposed between the first magnetic layer and the first electrode layer, the second magnetic layer and the third magnetic layer being aligned in a second direction, the second direction crossing the first direction;
a first intermediate layer disposed between the second magnetic layer and the first magnetic layer; and
a second intermediate layer disposed between the third magnetic layer and the first magnetic layer.

22. The pressure sensor according to claim 21,
the first direction crossing a surface of the deform able film.

23. The pressure sensor according to claim 21,
an electrical resistance between the first electrode layer and the second electrode layer changing according to a deformation of the deformable film.

24. The pressure sensor according to claim 21,
the first intermediate layer and the second intermediate layer including oxygen (O).

25. The pressure sensor according to claim 24,
the first intermediate layer and the second intermediate layer further including at least one of magnesium (Mg), aluminum (Al), zinc (Zn), and gallium (Ga).

26. A pressure sensor comprising:
a supporting portion;
a deformable film supported by the supporting portion; and
a strain detecting element disposed on the deformable film,
the strain detecting element comprising:
a first magnetic layer;
a first electrode and a second electrode;
the first electrode and the first magnetic layer being aligned in a first direction, the second electrode and the first magnetic layer being aligned in the first direction, the first electrode and the second electrode being aligned in a second direction, the second direction crossing the first direction;
a second magnetic layer disposed between the first electrode and the first magnetic layer;
a first intermediate layer disposed between the second magnetic layer and the first magnetic layer;
a third magnetic layer disposed between the second electrode and the first magnetic layer;
a second intermediate layer disposed between the third magnetic layer and the first magnetic layer, and
the first intermediate layer and the second intermediate layer including at least one of magnesium (Mg), aluminum (Al), zinc (Zn), and gallium (Ga).

27. The pressure sensor according to claim 26,
the first direction crossing a surface of the deformable film.

28. The pressure sensor according to claim 26,
an electrical resistance between the first electrode and the second electrode changing according to a deformation of the deformable film.

29. The pressure sensor according to claim 26,
the first intermediate layer and the second intermediate layer further including oxygen (O).

30. A pressure sensor comprising:
a supporting portion;
a deformable film supported by the supporting portion: and
a strain detecting element disposed on the deformable film,
the strain detecting element comprising:
a first magnetic layer;
a first electrode and a second electrode;
the first electrode and the first magnetic layer being aligned in a first direction, the second electrode and the first magnetic layer being aligned in the first direction, the first electrode and the second electrode being aligned in a second direction, the second direction crossing the first direction;
a second magnetic layer disposed between the first electrode and the first magnetic layer;
a third magnetic layer disposed between the second electrode and the first magnetic layer; and
an intermediate layer, the intermediate layer being disposed between the second magnetic layer and the first magnetic layer, the intermediate layer being disposed between the third magnetic layer and the first magnetic layer, and
the intermediate layer including at least one of magnesium (Mg), aluminum (Al), Zinc (Zn), and gallium (Ga).

31. The pressure sensor according to claim 30,
the first direction crossing a surface of the deformable film.

32. The pressure sensor according to claim 30,
an electrical resistance between the first electrode and the second electrode changing according to a deformation of the deformable film.

33. The pressure sensor according to claim 30,
the intermediate layer further including oxygen (O).
